(19) United States
(12) Patent Application Publication
(10) Pub. No.: US 2015/0255029 A1
(43) Pub. Date: Sep. 10, 2015

(54) DISPLAY DEVICE, DISPLAY MODULE INCLUDING THE DISPLAY DEVICE, AND ELECTRONIC DEVICE INCLUDING THE DISPLAY DEVICE OR THE DISPLAY MODULE

(71) Applicant: SEMICONDUCTOR ENERGY LABORATORY CO., LTD., Atsugi-shi (JP)

(72) Inventors: Yasuhiro NIIKURA, Zama (JP); Makoto IKENAGA, Kyoto (JP); Manabu KOBAYASHI, Tokyo (JP); Ryo HATSUMI, Hadano (JP)

(21) Appl. No.: 14/638,667

(22) Filed: Mar. 4, 2015

(30) Foreign Application Priority Data
Mar. 7, 2014 (JP) 2014-044502
May 21, 2014 (JP) 2014-104894
Jun. 25, 2014 (JP) 2014-130113
Sep. 26, 2014 (JP) 2014-196183

(51) Int. Cl. G09G 3/36; G06F 3/041

(52) U.S. Cl. CPC G09G 3/3618; G06F 3/041; G09G 2320/02

(57) ABSTRACT

[Object]

Provided is a novel display device without deterioration of display quality or a novel display device in which flickering due to a reduced refresh rate is suppressed.

[Solution]

The display device includes a pixel for displaying a still image at a frame frequency of less than or equal to 1 Hz. The pixel includes a liquid crystal layer. The liquid crystal layer has a dielectric constant anisotropy of higher than or equal to 2 and lower than or equal to 3.8. Thus, flickering due to a reduced refresh rate can be suppressed, which leads to an improvement in display quality.

### TECHNICAL FIELD

One embodiment of the present invention relates to a display device, and particularly relates to a liquid crystal display device including a liquid crystal element.

Note that one embodiment of the present invention is not limited to the above technical field. The technical field of one embodiment of the invention disclosed in this specification and the like relates to an object, a method, or a manufacturing method. In addition, the present invention relates to a process, a machine, manufacture, or a composition of matter. In particular, one embodiment of the present invention relates to a semiconductor device, a display device, a light-emitting device, a power storage device, a storage device, a driving method thereof, or a manufacturing method thereof.

Note that the display device in this specification and the like indicates all devices that have a display function. The display device may include a semiconductor element such as a transistor, a semiconductor circuit, an arithmetic device, a storage device, or the like. The display device includes a driver circuit for driving a plurality of pixels and the like. Furthermore, the display device includes a control circuit, a power supply circuit, a signal generation circuit, or the like provided over a different substrate.

### BACKGROUND ART

Commoditization of display devices has progressed as a result of recent technological innovation. Higher value-added products are being required and have still been actively developed.

As added value of the liquid crystal display devices, a reduction in power consumption has attracted attention for the purpose of extending operation time of a mobile device or the like.

For example, Patent Document 1 discloses the structure of a display device whose power consumption is reduced by reducing the frequency of writing signals (also referred to as “refresh”) for the same image in the case of continuously displaying the same image (still image).

The refresh operation needs to be performed such that a change of an image caused by the refresh operation is not distinguished by users. The frequency of refresh operations is referred to as a refresh rate.

### PRIOR ART DOCUMENT

### Patent Document

[Patent Document 1] Japanese Published Patent Application No. 2011-237760

### SUMMARY OF THE INVENTION

### Problems to be Solved by the Invention

For driving of a display device at a low refresh rate, it is need to prevent a change of a still image with time from being perceived by users.

However, a voltage corresponding to a signal written to a pixel changes with time. When the voltage applied to a pixel changes in excess of an acceptable range of a deviation in gray level for displaying the same still image, viewers perceive flickers in the image, which leads to a decrease in display quality.

In view of the above, an object of one embodiment of the present invention is to provide a novel display device without a decrease in display quality. Another object of one embodiment of the present invention is to keep a change in voltage applied to a pixel within an acceptable range of a deviation in gray level for displaying the same still image. Another object of one embodiment of the present invention is to suppress flickering due to a reduced refresh rate. Another object of one embodiment of the present invention is to provide a novel display device with low power consumption. Another object of one embodiment of the present invention is to provide a novel display device. Note that the descriptions of these objects do not disturb the existence of other objects. In one embodiment of the present invention, there is no need to achieve all the objects. Other objects will be apparent from and can be derived from the description of the specification, the drawings, the claims, and the like.

### Means for Solving the Problems

One embodiment of the present invention is a display device including a pixel for displaying a still image at a frame frequency of less than or equal to 1 Hz. The pixel includes a liquid crystal layer. The liquid crystal layer has a dielectric constant anisotropy of higher than or equal to 2 and lower than or equal to 3.8.

One embodiment of the present invention is a display device including a pixel for displaying a still image at a frame frequency of less than or equal to 1 Hz. The pixel includes a transistor and a liquid crystal layer. The liquid crystal layer has a dielectric constant anisotropy of higher than or equal to 2 and lower than or equal to 3.8.

One embodiment of the present invention is a display device including a pixel for displaying a still image at a frame frequency of less than or equal to 1 Hz. The pixel includes a transistor, a liquid crystal layer, and a reflective electrode. The liquid crystal layer has a dielectric constant anisotropy of higher than or equal to 2 and lower than or equal to 3.8.

In each of the above structures, the transistor preferably includes a semiconductor layer and the semiconductor layer preferably includes an oxide semiconductor.

In each of the above structures, the liquid crystal layer preferably has a dielectric constant anisotropy of 2.1 or higher and 3.6 or lower.

In each of the above structures, the frame frequency is preferably 0.2 Hz or lower.

In each of the above structures, the reflective electrode preferably has unevenness.

Another embodiment of the present invention is a display device including the semiconductor device according to any one of the above embodiments and a display element. Another embodiment of the present invention is a display module including the display device and a touch sensor. Another embodiment of the present invention is an electronic device including the semiconductor device according to any one of the above embodiments, the display device, or the display module, and an operation key or a battery.

### Effect of the Invention

According to one embodiment of the present invention, a novel display device without a decrease in display quality can be provided. According to another embodiment of the present invention, a change in voltage applied to a pixel can be kept within an acceptable range of a deviation in gray level for displaying the same still image. According to another embodiment of the present invention, flickering due to a reduced refresh rate can be suppressed. According to another embodiment of the present invention, a novel display device with low power consumption can be provided. According to another embodiment of the present invention, a novel display device can be provided. Note that the descriptions of these effects do not disturb the existence of other effects. One embodiment of the present invention does not necessarily achieve all the effects. Other effects will be apparent from and can be derived from the description of the specification, the drawings, the claims, and the like.

### BRIEF DESCRIPTION OF DRAWING

FIG. 1 A graph showing the current-voltage characteristics of liquid crystal layers.

FIG. 2 A diagram showing the voltage holding ratio of liquid crystal layers.

FIGS. 3A and 3B Graphs showing the transmittance-voltage characteristics of a liquid crystal layer and 3C a schematic cross-sectional view of the liquid crystal layer.

FIG. 4 A schematic cross-sectional view of a liquid crystal layer for observing the transmittance of a liquid crystal layer.

FIG. 5 A diagram showing the residual DC voltage of liquid crystal layers.

FIG. 6 A block diagram illustrating a structure of a liquid crystal display device having a display function of one embodiment of the present invention.

FIGS. 7A and 7B Diagrams illustrating a structure of a display portion of a liquid crystal display device having a display function of one embodiment of the present invention.

FIG. 8 A diagram illustrating a structure of a display portion of a liquid crystal display device having a display function of one embodiment of the present invention.

FIG. 9 A circuit diagram illustrating a liquid crystal display device having a display function of one embodiment of the present invention.

FIGS. 10A1, 10A2, 10B1, 10B2 and 10C Diagrams illustrating source line inversion driving and dot inversion driving of a liquid crystal display device having a display function of one embodiment of the present invention.

FIG. 11 A timing chart showing source line inversion driving and dot inversion driving of a liquid crystal display device having a display function of one embodiment of the present invention.

FIGS. 12A and 12B Diagrams illustrating a structure of a display device of one embodiment of the present invention.

FIGS. 13A and 13B Diagrams illustrating a structural example of a transistor of one embodiment of the present invention.

FIGS. 14A and 14D Diagrams illustrating an example of a method of manufacturing a transistor of one embodiment of the present invention.

FIGS. 15A and 15B Diagrams illustrating structural examples of transistors of one embodiment of the present invention.

FIGS. 16A and 16C Diagrams illustrating structural examples of transistors of one embodiment of the present invention.

FIGS. 17A and 17D Cs-corrected high-resolution TEM images of a cross section of a CAAC-OS and a schematic cross-sectional view of the CAAC-OS.

FIGS. 18A and 18D Cs-corrected high-resolution TEM images of a plane of a CAAC-OS.

FIGS. 19A and 19C Diagrams showing structure analysis of a CAAC-OS and a single crystal oxide semiconductor by XRD.

FIG. 20 A top view illustrating one embodiment of a display device.

FIG. 21 A cross-sectional view illustrating one embodiment of a display device.

FIGS. 22A and 22C Projection views illustrating a structure of an input/output device of Embodiment.

FIG. 23 A cross-sectional view illustrating a structure of an input/output device of Embodiment.

FIGS. 24A, 24B1 and 24B2 Diagrams illustrating configurations and driving methods of a sensor circuit 19 and a converter CONV of Embodiment.

FIGS. 25A and 25C Diagrams illustrating electronic devices of one embodiment of the present invention.

FIGS. 26A and 26B Diagrams illustrating display of one embodiment of the present invention.

FIGS. 27A and 27B Diagrams illustrating display of one embodiment of the present invention.

FIGS. 28A and 28B Diagrams showing changes in gray level after white display or black display.

FIG. 29 A diagram showing pupil diameters during viewing of display.

FIG. 30 A diagram showing pupil diameters during viewing of display.

FIG. 31 A diagram showing a display example of a display device of Example.

FIG. 32 A diagram showing the voltage holding ratio of liquid crystal layers.

FIG. 33 A diagram showing the residual DC voltage of liquid crystal layers.

FIG. 34 A diagram showing changes in gray level after white display or black display.

FIG. 35 A diagram illustrating a change in pupil diameter.

FIG. 36 A diagram showing a display example of a display device of Example.

FIGS. 37A and 37B Diagrams showing time-dependent changes in l_{d}(t) and s_{d}(t).

FIGS. 38A and 38B Diagrams showing the dependence of visual stimulation on rewriting time and the results of subjective evaluation on flickering.

FIGS. 39A and 39B Diagrams showing changes in pupil diameter during viewing of a panel in which the same image is written after a voltage of one polarity is held for 60 s by 1/60 fps driving.

FIG. 40 A schematic diagram illustrating conditions for reflectance measurement.

FIG. 41 A diagram showing the NTSC ratio of a display device of Example.

FIG. 42 A diagram showing the characteristics of a transistor of Example.

FIGS. 43A and 43B Diagrams showing show electron diffraction patterns of a CAAC-OS.

FIG. 44 A diagram showing changes in crystal part of an In—Ga—Zn oxide induced by electron irradiation.

### MODE FOR CARRYING OUT THE INVENTION

Hereinafter, embodiments will be described with reference to drawings. Note that the embodiments can be implemented with various modes, and it will be readily appreciated by those skilled in the art that modes and details can be changed in various ways without departing from the spirit and scope of the present invention. Thus, the present invention should not be interpreted as being limited to the following description of the embodiments.

In the reference drawings, the size, the thickness of layers, and/or regions may be exaggerated for clarity in some cases. Therefore, embodiments of the present invention are not limited to such scales. Note that drawings are schematic views of ideal examples, and the embodiments of the present invention are not limited to the shape or the value illustrated in the drawings. For example, variation in signal, voltage, or current due to noise or difference in timing can be included.

Note that in this specification and the like, a transistor is an element having at least three terminals of a gate, a drain, and a source. In addition, the transistor has a channel region between a drain (a drain terminal, a drain region, or a drain electrode) and a source (a source terminal, a source region, or a source electrode), and current can flow through the drain, the channel region, and the source.

Here, since the source and the drain of the transistor change depending on the structure, operating conditions, and the like of the transistor, it is difficult to define which is a source or a drain. Thus, a portion which functions as the source and a portion which functions as the drain are not called a source and a drain and one of the source and the drain is referred to as a first electrode and the other thereof is referred to as a second electrode in some cases.

Note that in this specification, ordinal numbers such as “first”, “second”, and “third” are used in order to avoid confusion among components, and the terms do not limit the components numerically.

Note that in this specification, when it is described that “A and B are connected to each other”, the case where A and B are electrically connected to each other is included in addition to the case where A and B are directly connected to each other. Here, the description “A and B are electrically connected to each other” means the following case: when an object having any electrical function exists between A and B, an electric signal can be transmitted and received between A and B.

Note that in this specification, terms for describing arrangement, such as “over” and “under”, are used for convenience for describing a positional relation between components with reference to drawings. Further, a positional relation between components is changed as appropriate in accordance with a direction in which each component is described. Thus, there is no limitation to terms used in this specification, and description can be made appropriately depending on the situation.

Note that positional relations of circuit blocks in block diagrams are specified for description, and even in the case where different circuit blocks have different functions, they may be provided in an actual circuit or region so that different functions are achieved in the same circuit or block. In addition, functions of circuit blocks in block diagrams are specified for description, and even in the case where one circuit block is illustrated, blocks may be provided in an actual circuit or region so that processing performed by one circuit block is performed by a plurality of circuit blocks.

Note that a pixel corresponds to a display unit controlling the luminance of one color component (e.g., any one of R (red), G (green), and B (blue)). Therefore, in a color display device, the minimum display unit of a color image is composed of three pixels of an R pixel, a G pixel and a B pixel. Note that the color of the color elements is not necessarily of three varieties and may be of three or more varieties or may include a color other than RGB (e.g., white (W), yellow (Y)).

In this specification and the like, the term “parallel” indicates that the angle formed between two straight lines is greater than or equal to −10° and less than or equal to 10°, and accordingly includes the case where the angle is greater than or equal to −5° and less than or equal to 5°. The term “substantially parallel” indicates that the angle formed between two straight lines is greater than or equal to −30° and less than or equal to 30°. In addition, the term “perpendicular” indicates that an angle formed between two straight lines is greater than or equal to 80° and less than or equal to 100°, accordingly includes the case where the angle is greater than or equal to 85° and less than or equal to 95°. The term “substantially perpendicular” indicates that the angle formed between two straight lines is greater than or equal to 60° and less than or equal to 120°.

Unless otherwise specified, the off-state current in this specification and the like refers to a drain current of a transistor in the off state (also referred to as non-conduction state and cutoff state). Unless otherwise specified, the off state of an n-channel transistor means that the voltage between its gate and source (gate-source voltage) Vgs is lower than the threshold voltage Vth, and the off state of a p-channel transistor means that the voltage Vgs between its gate and source is higher than the gate-source voltage Vth. For example, in some cases, the off-state current of an n-channel transistor sometimes refers to a drain current that flows when the gate-source voltage Vgs is lower than the threshold voltage Vth.

The off-state current of a transistor depends on Vgs in some cases. Thus, “the off-state current of a transistor is smaller than or equal to I” means “there is Vgs with which the off-state current of a transistor becomes smaller than or equal to I” in some cases. Furthermore, “the off-state current of a transistor” means “the off-state current in an off state at predetermined Vgs”, “the off-state current in an off state at Vgs in a predetermined range”, “the off-state current in an off state at Vgs with which sufficiently reduced off-state current is obtained”, or the like.

As an example, the assumption is made of an n-channel transistor where the threshold voltage Vth is 0.5 V and the drain current is 1×10⁻⁹ A at Vgs of 0.5 V, 1×10⁻¹³ A at Vgs of 0.1 V, 1×10⁻¹⁹ A at Vgs of −0.5 V, and 1×10⁻²² A at Vgs of −0.8 V. The drain current of the transistor is 1×10⁻¹⁹ A or lower at Vgs of −0.5 V or at Vgs in the range of −0.8 V to −0.5 V; therefore, it can be said that the off-state current of the transistor is 1×10⁻¹⁹ A or lower. Since there is Vgs at which the drain current of the transistor is 1×10⁻²² A or lower, it may be said that the off-state current of the transistor is 1×10⁻²² A or lower.

In this specification and the like, the off-state current of a transistor with a channel width W is expressed by a value of a current flowing per channel width W or a value of a current flowing per predetermined channel width (e.g., 1 μm) in some cases. In the latter case, the unit of off-state current may be represented by current per length (e.g., A/μm).

The off-state current of a transistor depends on temperature in some cases. Unless otherwise specified, the off-state current in this specification and the like may be an off-state current at room temperature, 60° C., 85° C., 95° C., or 125° C. Alternatively, the off-state current may be an off-state current at a temperature at which the reliability of a semiconductor device or the like including the transistor is ensured or a temperature at which the semiconductor device or the like including the transistor is used (e.g., temperature in the range of 5° C. to 35° C.). “The off-state current of a transistor is less than or equal to I” means that there is a value of Vgs with which the off-state current of a transistor is less than or equal to I at room temperature, 60° C., 85° C., 95° C., 125° C., a temperature at which the reliability of a semiconductor device including the transistor is ensured, or a temperature at which the semiconductor device or the like including the transistor is used (e.g., a temperature in the range of 5° C. to 35° C.) in some cases.

The off-state current of a transistor depends on voltage Vds between its drain and source in some cases. Unless otherwise specified, the off-state current in this specification and the like may be an off-state current at Vds of 0.1 V, 0.8 V, 1 V, 1.2 V, 1.8 V, 2.5 V, 3 V, 3.3 V, 10 V, 12 V, 16 V, or 20 V. Alternatively, the off-state current may be an off-state current at Vds at which the reliability of a semiconductor device or the like including the transistor is ensured or Vds used in the semiconductor device or the like including the transistor. “The off-state current of a transistor is less than or equal to I” means that there is a value of Vgs with which the off-state current of a transistor is less than or equal to I at Vds of 0.1 V, 0.8 V, 1V, 1.2 V, 1.8 V, 2.5 V, 3 V, 3.3 V, 10 V, 12 V, 16 V, or 20 V, Vds at which the reliability of a semiconductor device including the transistor is ensured, or Vds at which the semiconductor device or the like including the transistor is used in some cases.

In the above description of off-state current, a drain may be replaced with a source. That is, the off-state current sometimes refers to a current that flows through a source of a transistor in the off state.

In this specification and the like, the term “leakage current” sometimes expresses the same meaning as off-state current. In this specification and the like, the off-state current sometimes refers to a current that flows between a source and a drain when a transistor is off, for example.

Note that in this specification and the like, the dielectric constant anisotropy of a liquid crystal layer is measured under the conditions that the measurement frequency is 1 kHz and the measurement temperature is 20° C.

### Embodiment 1

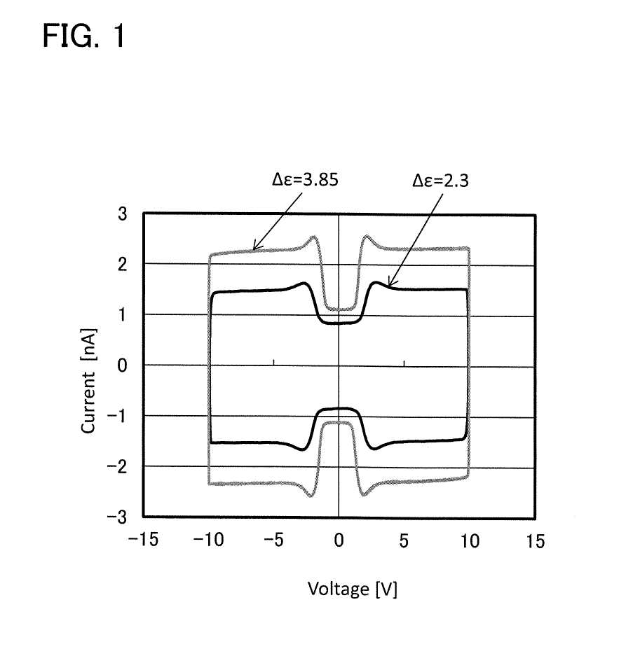

In this embodiment, a basic structure of one embodiment of the present invention is described. The basic operation of one embodiment of the present invention can be explained using graphs and schematic diagrams of FIG. 1 to FIG. 5.

A display device (also referred to as liquid crystal display device) of one embodiment of the present invention includes a pixel for displaying a still image at a frame frequency of 1 Hz or lower. A liquid crystal layer included in the pixel has a dielectric constant anisotropy (AE) of greater than or equal to 2 and less than or equal to 3.8.

First, an effect brought by setting the dielectric constant anisotropy of the liquid crystal layer to greater than or equal to 2 and less than or equal to 3.8 is described. The graph in FIG. 1 shows current-voltage characteristics of a liquid crystal layer having a dielectric constant anisotropy of 2.3 as an example of the liquid crystal layer having a dielectric constant anisotropy (AE) of greater than or equal to 2 and less than or equal to 3.8. For comparison, the graph in FIG. 1 also shows current-voltage characteristics of a liquid crystal layer having a dielectric constant anisotropy of 3.85 as an example of a liquid crystal layer having a dielectric constant anisotropy in excess of 3.8.

In the graph for a dielectric constant anisotropy of 2.3 in FIG. 1, current changes abruptly with an increase in voltage (at around −3 V and +3 V) and then becomes a steady state. Similarly, in the graph for a dielectric constant anisotropy of 3.85, current changes abruptly with an increase in voltage (at around −3 V and +3 V) and then becomes a steady state.

When the graphs for the different dielectric constant anisotropies shown in FIG. 1 are compared, a significant peak caused by an ionic impurity is not observed. However, a high dielectric constant anisotropy facilitates absorption of an ionic impurity, leading to a low resistivity.

A liquid crystal material of the liquid crystal layer with a dielectric constant anisotropy of 2.3 has a resistivity of 1.0×10¹⁴ Ω·cm or higher and 1.0×10¹⁵ Ω·cm or lower. A liquid crystal material of the liquid crystal layer with a dielectric constant anisotropy of 3.85 has a resistivity of 10¹³ Ω·cm or higher and lower than 1.0×10¹⁴ Ω·cm. Therefore, in the display device of one embodiment of the present invention, the dielectric constant anisotropy of the liquid crystal layer is preferably 2 or higher and 3.8 or lower, and the resistivity thereof is preferably 1.0×10¹⁴ Ω·cm or higher and 1.0×10¹⁵ Ω·cm or lower.

Here, the dielectric constant anisotropy is described. The dielectric constant anisotropy is also called dielectric anisotropy. A high dielectric anisotropy is preferable for displaying moving images.

When the dielectric constant anisotropy of a liquid crystal layer is high, interaction with an electric field is strong and the operation speed of the liquid crystal layer is high; thus, a liquid crystal display device including a liquid crystal layer having a high dielectric constant anisotropy can operate at a high speed.

However, when the dielectric constant anisotropy of a liquid crystal layer exceeds 3.8, an influence of an impurity included in the liquid crystal layer becomes significant as described above. It is difficult to remove the impurity in the liquid crystal layer, especially in the liquid crystal layer having a dielectric constant anisotropy in excess of 3.8. The impurity that remains in the liquid crystal layer increases the conductivity of the liquid crystal layer, which makes it difficult to keep voltage which has been applied to a pixel when the refresh rate is low.

On the other hand, there is an idea that a low dielectric constant anisotropy is preferable.

When the dielectric constant anisotropy of a liquid crystal layer is low, the amount of an impurity in the liquid crystal layer can be reduced, so that the liquid crystal layer can have a low conductivity. For this reason, the liquid crystal layer having a low dielectric constant anisotropy has an advantage in that voltage applied into a pixel can be kept longer when the refresh rate is low.

However, when the dielectric constant anisotropy of a liquid crystal layer is less than 2, interaction with an electric field is small and the operation speed of the liquid crystal layer is low; thus, a high driving voltage is needed for high speed operation. For this reason, a dielectric constant anisotropy of less than 2 is not suitable for a liquid crystal layer of a liquid crystal display device whose refresh rate is reduced for the purpose of low power consumption. In particular, high driving voltage is not preferable because the total power consumption of the liquid crystal display device significantly increases when driving at a low refresh rate is changed to driving at a higher refresh rate for displaying moving images.

Therefore, in one mode of this embodiment, it is preferable that the dielectric constant anisotropy of a liquid crystal layer be greater than or equal to 2 and less than or equal to 3.8. The liquid crystal layer having a dielectric constant anisotropy of greater than or equal to 2 and less than or equal to 3.8 can reduce the proportion of the impurity included therein and does not increase power consumption when moving image display is performed; thus, driving voltage of the liquid crystal layer can be set in a preferable range.

Note that in the case where the dielectric constant anisotropy of a liquid crystal layer is greater than or equal to 2 and less than or equal to 3.8, the driving voltage of the liquid crystal layer is preferably set high within the range without an increase in power consumption. A high driving voltage of the liquid crystal layer broadens an acceptable range of a deviation in gray level. In other words, flickering can be suppressed owing to a small deviation in gray level in accordance with a change in voltage because the driving voltage is high.

Note that although the liquid crystal layer with a dielectric constant anisotropy of 2 or higher and 3.8 or lower is described, preferable dielectric constant anisotropy is 2.2 or higher and 3.8 or lower. More preferable dielectric constant anisotropy is 2.2 or higher and 3.6 or lower.

In this embodiment, a liquid crystal layer in a twisted nematic (TN) mode is described as an example, but other modes can be employed.

As an operation mode of the liquid crystal layer other than the TN mode, an IPS (in-plane-switching) mode, an FFS (fringe field switching) mode, an MVA (multi-domain vertical alignment) mode, a PVA (patterned vertical alignment) mode, an ASM (axially symmetric aligned micro-cell) mode, an OCB (optical compensated birefringence) mode, an FLC (ferroelectric liquid crystal) mode, an AFLC (antiferroelectric liquid crystal) mode, or the like can be used. Note that the structure of a pixel electrode in each pixel in the display device can be changed as appropriate in accordance with the display mode.

By setting the dielectric constant anisotropy of the liquid crystal layer to greater than or equal to 2 and less than or equal to 3.8, a deviation in gray level can be kept within the acceptable range for displaying the same still image, so that flickering can be suppressed. As a result, display quality can be improved.

Note that the acceptable deviation in gray level for displaying the same still image is 0 or more and 3 or less when the image is displayed by controlling 256 levels of transmittance, for example. When the deviation in gray level for displaying the same still image is 0 or more and 3 or less, viewers hardly perceive flickering. As another example, when the image is displayed by controlling 1024 levels of transmittance, the acceptable range of a deviation in gray level is 0 or more and 12 or less. That is, the acceptable range of a deviation in gray level for displaying the same still image is preferably more than or equal to 1% and less than or equal to 1.2% of the maximum gray levels.

It is particularly preferable that the structure of the liquid crystal layer having a dielectric constant anisotropy of greater than or equal to 2 and less than or equal to 3.8, which is one embodiment of the present invention, be combined with a driving method by which moving image display and still image display are performed at different refresh rates. In a liquid crystal display device which operates at different refresh rates, when moving image display is changed to still image display, the frame frequency is changed from 60 Hz to less than or equal to 1 Hz, preferably from 60 Hz to less than or equal to 0.2 Hz, whereby the power consumption is reduced. That is, the structure of this embodiment is suitable as a structure in which the refresh rate is reduced at the time of still image display.

In the display device which performs display at different refresh rates, it is preferable to reduce power consumption and prevent a decrease in display quality at the time of moving image display and at the time of still image display. At the time of still image display, as the refresh rate is set lower, the time interval between applications of voltage to a pixel gets longer. In other words, when the refresh rate at the time of still image display is decreased, there is a certain period of time during which voltage is not applied to a pixel.

Accordingly, in the case of driving at a decreased refresh rate at the time of still image display, it is important to keep voltage applied to a pixel at a certain value. In addition, since the frame frequency is increased in the case of driving at an increased refresh rate at the time of moving image display, setting driving voltage low is important for reducing power consumption.

In one embodiment of the present invention, an impurity in the liquid crystal layer is reduced as compared with in a liquid crystal layer having a dielectric constant anisotropy in excess of 3.8. Accordingly, leakage current caused by impurity in the liquid crystal layer is small, so that voltage applied to a pixel can be kept when the refresh rate is low.

Furthermore, in the structure of one embodiment of the present invention, driving voltage can be set low as compared with in the case of a liquid crystal layer having a dielectric constant anisotropy of less than 2. In a liquid crystal display device which operates at a low driving voltage, an increase in power consumption, which is caused by an increase in frame frequency when still image display is changed to moving image display, can be suppressed.

In one embodiment of the present invention, since leakage current caused by an impurity in the liquid crystal layer can be small, flickering can be suppressed without providing a large storage capacitor in a pixel in advance. Since the design for suppressing flickering with a large storage capacitor is not necessary, a design with a small storage capacitor is possible, so that the pixel resolution can be increased. The high pixel resolution and a low refresh rate can reduce eyestrain.

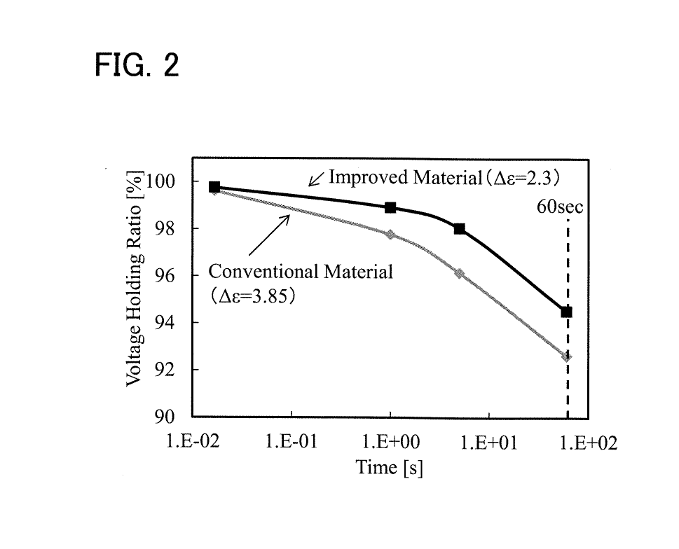

Here, the voltage holding ratio of a liquid crystal layer with a dielectric constant anisotropy of 2 or higher and 3.8 or lower is described. The graph in FIG. 2 shows time-dependent changes in voltage holding ratio. For the voltage holding ratio, calculated is an area ratio with a voltage held after a voltage of 5 V is applied to electrodes with the liquid crystal layer interposed therebetween and the electrodes are open-circuited.

The graph in FIG. 2 shows a result of a liquid crystal layer having a dielectric constant anisotropy of 2.3 as an example of a liquid crystal layer having a dielectric constant anisotropy of greater than or equal to 2 and less than or equal to 3.8, and also shows a result of a liquid crystal layer having a dielectric constant anisotropy of 3.85 as a comparative example. Liquid crystal materials of the liquid crystal layers are the same as those in FIG. 1. Note that the liquid crystal material of the liquid crystal layer with a dielectric constant anisotropy of 2.3 has a resistivity of 2.99×10¹⁴ Ω·cm, and the liquid crystal material of the liquid crystal layer with a dielectric constant anisotropy of 3.85 has a resistivity of 3.78×10¹³ Ω·cm.

In FIG. 2, the vertical axis represents voltage holding ratio (VHR) and the horizontal axis represents time.

According to the graph in FIG. 2, after a lapse of 60 s, the liquid crystal layer with a dielectric constant anisotropy of 3.85 (conventional material) has a voltage holding ratio of 92.6%, whereas the liquid crystal layer with a dielectric constant anisotropy of 2.3 (improved material) has a voltage holding ratio of 94.5%. Even in a period of time when voltage is not applied to the liquid crystal layer, the voltage holding ratio is preferably high in order to reduce a deviation in gray level.

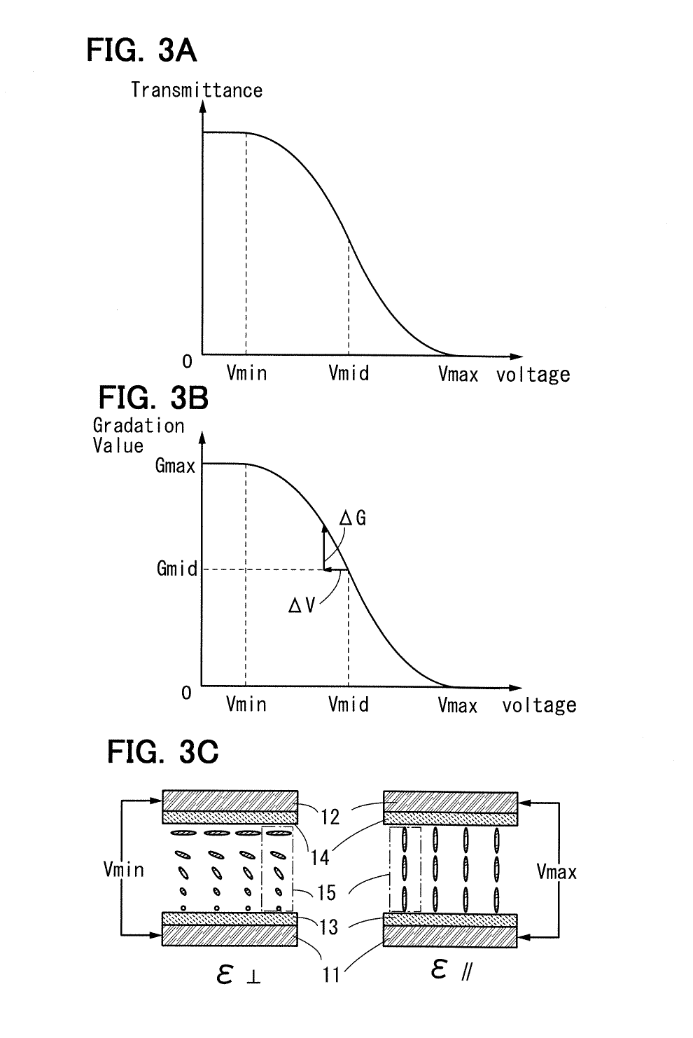

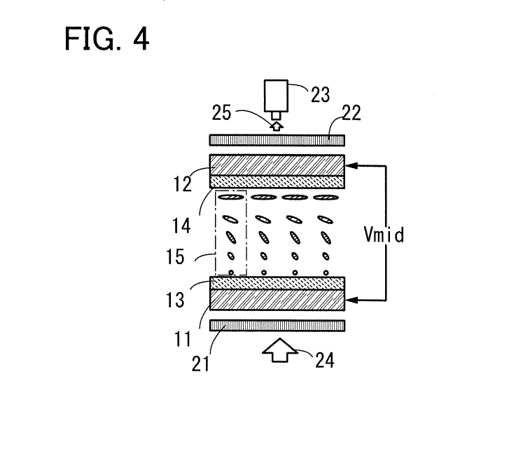

Next, using FIG. 3 and FIG. 4, description is made on the structure in FIG. 1 and FIG. 2 in which a deviation in gray level in accordance with a change in voltage applied to a pixel can be kept within an acceptable range by employing the liquid crystal layer having a dielectric constant anisotropy of greater than or equal to 2 and less than or equal to 3.8.

First, the characteristics of a liquid crystal layer are described with reference to FIG. 3.

FIG. 3A is a graph showing voltage-transmittance characteristics of a liquid crystal layer in the TN mode.

The graph in FIG. 3A shows a curve of a normally-white liquid crystal element. In a liquid crystal layer, orientations of liquid crystal molecules in the liquid crystal layer are changed by an electric field in accordance with voltage applied between electrodes between which the liquid crystal layer is sandwiched, whereby the transmittance of polarized light is controlled. In FIG. 3A, the voltage Vmax is voltage at which the transmittance of light through the liquid crystal layer becomes 0. The voltage Vmin is voltage at which the transmittance of light through the liquid crystal layer becomes the maximum value. The voltage Vmid is voltage at which the transmittance of light through the liquid crystal layer becomes a half value (50%).

The graph in FIG. 3B shows a relation of voltage applied to the liquid crystal layer and a gray level. In FIG. 3B, for example, in the case where a black image or a white image is displayed, the light transmittance is changed by application of the voltage Vmax or the voltage Vmin; thus, the image can be displayed by switching the gray level between 0 and Gmax.

In FIG. 3B, in the case where an image is displayed with multi gray levels for expressing a color shade, the voltages Vmax, Vmid, and Vmin are applied, so that the light transmittance is changed and the gray level is switched between Gmax, Gmid, and 0, whereby the image can be displayed. In order to increase the gray levels, a plurality of voltage levels is set between the voltage Vmax and the voltage Vmin. The light transmittance is changed in accordance with the voltage level, which is utilized for achieving a display device capable of displaying an image with a plurality of gray levels.

In that case, when a value of voltage applied to the liquid crystal layer is not changed, the light transmittance is also not changed; thus, a desired gray level can be obtained. On the other hand, a value of voltage applied to a liquid crystal layer in a pixel in an active-matrix liquid crystal display device including a liquid crystal element is changed with time due to current flowing through the liquid crystal layer. Specifically, as a certain period of time passes and the value of voltage is changed by ΔV, the gray level is also changed by AG. When the value of voltage applied to a pixel is changed to a value outside the acceptable range of a deviation in gray level for displaying the same still image, flickering might be perceived by viewers, which means a decrease in display quality.

FIG. 3C is a cross-sectional schematic view of electrodes between which a liquid crystal layer is sandwiched. FIG. 3C illustrates an oriented state of the liquid crystal layer to which the voltage Vmin in FIG. 3A is applied (an initial orientation state) and an oriented state of the liquid crystal layer to which the voltage Vmax is applied (an saturated orientation state).

Note that the initial orientation state refers to a state of liquid crystal molecules to which voltage is not applied. The initial orientation state in the TN liquid crystal is a state where liquid crystal molecules are twisted by 90° between electrodes. The saturated orientation state refers to a state of liquid crystal molecules to which voltage is applied in which the liquid crystal molecules are tilted or rise and the orientations are hardly changed by application of a higher voltage.

In FIG. 3C, cross sections of a first electrode 11, a second electrode 12, an alignment film 13, an alignment film 14, and a liquid crystal molecules 15 are illustrated. Note that the first electrode 11 corresponds to a pixel electrode, and the second electrode 12 corresponds to a counter electrode.

A dielectric constant in the initial orientation state is represented by ∈⊥, and a dielectric constant in the saturated orientation state is represented by ∈//. A difference between the dielectric constant ∈⊥ in the initial orientation state and the dielectric constant ∈// in the saturated orientation state corresponds to the dielectric constant anisotropy (Δ∈) described above.

FIG. 4 is a schematic view for observing a change in transmittance in the case where the voltage Vmid is applied between the electrodes illustrated in FIG. 3C between which the liquid crystal layer is sandwiched.

FIG. 4 illustrates an orientation state (also referred to as a middle orientation state, a gray level, or a half tone) of the liquid crystal layer to which the voltage Vmid described with reference to FIG. 3A is applied. FIG. 4 illustrates a polarizing plate 21, a polarizing plate 22, and a light detector 23, in addition to the first electrode 11, the second electrode 12, the alignment film 13, the alignment film 14, and the liquid crystal molecules 15 illustrated in FIG. 3C. In FIG. 4, arrows represent light; an arrow 24 represents light that enters the liquid crystal layer and an arrow 25 represents light that is transmitted through the liquid crystal layer. Note that the light represented by the arrow 24 corresponds to backlight of the display device. Note that a liquid crystal element may refer to a structure including the first electrode 11, the second electrode 12, the alignment film 13, the alignment film 14, the liquid crystal molecules 15, the polarizing plate 21, and the polarizing plate 22 illustrated in FIG. 4.

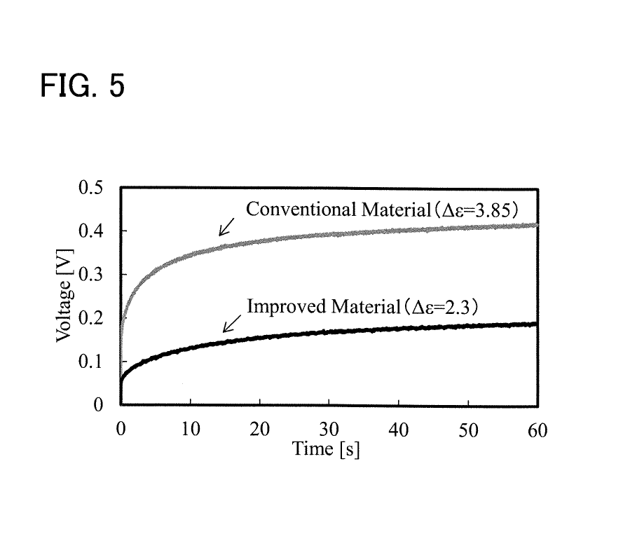

Here, residual DC depending on a change in voltage written to a pixel when a dielectric constant anisotropy of the liquid crystal layer described with reference to FIG. 1 and FIG. 2 is higher than or equal to 2 and lower than or equal to 3.8, is described with reference to FIG. 5.

Note that the residual DC refers to voltage generated by electric charges remaining between the electrodes when voltage is applied to the liquid crystal layer. By the residual DC, an extra voltage is applied between the electrodes when a predetermined voltage is applied to the liquid crystal layer. In addition, even in a period of time when voltage is not applied to the liquid crystal layer, voltage remains between the electrodes due to electric charges which remain in the liquid crystal layer. Note that in the structure in which a liquid crystal material is sandwiched between electrodes and alignment films are provided on the electrodes, “between the electrodes” means between the alignment films.

The graph in FIG. 5 shows a liquid crystal layer having a dielectric constant anisotropy of 2.3 as an example of a liquid crystal layer having a dielectric constant anisotropy of greater than or equal to 2 and less than or equal to 3.8. The graph in FIG. 5 also shows a liquid crystal layers having dielectric constant anisotropies of 3.85 as a comparative example. Liquid crystal materials of the liquid crystal layers are the same as those in FIG. 1 and FIG. 2.

FIG. 5 shows a time-dependent change in voltage in a state where a voltage of 5 V is applied between electrodes between which a liquid crystal layer is sandwiched for one minute, and the electrodes are short-circuited for one second, and then the electrodes are open-circuited. In FIG. 5, the vertical axis represents voltage and the horizontal axis represents time.

The graph in FIG. 5 shows that the liquid crystal layer with a dielectric constant anisotropy of 2.3 (improved material) has a lower residual DC voltage than the liquid crystal layer with a dielectric constant anisotropy of 3.85 (conventional material).

By comparing the lines with different dielectric constant anisotropies in FIG. 5, it is found that the voltage just after the electrodes are open-circuited is higher in the liquid crystal layer having a larger dielectric constant anisotropy. A reason of the difference in voltage depending on the liquid crystal materials is that a large dielectric constant anisotropy increases the proportion of an impurity in the liquid crystal layer. Therefore, by employing the structure of one embodiment of the present invention with a dielectric constant anisotropy of greater than or equal to 2 and less than or equal to 3.8, in which the proportion of an impurity in the liquid crystal layer is low, an influence of the residual DC just after the electrodes are open-circuited can be reduced.

When Formula 1 derived from Maxwell-Wagner theory about multilayer dielectric is satisfied, electric charges accumulated at the interface between the alignment film and the liquid crystal layer can be reduced, so that the residual DC can be reduced. Note that in Formula 1, ∈_{LC} represents a dielectric constant of the liquid crystal layer, ρ_{LC} represents a resistivity of the liquid crystal layer, ∈_{AL} represents a dielectric constant of the alignment film, and ρ_{AL} represents a resistivity of the alignment film.

[Formula 1]

∈_{LC}·ρ_{LC}=∈_{AL}·ρ_{AL} (1)

To obtain a relation close to the relation in Formula 1, it is preferable that the resistivity of the liquid crystal layer and the resistivity of the alignment film be close to each other as much as possible. Since the alignment film has higher resistivity than the liquid crystal layer, to make the resistivities of the liquid crystal layer and the alignment film close to each other, it is necessary to increase the resistivity of the liquid crystal layer or decrease the resistivity of the alignment film. As described above, it is preferable to increase the resistivity of the liquid crystal layer.

As described above, with the use of the liquid crystal layer with a dielectric constant anisotropy ranging from 2 to 3.8 and a material which makes the voltage holding ratio of the liquid crystal layer high, the residual DC can be suppressed. In other words, a change in voltage written to a pixel can be kept within an acceptable range of a deviation in gray level for displaying the same still image. Thus, a novel display device without deterioration in display quality can be provided.

Note that this embodiment can be combined with any of the other embodiments in this specification as appropriate.

### Embodiment 2

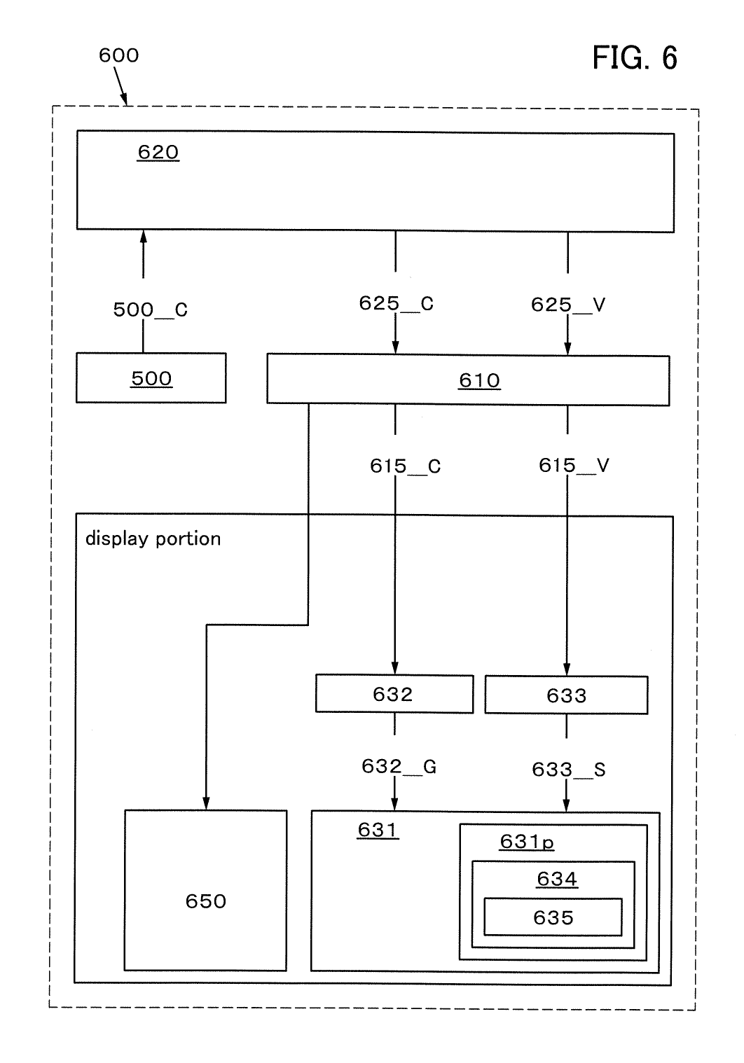

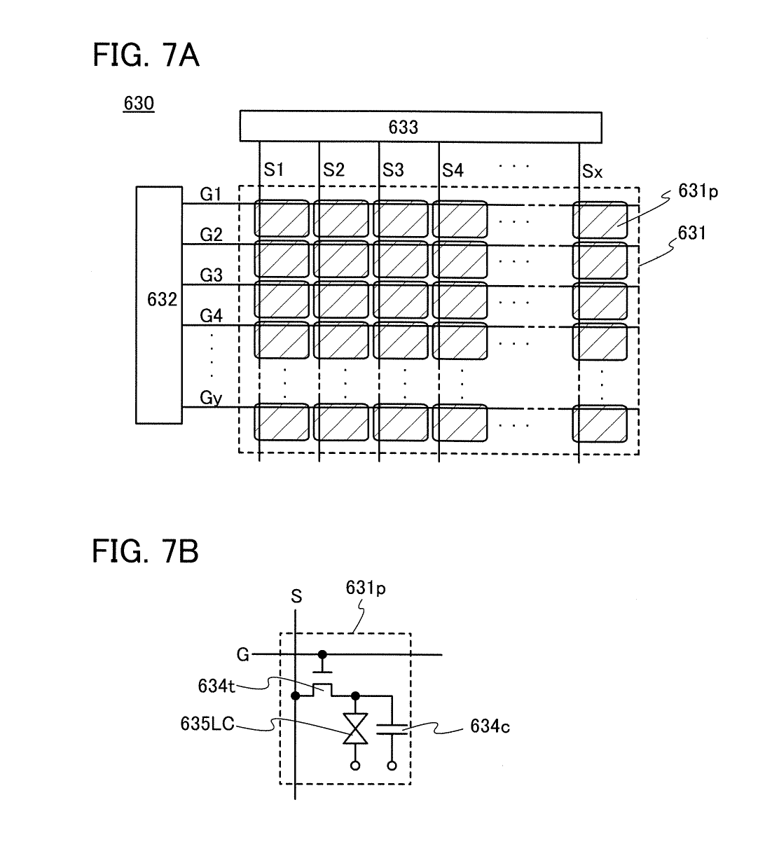

In this embodiment, an example of a liquid crystal display device including the liquid crystal layer described in Embodiment 1 is described with reference to FIG. 6 and FIG. 7.

Specifically, a liquid crystal display device which has a first mode in which a G signal is output at a frequency of 60 Hz or higher and a second mode in which the G signal is output at a frequency of 1 Hz or lower, preferably 0.2 Hz or lower is described. The G signal selects a pixel.

FIG. 6 is a block diagram of a structure of a liquid crystal display device having a display function of one embodiment of the present invention.

FIG. 7 are a block diagram and a circuit diagram of a structure of a display portion in the liquid crystal display device having a display function of one embodiment of the present invention.

### <1. Structure of Liquid Crystal Display Device>

A liquid crystal display device 600 having a display function, which is described as an example in this embodiment and illustrated in FIG. 6, includes a pixel portion 631 including pixel circuits 634; the pixel circuits 634 which hold first driving signals (also referred to as S signals) 633_S input and include display elements 635; the display elements 635 display an image on the pixel portion 631 in accordance with the S signals 633_S; a first driver circuit (also referred to as S driver circuit) 633 which outputs the S signals 633_S to the pixel circuits 634; and a second driver circuit (also referred to as G driver circuit) 632 which outputs second driving signals (also referred to as G signals) 632_G for selecting the pixel circuits 634 to the pixel circuits 634.

The G driver circuit 632 has a first mode in which a G signal 632_G is output to a pixel at a frequency of 30 or more times per second, preferably a frequency of 60 or more times and less than 960 times per second and a second mode in which the G signal 632_G is output to a pixel at a frequency of one or more times per day and less than 0.1 time per second, preferably a frequency of one or more times per hour and less than once per second.

Note that in the G driver circuit 632, the first mode and the second mode are switched in accordance with a mode-switching signal.

The pixel circuit 634 is provided in a pixel 631p. A plurality of pixels 631p is provided in the pixel portion 631. The pixel portion 631 is provided in a display portion 630.

The liquid crystal display device 600 having a display function includes an arithmetic unit 620. The arithmetic unit 620 outputs a first-order control signal 625_C and a first-order image signal 625_V.

The liquid crystal display device 600 includes a control unit 610. The control unit 610 controls the S driver circuit 633 and the G driver circuit 632.

In the case where a liquid crystal element is used as the display element 635, a light supply portion 650 is provided in the display portion 630. The light supply portion 650 supplies light to the pixel portion 631 including the liquid crystal element, and functions as a backlight.

In the liquid crystal display device 600 having a display function, the frequency for selecting one from a plurality of pixel circuits 634 in the pixel portion 631 can be changed by the G signal 632_G output from the G driver circuit 632. As a result, the liquid crystal display device 600 can have a display function which gives less eyestrain to users.

Elements included in the liquid crystal display device having a display function of one embodiment of the present invention are described below.

### <2. Arithmetic Unit>

The arithmetic unit 620 generates the first-order image signal 625_V and the first-order control signal 625_C.

The first-order control signal 625_C generated by the arithmetic unit 620 includes the mode-switching signal.

For example, the arithmetic unit 620 may output the first-order control signal 625_C including the mode-switching signal in accordance with an image-switching signal 500_C output from an input unit 500.

When the image-switching signal 500_C is input to the G driver circuit 632 in the second mode from the input unit 500 through the control unit 610, the G driver circuit 632 switches its mode from the second mode to the first mode, and outputs a G signal at least once, and then switches its modes to the second mode.

For example, when the input unit 500 senses a page turning operation, the input unit 500 outputs the image-switching signal 500_C to the arithmetic unit 620.

The arithmetic unit 620 generates the first-order image signal 625_V including the page turning operation signal and outputs the first-order image signal 625_V together with the first-order control signal 625_C including the image-switching signal 500_C.

The control unit 610 outputs the image-switching signal 500_C to the G driver circuit 632 and outputs the second-order image signal 615_V including the page turning operation signal to the S driver circuit 633.

The G driver circuit 632 switches its modes from the second mode to the first mode, and outputs the G signal 632_G at a rate at which viewers cannot perceive a change in image by signal rewrite operation.

Meanwhile, the S driver circuit 633 outputs to the pixel circuits 634 the S signals 633_S generated from the second-order image signal 615_V including the page turning operation signal.

The second-order image signal 615_V including the page turning operation signal is applied to the pixel 631p; thus, the pixel 631p can display many frame images including the page turning operation for a short time, resulting in smooth page turning operation.

The arithmetic unit 620 may be configured to determine whether the first-order image signal 625_V output from the arithmetic unit 620 to the display portion 630 is an moving image or a still image, and output a signal for selecting the first mode when the first-order image signal 625_V is a moving image and output a signal for selecting the second mode when the first-order image signal 625_V is a still image.

Whether the first-order image signal 625_V is a moving image or a still image can be determined in accordance with a difference in signal between one frame in the first-order image signal 625_V and the previous or next frame. When the difference is larger than a predetermined value, the signal is a moving image; when the difference is less than or equal to the predetermined value, the signal is a still image.

Alternatively, a structure can be employed in which when the second mode is switched to the first mode, the G signal 632_G is output a predetermined number of times which is larger than or equal to one, and then the first mode is switched to the second mode.

### <3. Control Unit>

The control unit 610 outputs the second-order image signal 615_V generated from the first-order image signal 625_V (see FIG. 6). Note that the control unit 610 may be configured to output the first-order image signal 625_V directly to the display portion 630.

The control unit 610 has a function of generating a second-order control signal 615_C (e.g., a start pulse signal SP, a latch signal LP, or a pulse width control signal PWC) from the first-order control signal 625_C including a synchronization signal (e.g., a vertical synchronization signal or a horizontal synchronization signal) and supplying the generated signal to the display portion 630. Note that the second-order control signal 615_C includes a clock signal CK or the like.

The control unit 610 may be provided with an inversion control circuit to have a function of inverting the polarity of the second-order image signal 615_V at a timing notified by the inversion control circuit. Specifically, the inversion of the polarity of the second-order image signal 615_V may be performed in the control unit 610 or in the display portion 630 in accordance with an instruction by the control unit 610.

The inversion control circuit has a function of determining timing of inverting the polarity of the second-order image signal 615_V by using a synchronization signal. For example, the inversion control circuit includes a counter and a signal generation circuit.

The counter has a function of counting the number of frame periods by using the pulse of a horizontal synchronization signal.

The signal generation circuit has a function of notifying timing of inverting the polarity of the second-order image signal 615_V to the control unit 610 so that the polarity of the second-order image signal 615_V is inverted every plural consecutive frame periods by using information on the number of frame periods that is obtained in the counter.

### <4. Display Portion>

The display portion 630 includes the pixel portion 631 including a display element 635 in each pixel and driver circuits such as the S driver circuit 633 and the G driver circuit 632. The pixel portion 631 includes a plurality of pixels 631p each provided with the display element 635 (see FIG. 6).

The second-order image signal 615_V that are input to the display portion 630 are supplied to the S driver circuit 633. In addition, power supply potentials and the second-order control signal 615_C are supplied to the S driver circuit 633 and the G driver circuit 632.

Note that the second-order control signals 615_C include an S driver circuit start pulse signal SP and an S driver circuit clock signal CK that control the operation of the S driver circuit 633; a latch signal LP; a G driver circuit start pulse SP and a G driver circuit clock signal CK that control the operation of the G driver circuit 632; a pulse width control signal PWC; and the like.

FIG. 7A illustrates an example of a structure of the display portion 630.

In the display portion 630 in FIG. 7A, the plurality of pixels 631p, a plurality of scan lines G for selecting the pixels 631p row by row, and a plurality of signal lines S for supplying the S signals 633_S generated from the second-order image signal 615_V to the selected pixels 631p are provided in the pixel portion 631.

The input of the G signals 632_G to the scan lines G is controlled by the G driver circuit 632. The input of the S signals 633_S to the signal lines S is controlled by the S driver circuit 633. Each of the plurality of pixels 631p is connected to at least one of the scan lines G and at least one of the signal lines S.

Note that the kinds and number of the wirings in the pixel portion 631 can be determined by the structure, number, and position of the pixels 631p. Specifically, in the pixel portion 631 illustrated in FIG. 7A, the pixels 631p are arranged in a matrix of x columns and y rows, and the signal lines S1 to Sx and the scan lines G1 to Gy are provided in the pixel portion 631.

### <4-1. Pixel>

Each pixel 631p includes the display element 635 and the pixel circuit 634 including the display element 635.

### <4-2. Pixel Circuit>

In this embodiment, FIG. 7B illustrates an example of a structure of the pixel circuit 634 in which a liquid crystal element 635LC is used as the display element 635.

The pixel circuit 634 includes a transistor 634t for controlling supply of the S signal 633_S to the liquid crystal element 635LC. An example of connection relation between the transistor 634t and the display element 635 is described.

A gate of the transistor 634t is connected to any one of the scan lines G1 to Gy. One of a source and a drain of the transistor 634t is connected to any one of the signal lines S1 to Sx. The other of the source and the drain of the transistor 634t is connected to a first electrode of the display element 635.

Note that pixel 631p may include, in addition to the capacitor 634c for holding voltage between a first electrode and a second electrode of the liquid crystal element 635LC, another circuit element such as a transistor, a diode, a resistor, a capacitor, or an inductor as needed.

In the pixel 631p illustrated in FIG. 7B, one transistor 634t is used as a switching element for controlling input of the S signal 633_S to the pixel 631p. However, a plurality of transistors which serve as one switching element may be used in the pixel 631p. In the case where the plurality of transistors serve as one switching element, the transistors may be connected to one another in parallel, in series, or in combination of parallel connection and series connection.

Note that the capacitance of the pixel circuit 634 may be adjusted as appropriate. For example, in the second mode to be described later, in the case where the S signal 633_S is held for a relatively long time (specifically, greater than or equal to 1/60 sec), the capacitor 634c is provided. Alternatively, the capacitance of the pixel circuit 634 may be adjusted by utilizing a structure other than the capacitor 634c. For example, with a structure in which the first electrode and the second electrode of the liquid crystal element 635LC are formed to overlap with each other, a capacitor may be substantially formed.

Note that the structure of the pixel circuit 634 can be selected depending on the kind of the display element 635 or the driving method.

<4-2a. Display Element>

The liquid crystal element 635LC includes a first electrode, a second electrode, and a liquid crystal layer including a liquid crystal material to which the voltage between the first electrode and the second electrode is applied. In the liquid crystal element 635LC, the alignment of liquid crystal molecules is changed in accordance with the level of voltage applied between the first electrode and the second electrode, so that the transmittance is changed. Accordingly, the transmittance of the display element 635 is controlled by the potential of the S signal 633_S; thus, gradation can be expressed.

<4-2b. Transistor>

The transistor 634t controls whether to apply the potential of the signal line S to the first electrode of the display element 635. A predetermined reference potential Vcom is applied to the second electrode of the display element 635.

Note that a transistor including an oxide semiconductor can be suitably used as the transistor in the liquid crystal display device of one embodiment of the present invention. Embodiments 6 and 7 can be referred to for details of the transistor including an oxide semiconductor.

### <5. Light Supply Portion>

A plurality of light sources is provided in the light supply portion 650. The control unit 610 controls driving of the light sources in the light supply portion 650. Note that in the case of a reflective liquid crystal display device, the light supply portion 650 is not necessarily provided.

The light source in the light supply portion 650 can be a cold cathode fluorescent lamp, a light-emitting diode (LED), an OLED element generating luminescence (electroluminescence) when an electric field is applied thereto, or the like. A coloring method of the light source in the light supply portion 650 is, for example, a method in which light emission of red, green, and blue is used (a three-color method), a method in which part of blue light emission is converted into red or green (a color conversion method or a quantum dot method), or a method in which part of white light emission is converted into red, green, and blue by being transmitted through a color filter (a color filter method).

### <6. Input Unit>

As the input unit 500, a touch panel, a touch pad, a mouse, a finger joystick, a trackball, a data glove, or an imaging device can be used, for example. In the arithmetic unit 620, an electric signal output from the input unit 500 can be associated with coordinates of a display portion. Accordingly, users can input an instruction for processing information displayed on the display portion.

Examples of information input with the input unit 500 by users are instructions for dragging an image displayed on the display portion to another position on the display portion; for swiping a screen for turning a displayed image and displaying the next image; for scrolling a continuous image; for selecting a specific image; for pinching a screen for changing the size of a displayed image; and for inputting handwritten characters.

Note that this embodiment can be combined with any of the other embodiments in this specification as appropriate.

### Embodiment 3

In this embodiment, an example of a method for driving the liquid crystal display device described in Embodiment 2 is described with reference to FIG. 7 and FIG. 8.

FIG. 7 are a block diagram and a circuit diagram illustrating a configuration of a display portion of a liquid crystal display device having a display function in one embodiment of the present invention.

FIG. 8 is a block diagram illustrating a modification example of a configuration of a display portion of a liquid crystal display device having a display function in one embodiment of the present invention.

<1. Method for Writing S Signals into Pixel Portion>

An example of a method for writing the S signals 633_S into the pixel portion 631 in FIG. 7A or FIG. 8 is described. Specifically, the method described here is a method for writing the S signal 633_S into each pixel 631p including the pixel circuit illustrated in FIG. 7B in the pixel portion 631.

<Writing Signals into Pixel Portion>

In a first frame period, the scan line G1 is selected by input of the G signal 632_G with a pulse to the scan line G1. In each of the plurality of pixels 631p connected to the selected scan line G1, the transistor 634t is turned on.

When the transistors 634t are on (in one line period), the potentials of the S signals 633_S generated from the second-order image signals 615_V are applied to the signal lines S1 to Sx. Through each of the transistors 634t that are on, charge corresponding to the potential of the S signal 633_S is accumulated in the capacitor 634c and the potential of the S signal 633_S is applied to a first electrode of the liquid crystal element 635LC.

In a period during which the scan line G1 is selected in the first frame period, the S signals 633_S having a positive polarity are sequentially input to all the signal lines S1 to Sx. Thus, the S signals 633_S having a positive polarity are input to first electrodes G1S1 to GlSx in the pixels 631p that are connected to the scan line G1 and the signal lines S1 to Sx. Accordingly, the transmittance of the liquid crystal element 635LC is controlled by the potential of the S signal 633_S; thus, gradation is expressed by the pixels.

Similarly, the scan lines G2 to Gy are sequentially selected, and the pixels 631p connected to the scan lines G2 to Gy are sequentially subjected to the same operation as that performed while the scan line G1 is selected. Through the above operations, an image for the first frame can be displayed on the pixel portion 631.

Note that in one embodiment of the present invention, the scan lines G1 to Gy are not necessarily selected sequentially.

It is possible to employ dot sequential driving in which the S signals 633_S are sequentially input to the signal lines S1 to Sx from the S driver circuit 633 or line sequential driving in which the S signals 633_S are input all at once. Alternatively, a driving method in which the S signals 633_S are sequentially input to every plural signal lines S may be employed.

In addition, the method for selecting the scan lines G is not limited to progressive scan; interlaced scan may be employed for selecting the scan lines G.

In given one frame period, the polarities of the S signals 633_S input to all the signal lines may be the same, or the polarities of the S signals 633_S to be input to the pixels may be inverted signal line by signal line.

<Writing Signals into Pixel Portion Divided into Plurality of Regions>

FIG. 8 illustrates a modification example of the structure of the display portion 630.

In the display portion 630 in FIG. 8, the plurality of pixels 631p, the plurality of scan lines G for selecting the pixels 631p row by row, and the plurality of signal lines S for supplying the S signals 633_S to the selected pixels 631p are provided in the pixel portion 631 divided into a plurality of regions (specifically, a first region 631a, a second region 631b, and a third region 631c).

The input of the G signals 632_G to the scan lines G in each region is controlled by the corresponding G driver circuit 632. The input of the S signals 633_S to the signal lines S is controlled by the S driver circuit 633. Each of the plurality of pixels 631p is connected to at least one of the scan lines G and at least one of the signal lines S.

Such a structure allows the pixel portion 631 to be divided into separately driven regions.

For example, the following operation is possible: when information is input from a touch panel used as the input unit 500, coordinates specifying a region to which the information is to be input are obtained, and the G driver circuit 632 driving the region corresponding to the coordinates operates in the first mode and the G driver circuit 632 driving the other region operates in the second mode. Thus, it is possible to stop the operation of the G driver circuit for a region where information has not been input from the touch panel, that is, a region where rewriting of a displayed image is not necessary.

### <2. G Driver Circuit in First Mode and Second Mode>

The S signal 633_S is input to the pixel circuit 634 to which the G signal 632_G output by the G driver circuit 632 is input. In a period during which the G signal 632_G is not input, the pixel circuit 634 holds the potential of the S signal 633_S. In other words, the pixel circuit 634 holds a state where the potential of the S signal 633_S is written in.

The pixel circuit 634 into which display data is written maintains a display state corresponding to the S signal 633_S. Note that to maintain a display state is to keep the amount of change in display state within a given range. This given range is set as appropriate, and is preferably set so that a user viewing displayed images can recognize the displayed images as the same image.

The G driver circuit 632 has the first mode and the second mode.

### <2-1. First Mode>

The G driver circuit 632 in the first mode outputs the G signals 632_G to pixels at a rate of higher than or equal to 30 times per second, preferably higher than or equal to 60 times per second and lower than 960 times per second.

The G driver circuit 632 in the first mode rewrites signals at a speed such that change in images which occurs each time signals are rewritten is not recognized by the user. As a result, a smooth moving image can be displayed.

### <2-2. Second Mode>

The G driver circuit 632 in the second mode outputs the G signals 632_G to pixels at a rate of higher than or equal to once per day and lower than 0.1 times per second, preferably higher than or equal to once per hour and lower than once per second.

In a period during which the G signal 632_G is not input, the pixel circuit 634 keeps holding the S signal 633_S and maintains the display state corresponding to the potential of the S signal 633_S.

In this manner, display without flickering due to rewriting of the display in the pixel can be performed in the second mode.

As a result, eyestrain of a user of the liquid crystal display device having a display function can be reduced.

Power consumed by the G driver circuit 632 is reduced in a period during which the G driver circuit 632 does not operate.

Note that the pixel circuit that is driven by the G driver circuit 632 having the second mode is preferably configured to hold the S signal 633_S for a long period. For example, the off-state leakage current of the transistor 634t is preferably as low as possible.

Embodiments 6 and 7 can be referred to for examples of a structure of the transistor 634t with low off-state leakage current.

Note that this embodiment can be combined with any of the other embodiments in this specification as appropriate.

### Embodiment 4

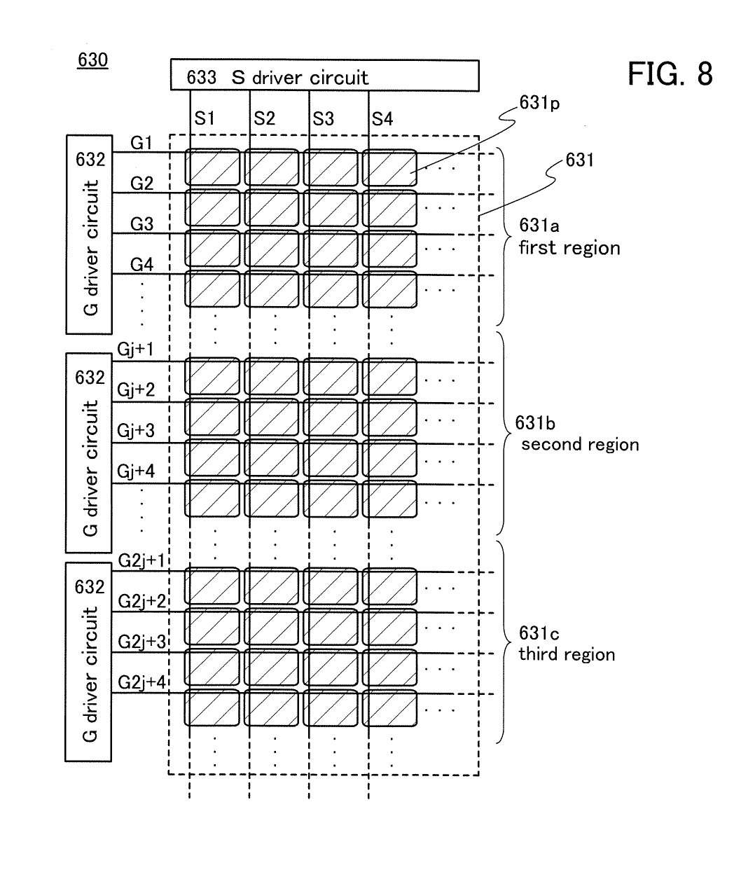

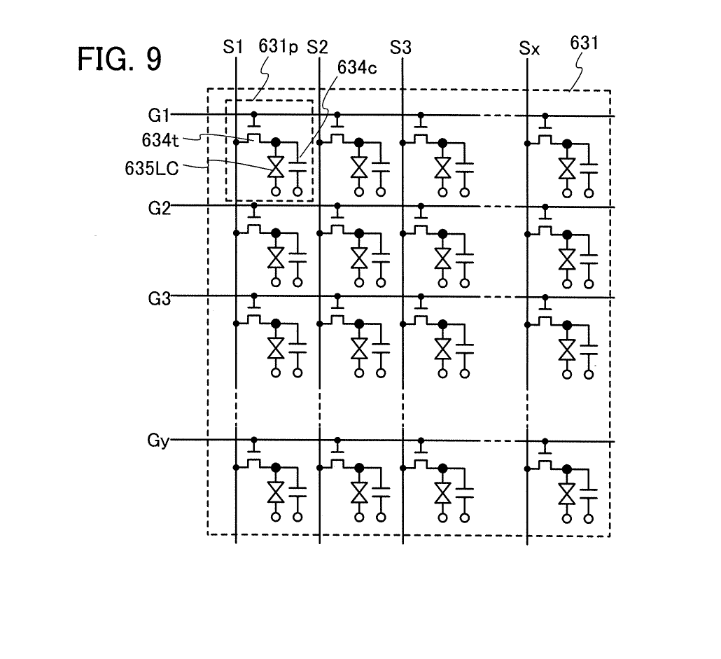

In this embodiment, an example of a method for driving the liquid crystal display device described in Embodiment 2 is described with reference to FIG. 9 to FIG. 11.

FIG. 9 is a circuit diagram illustrating a liquid crystal display device having a display function in one embodiment of the present invention.

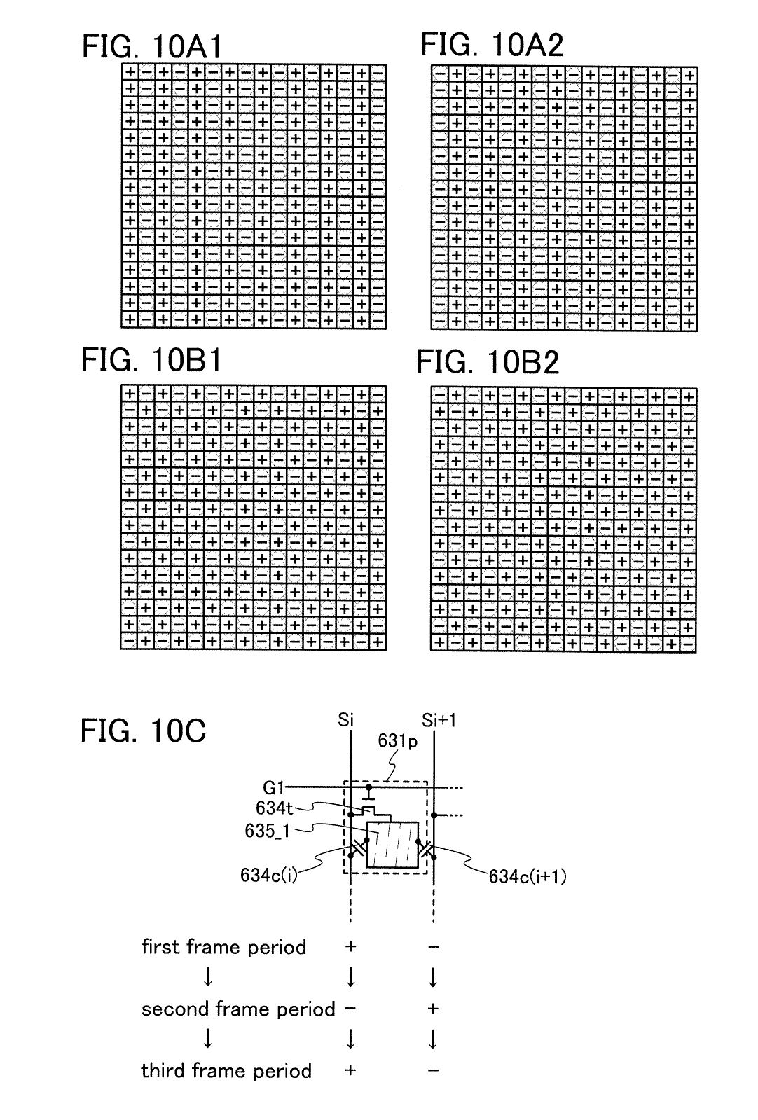

FIG. 10 illustrate source line inversion driving and dot line inversion driving of a liquid crystal display device having a display function in one embodiment of the present invention.

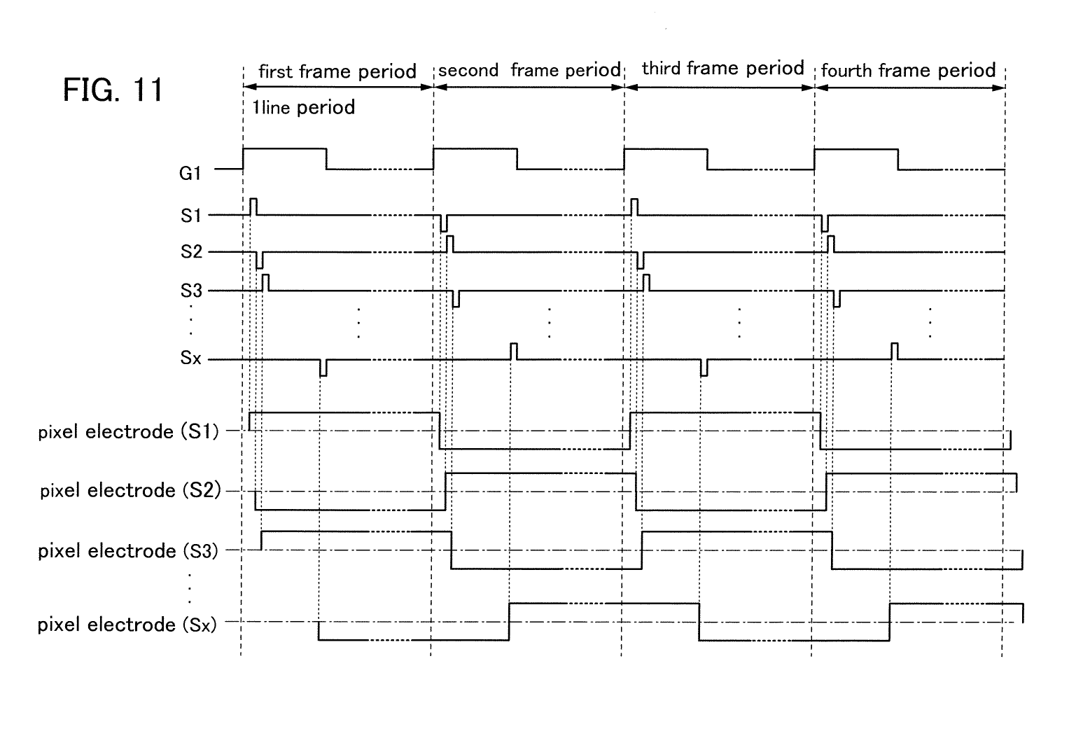

FIG. 11 is a timing chart illustrating source line inversion driving and dot line inversion driving of a liquid crystal display device having a display function in one embodiment of the present invention.

### <1. Overdriving>

The response time of liquid crystal from application of voltage to saturation of the change in transmittance is generally about ten milliseconds. Thus, the slow response of the liquid crystal tends to be perceived as a blur of a moving image.

As a countermeasure, in one embodiment of the present invention, overdriving may be employed in which the voltage applied to the display element 635 including the liquid crystal element is temporarily increased so that the alignment of liquid crystal changes quickly. By overdriving, the response speed of the liquid crystal can be increased, a blur of a moving image can be prevented, and the quality of the moving image can be improved.

Further, if the transmittance of the display element 635 including the liquid crystal element keeps changing without reaching a constant value after the transistor 634t is turned off, the relative permittivity of the liquid crystal also changes; accordingly, the voltage held in the display element 635 including the liquid crystal element easily changes.

For example, in the case where no capacitor is connected in parallel to the display element 635 including the liquid crystal element or in the case where the capacitor 634c connected in parallel to the display element 635 including the liquid crystal element has small capacitance, the change in the voltage held in the display element 635 including the liquid crystal element tends to occur markedly. However, by the overdriving, the response time can be shortened and therefore the change in the transmittance of the display element 635 including the liquid crystal element after the transistor 634t is turned off can be made small. Accordingly, even in the case where the capacitor 634c connected in parallel to the display element 635 including the liquid crystal element has small capacitance, the change in the voltage held in the display element 635 including the liquid crystal element after turning off the transistor 634t can be prevented.

### <2. Source Line Inversion Driving and Dot Inversion Driving>

In the pixel 631p to which the signal line Si of the pixel circuit illustrated in FIG. 10 is connected, the pixel electrode 635_1 is positioned between the signal line Si and a signal line Si+1 that is adjacent to the signal line Si. If the transistor 634t is off, it is ideal that the pixel electrode 635_1 and the signal line Si are electrically separated from each other. Further, ideally, the pixel electrode 635_1 and the signal line Si+1 are electrically separated from each other. However, there actually exist a parasitic capacitance 634c(i) between the pixel electrode 635_1 and the signal line Si, and a parasitic capacitance 634c(i+1) between the pixel electrode 635_1 and the signal line Si+1 (see FIG. 10C). Note that FIG. 10C illustrates a pixel electrode 635_1 serving as a first electrode or a second electrode of the liquid crystal element 635LC, instead of the liquid crystal element 635LC illustrated in FIG. 9.

For example, when a structure is employed in which the first electrode and the second electrode of the liquid crystal element 635LC overlap with each other and the overlap between the two electrodes is practically utilized as a capacitor, there are cases where the capacitor 634c formed using a capacitor line is not connected to the liquid crystal element 635LC, or where the capacitor 634c connected to the liquid crystal element 635LC has a small capacitance. In such cases, the potential of the pixel electrode 635_1 serving as the first electrode or the second electrode of the liquid crystal element is easily affected by the parasitic capacitance 634c(i) and the parasitic capacitor 634c(i+1).

This tends to cause a phenomenon in which even when the transistor 634t is off in the period during which the potential of an image signal is held, the potential of the pixel electrode 635_1 fluctuates in conjunction with a change in the potential of the signal line Si or the signal line Si+1.

The phenomenon in which in the period during which the potential of an image signal is held, the potential of a pixel electrode fluctuates in conjunction with a change in the potential of a signal line is referred to as crosstalk. Crosstalk causes degradation of display contrast. For example, in the case of using normally-white liquid crystal for the liquid crystal element 635LC, images are whitish.

In one embodiment of the present invention, in view of the above situation, a driving method may be employed in which image signals having opposite polarities are input to the signal line Si and the signal line Si+1 arranged with the pixel electrode 635_1 provided therebetween, in one given frame period.

Note that the “image signals having opposite polarities” means, on the assumption that the potential of a common electrode of the liquid crystal element is a reference potential, an image signal having a potential higher than the reference potential and an image signal having a potential lower than the reference potential.

Two methods (source line inversion and dot inversion) can be given as examples of a method for sequentially writing image signals having alternating opposite polarities into a plurality of pixels which are selected.

In either method, in a first frame period, an image signal having a positive (+) polarity is input to the signal line Si and an image signal having a negative (−) polarity is input to the signal line Si+1. Next, in a second frame period, an image signal having a negative (−) polarity is input to the signal line Si and an image signal having a positive (+) polarity is input to the signal line Si+1. Then, in a third frame period, an image signal having a positive (+) polarity is input to the signal line Si and an image signal having a negative (−) polarity is input to the signal line Si+1 (see FIG. 10C).

When such a driving method is employed, the potentials of a pair of signal lines change in opposite polarity directions, whereby the fluctuation of the potential of a pixel electrode can be canceled out. Therefore, crosstalk can be reduced.

### <2-1. Source Line Inversion Driving>

Source line inversion is a method in which image signals having opposite polarities are input in one given frame period so that the polarity of an image signal input to a plurality of pixels connected to one signal line and the polarity of an image signal input to a plurality of pixels connected to another signal line that is adjacent to the above signal line are opposite to each other.

FIGS. 10A1 and 10A2 schematically show polarities of image signals supplied to pixels in the case of source line inversion driving. In FIGS. 10A1 and 10A2, the sign “+” indicates a pixel to which an image signal having a positive polarity is supplied in one given frame period, and the sign “−” indicates a pixel to which an image signal having a negative polarity is supplied in the given frame period. The frame illustrated in FIG. 10A2 is a frame following the frame illustrated in FIG. 10A1.

### <2-2. Dot Inversion Driving>

Dot inversion is a method in which image signals having opposite polarities are input in one given frame period so that the polarity of an image signal input to a plurality of pixels connected to one signal line and the polarity of an image signal input to a plurality of pixels connected to another signal line adjacent to the above signal line are opposite to each other and, in addition, so that in the plurality of pixels connected to the one signal line, the polarity of an image signal input to a pixel and the polarity of an image signal input to a pixel adjacent to the pixel are opposite to each other.

FIGS. 10B1 and 10B2 schematically show polarities of image signals supplied to pixels in the case of dot inversion driving. In FIGS. 10B1 and 10B2, the sign “+” indicates a pixel to which an image signal having a positive polarity is supplied in one given frame period, and the sign “−” indicates a pixel to which an image signal having a negative polarity is supplied in the given frame period. The frame illustrated in FIG. 10B2 is a frame following the frame illustrated in FIG. 10B1.

### <2-3. Timing Chart>

FIG. 11 is a timing chart in the case of operating the pixel portion 631 illustrated in FIG. 9 by source line inversion driving. Specifically, FIG. 11 shows changes over time of the potential of a signal supplied to the scan line G1, the potentials of image signals supplied to the signal lines S1 to Sx, and the potentials of the pixel electrodes included in pixels connected to the scan line G1.

First, the scan line G1 is selected by inputting a signal with a pulse to the scan line G1. In each of the plurality of pixels 631p connected to the selected scan line G1, the transistor 634t is turned on. When a potential of an image signal is supplied to the signal lines S1 to Sx in the state where the transistor 634t is on, the potential of the image signal is supplied to the pixel electrode of the liquid crystal element 635LC via the on-state transistor 634t.

In the timing chart of FIG. 11, an example is shown in which, in a period during which the scan line G1 is selected in the first frame period, image signals having a positive polarity are sequentially input to the odd-numbered signal lines S1, S3, . . . and image signals having a negative polarity are sequentially input to the even-numbered signal lines S2, S4, . . . , Sx. Therefore, image signals having a positive polarity are supplied to the pixel electrodes (S1), (S3), . . . in the pixels 631p which are connected to the odd-numbered signal lines S1, S3, . . . . Further, image signals having a negative polarity are supplied to the pixel electrodes (S2), (S4), . . . , (Sx) in the pixels 631p connected to the even-numbered signal lines S2, S4, . . . , Sx.

In the liquid crystal element 635LC, the alignment of liquid crystal molecules is changed in accordance with the level of the voltage applied between the pixel electrode and the common electrode, whereby transmittance is changed. Accordingly, the transmittance of the liquid crystal element 635LC can be controlled by the potential of the image signal; thus, gradation can be displayed.

When input of image signals to the signal lines Si to Sx is completed, the selection of the scan line G1 is terminated. When the selection of the scan line is terminated, the transistors 634t are turned off in the pixels 631p connected to the scan line. Then, voltage applied between the pixel electrode and the common electrode is held in the liquid crystal element 635LC, whereby display of gradation is maintained. Further, the scan lines G2 to Gy are sequentially selected, and operations similar to that in the period during which the scan line G1 is selected are performed in the pixels connected to the above respective scan lines.

Next, the scan line G1 is selected again in the second frame period. In a period during which the scan line G1 is selected in the second frame period, image signals having a negative polarity are sequentially input to the odd-numbered signal lines S1, S3, . . . and image signals having a positive polarity are sequentially input to the even-numbered signal lines S2, S4, . . . , Sx, unlike the period during which the scan line G1 is selected in the first frame period. Therefore, image signals having a negative polarity are supplied to the pixel electrodes (S1), (S3), . . . in the pixels 631p which are connected to the odd-numbered signal lines S1, S3, . . . . Further, image signals having a positive polarity are supplied to the pixel electrodes (S2), (S4), . . . , (Sx) in the pixels 631p connected to the even-numbered signal lines S2, S4, . . . , Sx.

Also in the second frame period, when input of image signals to the signal lines S1 to Sx is completed, the selection of the scan line G1 is terminated. Further, the scan lines G2 to Gy are sequentially selected, and operations similar to that in the period during which the scan line G1 is selected are performed in the pixels connected to the above respective scan lines.

An operation similar to the above is repeated in the third frame period and the fourth frame period.

Although an example in which image signals are sequentially input to the signal lines S1 to Sx is shown in the timing chart of FIG. 11, one embodiment of the present invention is not limited to this structure. Image signals may be input to the signal lines Si to Sx all at once, or image signals may be sequentially input per plurality of signal lines.

In this embodiment, the scan line is selected by progressive scan; however, interlace scan may also be employed for selecting a scan line.

By inversion driving in which the polarity of the potential of an image signal is inverted using the reference potential of a common electrode as a reference, degradation of liquid crystal called burn-in can be prevented.

However, in the inversion driving, the change in the potential supplied to the signal line is increased at the time of changing the polarity of the image signal; thus, a potential difference between a source electrode and a drain electrode of the transistor 634t which functions as a switching element is increased. Accordingly, degradation of characteristics, such as a shift of threshold voltage, is easily caused in the transistor 634t.

Furthermore, in order to maintain the voltage held in the liquid crystal element 635LC, the off-state current of the transistor 634t needs to be low even when the potential difference between the source electrode and the drain electrode is large.

Note that this embodiment can be combined with any of the other embodiments in this specification as appropriate.

### Embodiment 5

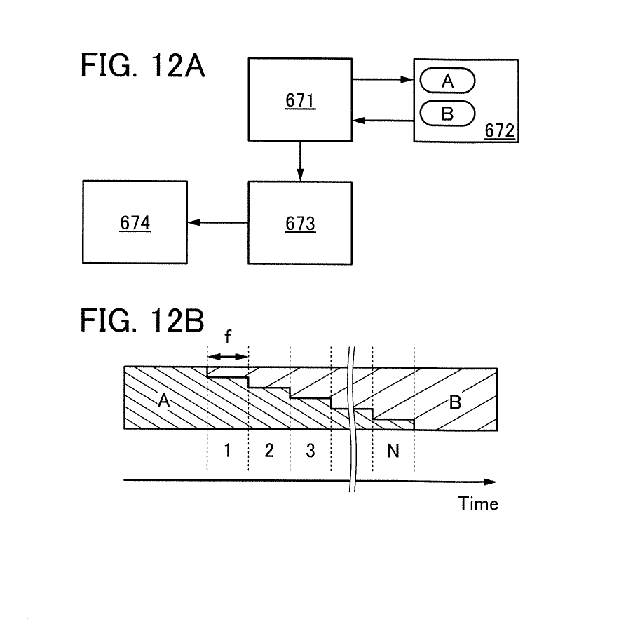

In this embodiment, a method for generating an image that can be displayed on the liquid crystal display device of one embodiment of the present invention is described using FIG. 12. In particular, an eye-friendly image switching method is described. The eye-friendly image switching method includes an image switching method by which eyestrain of users is reduced and an image switching method by which the eyestrain is not caused.

High-speed image switching causes eyestrain of users in some cases. For example, moving image display for which images are switched at an extremely high speed and the case of switching between different still images correspond to the high-speed image switching.

When images are switched for displaying different images, it is preferable that the images be switched gradually (silently) and naturally, not instantaneously.

For example, when a first image is changed to a second image that is different from the first image, it is preferable to interpose a fade-out image of the first image and/or a fade-in image of the second image between the first image and the second image. Alternatively, an image obtained by overlapping the first image and the second image may be interposed so that the second image fades in at the same time when the first image fades out (this technique is also referred to as crossfading). Further alternatively, a moving image (also referred to as morphing) for displaying the process in which the first image gradually changes into the second image may be interposed.

Specifically, a first still image is displayed at a low refresh rate, followed by an image for image switching is displayed at a high refresh rate, and then a second still image is displayed at a low refresh rate.

### <Fade-in, Fade-Out>

An example of a method for switching images A and B which are different images is described below.

FIG. 12A is a block diagram of a structure of a display device capable of switching images. The display device illustrated in FIG. 12A includes an arithmetic unit 671, a memory unit 672, a graphic unit 673, and a display means 674.

In the first step, the arithmetic unit 671 makes the memory unit 672 store data for the image A and data for the image B from an external memory device or the like.

In the second step, the arithmetic unit 671 sequentially generates new image data on the basis of the data for the image A and the data for the image B, in accordance with a division number set in advance.

In the third step, the arithmetic unit 671 outputs the generated image data to the graphic unit 673. The graphic unit 673 makes the display means 674 display the image data.

FIG. 12B is a schematic view for explaining image data generated for gradual image switching from the image A to the image B.

FIG. 12B shows the case where N (N is a natural number) sets of image data are generated for switching from the image A to the image B, and each set of image data is displayed for a frame period of f (f is a natural number). Therefore, the period needed for the switching from the image A to the image B is f×N frames.

Here, it is preferable that the above parameters such as N and f can be set freely by users. The arithmetic unit 671 obtains these parameters in advance, and generates image data in accordance with the parameters.

The i-th generated image data (i is an integer of 1 or larger and Nor smaller) is generated by weighting image data of the image A and image data of the image B and summing up the weighted data. For example, when the luminance (gray level) of a certain pixel where the image A is displayed is represented by a and the luminance (gray level) of the pixel where the image B is displayed is represented by b, the luminance (gray level) c of the pixel where the i-th generated image data is displayed is expressed by Formula 2.

$$\begin{matrix}[ Formula 2 ] & \\ c = \frac{( N - i ) a + ib}{N} & ( 2 )\end{matrix}$$

The image A is changed to the image B using image data generated in the above manner; therefore, discontinuous images can be switched gradually (silently) and naturally.

The case when all pixels satisfy a=0 in Formula 2 corresponds to fade-in when a black image is gradually changed to the image B. The case when all pixels satisfy b=0 corresponds to fade-out when the image A is gradually changed to the black image.

Although the method for switching images by temporarily overlapping two images is described above, a method by which images are not overlapped may be employed.

In the case where two images are not overlapped with each other, a black image may be interposed between the image A and the image B. In this case, the above image switching method can be performed at transition from the image A to the black image and/or transition from the black image to the image B. Moreover, an image interposed between the image A and the image B is not necessarily limited to a black image; a single color image like a white image may be used, or a multicolored image may be used as long as it differs from the image A and the image B.

Interposition of another image, particularly a single color image like a black image, between the image A and the image B enables users to watch images without feeling uncomfortable even when the images are switched; that is, images can be switched without causing stress of users.

Note that this embodiment can be combined with any of the other embodiments in this specification as appropriate.

### Embodiment 6

In this embodiment, structural examples of transistors which can be used in pixels of a liquid crystal display device are described with reference to drawings.

### <Structural Example of Transistor>

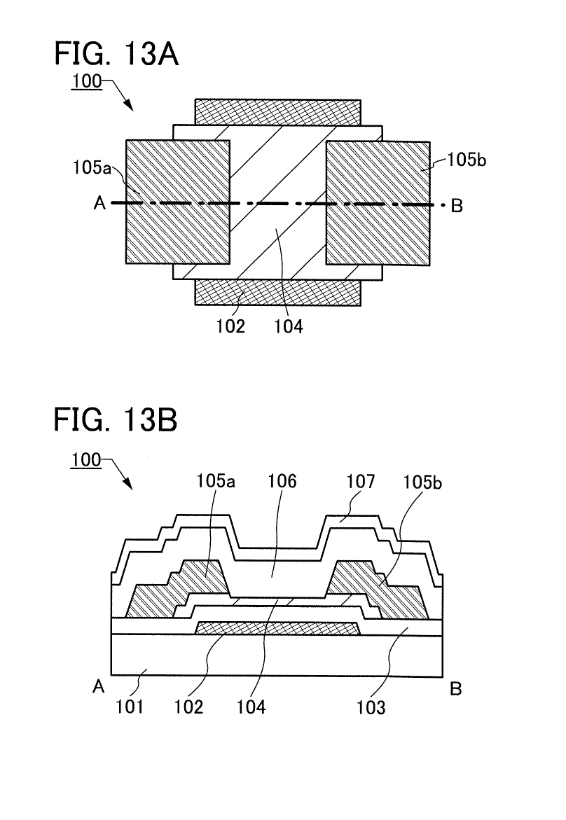

FIG. 13A is a schematic top view of a transistor 100 described below as an example. FIG. 13B is a schematic cross-sectional view of the transistor 100 taken along the section line A-B in FIG. 13A. The transistor 100 illustrated as an example in FIGS. 13A and 13B is a bottom-gate transistor.

The transistor 100 includes a gate electrode 102 over a substrate 101, an insulating layer 103 over the substrate 101 and the gate electrode 102, an oxide semiconductor layer 104 over the insulating layer 103, which overlaps with the gate electrode 102, and a pair of electrodes 105a and 105b in contact with the top surface of the oxide semiconductor layer 104. Further, an insulating layer 106 is provided to cover the insulating layer 103, the oxide semiconductor layer 104, and the pair of electrodes 105a and 105b, and an insulating layer 107 is provided over the insulating layer 106.

### <<Substrate>>

There is no particular limitation on the property of a material and the like of the substrate 101 as long as the material has heat resistance enough to withstand at least heat treatment which will be performed later. For example, a glass substrate, a ceramic substrate, a quartz substrate, a sapphire substrate, or an yttria-stabilized zirconia (YSZ) substrate may be used as the substrate 101. Alternatively, a single crystal semiconductor substrate or a polycrystalline semiconductor substrate made of silicon or silicon carbide, a compound semiconductor substrate made of silicon germanium, an SOI substrate, or the like can be used as the substrate 101. Still alternatively, any of these substrates provided with a semiconductor element may be used as the substrate 101.

Still alternatively, a flexible substrate such as a plastic substrate may be used as the substrate 101, and the transistor 100 may be provided directly on the flexible substrate. Further alternatively, a separation layer may be provided between the substrate 101 and the transistor 100. The separation layer can be used when part or the whole of the transistor is formed over the separation layer and separated from the substrate 101 and transferred to another substrate. Thus, the transistor 100 can be transferred to a substrate having low heat resistance or a flexible substrate.

### <<Gate Electrode>>

The gate electrode 102 can be formed using a metal selected from aluminum, chromium, copper, tantalum, titanium, molybdenum, and tungsten; an alloy containing any of these metals as a component; an alloy containing any of these metals in combination; or the like. Further, one or more metals selected from manganese and zirconium may be used. Furthermore, the gate electrode 102 may have a single-layer structure or a stacked-layer structure of two or more layers. For example, a single-layer structure of an aluminum film containing silicon, a two-layer structure in which a titanium film is stacked over an aluminum film, a two-layer structure in which a titanium film is stacked over a titanium nitride film, a two-layer structure in which a tungsten film is stacked over a titanium nitride film, a two-layer structure in which a tungsten film is stacked over a tantalum nitride film or a tungsten nitride film, a three-layer structure in which a titanium film, an aluminum film, and a titanium film are stacked in this order, and the like can be given. Alternatively, an alloy film or a nitride film which contains aluminum and one or more selected from titanium, tantalum, tungsten, molybdenum, chromium, neodymium, and scandium film may be used.

The gate electrode 102 can also be formed using a light-transmitting conductive material such as indium tin oxide, indium oxide containing tungsten oxide, indium zinc oxide containing tungsten oxide, indium oxide containing titanium oxide, indium tin oxide containing titanium oxide, indium zinc oxide, or indium tin oxide to which silicon oxide is added. It is also possible to have a stacked-layer structure formed using the above light-transmitting conductive material and the above metal.

Further, an In—Ga—Zn-based oxynitride semiconductor film, an In—Sn-based oxynitride semiconductor film, an In—Ga-based oxynitride semiconductor film, an In—Zn-based oxynitride semiconductor film, a Sn-based oxynitride semiconductor film, an In-based oxynitride semiconductor film, a film of metal nitride (such as InN or ZnN), or the like may be provided between the gate electrode 102 and the insulating layer 103. These films each have a work function higher than or equal to 5 eV, preferably higher than or equal to 5.5 eV. Thus, the threshold voltage of the transistor can be shifted in the positive direction, and what is called a normally-off switching element can be achieved. For example, in the case of using an In—Ga—Zn-based oxynitride semiconductor film, an In—Ga—Zn-based oxynitride semiconductor film having a higher nitrogen concentration than at least the oxide semiconductor layer 104, specifically, an In—Ga—Zn-based oxynitride semiconductor film having a nitrogen concentration of 7 at. % or higher is used.

### <<Insulating Layer>>

The insulating layer 103 functions as a gate insulating film. The insulating layer 103 in contact with the bottom surface of the oxide semiconductor layer 104 is preferably an oxide insulating film.

The insulating layer 103 may be formed to have a single-layer structure or a stacked-layer structure using, for example, one or more of silicon oxide, silicon oxynitride, silicon nitride oxide, silicon nitride, aluminum oxide, hafnium oxide, gallium oxide, Ga—Zn-based metal oxide, silicon nitride, and the like.

The insulating layer 103 may be formed using a high-k material such as hafnium silicate (HfSiOₓ), hafnium silicate to which nitrogen is added (HfSiₓO_{y}N_{z}), hafnium aluminate to which nitrogen is added (HfAlₓO_{y}N_{z}), hafnium oxide, or yttrium oxide, so that gate leakage current of the transistor can be reduced.

### <<Pair of Electrodes>>

The pair of electrodes 105a and 105b function as a source electrode and a drain electrode of the transistor.

The pair of electrodes 105a and 105b can be formed to have a single-layer structure or a stacked-layer structure using, as a conductive material, any of metals such as aluminum, titanium, chromium, nickel, copper, yttrium, zirconium, molybdenum, silver, tantalum, and tungsten, or an alloy containing any of these metals as its main component. For example, a single-layer structure of an aluminum film containing silicon, a two-layer structure in which a titanium film is stacked over an aluminum film, a two-layer structure in which a titanium film is stacked over a tungsten film, a two-layer structure in which a copper film is stacked over a copper-magnesium-aluminum alloy film, a three-layer structure in which a titanium film or a titanium nitride film, an aluminum film or a copper film, and a titanium film or a titanium nitride film are stacked in this order, a three-layer structure in which a molybdenum film or a molybdenum nitride film, an aluminum film or a copper film, and a molybdenum film or a molybdenum nitride film are stacked in this order, and the like can be given. Note that a transparent conductive material containing indium oxide, tin oxide, or zinc oxide may be used.

### <<Insulating Layer>>

The insulating layer 106 is preferably formed using an oxide insulating film containing oxygen at a higher proportion than oxygen in the stoichiometric composition. Part of oxygen is released by heating from the oxide insulating film containing oxygen at a higher proportion than oxygen in the stoichiometric composition. The oxide insulating film containing oxygen at a higher proportion than oxygen in the stoichiometric composition is an oxide insulating film in which the amount of released oxygen converted into oxygen atoms is greater than or equal to 1.0×10¹⁸ atoms/cm³, preferably greater than or equal to 3.0×10²⁰ atoms/cm³ in thermal desorption spectroscopy (TDS) analysis. Note that the temperature of the film surface in the TDS analysis is preferably higher than or equal to 100° C. and lower than or equal to 700° C., or higher than or equal to 100° C. and lower than or equal to 500° C.

As the insulating layer 106, a silicon oxide film, a silicon oxynitride film, or the like can be formed.

Note that the insulating layer 106 also functions as a film which relieves damage to the oxide semiconductor layer 104 at the time of forming the insulating layer 107 later.

Alternatively, an oxide film transmitting oxygen may be provided between the insulating layer 106 and the oxide semiconductor layer 104.

As the oxide film transmitting oxygen, a silicon oxide film, a silicon oxynitride film, or the like can be formed. Note that in this specification, a “silicon oxynitride film” refers to a film that contains oxygen at a higher proportion than nitrogen, and a “silicon nitride oxide film” refers to a film that contains nitrogen at a higher proportion than oxygen.

The insulating layer 107 can be formed using an insulating film having a blocking effect against oxygen, hydrogen, water, and the like. It is possible to prevent outward diffusion of oxygen from the oxide semiconductor layer 104 and entry of hydrogen, water, or the like into the oxide semiconductor layer 104 from the outside by providing the insulating layer 107 over the insulating layer 106. As for the insulating film having a blocking effect against oxygen, hydrogen, water, and the like, a silicon nitride film, a silicon nitride oxide film, an aluminum oxide film, an aluminum oxynitride film, a gallium oxide film, a gallium oxynitride film, an yttrium oxide film, an yttrium oxynitride film, a hafnium oxide film, and a hafnium oxynitride film can be given as examples.

### <Example of Manufacturing Method of Transistor>

Next, an example of a manufacturing method of the transistor 100 illustrated in FIG. 13 is described.

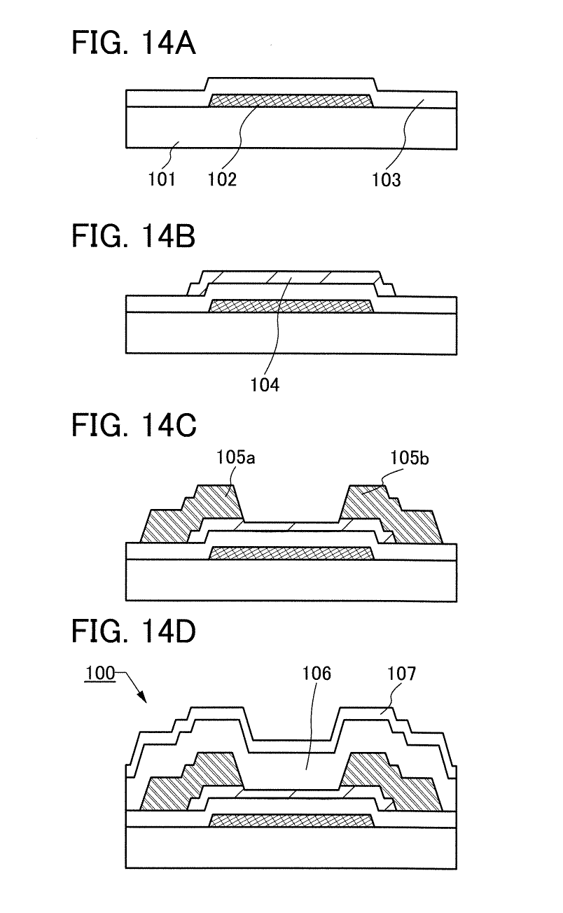

First, as illustrated in FIG. 14A, the gate electrode 102 is formed over the substrate 101, and the insulating layer 103 is formed over the gate electrode 102.

Here, a glass substrate is used as the substrate 101.

### <<Formation of Gate Electrode>>

A formation method of the gate electrode 102 is described below. First, a conductive film is formed by a sputtering method, a CVD method, an evaporation method, or the like and then a resist mask is formed over the conductive film using a first photomask by a photolithography process. Then, part of the conductive film is etched using the resist mask to form the gate electrode 102. After that, the resist mask is removed.

Note that instead of the above formation method, the gate electrode 102 may be formed by an electrolytic plating method, a printing method, an ink jet method, or the like.

### <<Formation of Gate Insulating Layer>>

The insulating layer 103 is formed by a sputtering method, a PECVD method, an evaporation method, or the like.

In the case where the insulating layer 103 is formed using a silicon oxide film, a silicon oxynitride film, or a silicon nitride oxide film, a deposition gas containing silicon and an oxidizing gas are preferably used as a source gas. Typical examples of the deposition gas containing silicon include silane, disilane, trisilane, and silane fluoride. As the oxidizing gas, oxygen, ozone, dinitrogen monoxide, and nitrogen dioxide can be given as examples.

In the case of forming a silicon nitride film as the insulating layer 103, it is preferable to use a two-step formation method. First, a first silicon nitride film with a small number of defects is formed by a plasma CVD method in which a mixed gas of silane, nitrogen, and ammonia is used as a source gas. Then, a second silicon nitride film in which the hydrogen concentration is low and hydrogen can be blocked is formed by switching the source gas to a mixed gas of silane and nitrogen. With such a formation method, a silicon nitride film with a small number of defects and a blocking property against hydrogen can be formed as the insulating layer 103.

Moreover, in the case of forming a gallium oxide film as the insulating layer 103, a metal organic chemical vapor deposition (MOCVD) method can be employed.

### <<Formation of Oxide Semiconductor Layer>>

Next, as illustrated in FIG. 14B, the oxide semiconductor layer 104 is formed over the insulating layer 103.

A formation method of the oxide semiconductor layer 104 is described below. First, an oxide semiconductor film is formed. Then, a resist mask is formed over the oxide semiconductor film using a second photomask by a photolithography process. Then, part of the oxide semiconductor film is etched using the resist mask to form the oxide semiconductor layer 104. After that, the resist mask is removed.

After that, heat treatment may be performed. In such a case, the heat treatment is preferably performed under an atmosphere containing oxygen. The temperature of the heat treatment may be, for example, higher than or equal to 150° C. and lower than or equal to 600° C., preferably higher than or equal to 200° C. and lower than or equal to 500° C.

### <<Formation of Pair of Electrodes>>

Next, as illustrated in FIG. 14C, the pair of electrodes 105a and 105b is formed.

A formation method of the pair of electrodes 105a and 105b is described below. First, a conductive film is formed by a sputtering method, a PECVD method, an evaporation method, or the like. Then, a resist mask is formed over the conductive film using a third photomask by a photolithography process. Then, part of the conductive film is etched using the resist mask to form the pair of electrodes 105a and 105b. After that, the resist mask is removed.

Note that as illustrated in FIG. 14B, an upper part of the oxide semiconductor layer 104 is in some cases partly etched and thinned by the etching of the conductive film. For this reason, the oxide semiconductor layer 104 is preferably formed thick.

### <<Formation of Insulating Layer>>

Next, as illustrated in FIG. 14D, the insulating layer 106 is formed over the oxide semiconductor layer 104 and the pair of electrodes 105a and 105b, and the insulating layer 107 is successively formed over the insulating layer 106.

In the case where the insulating layer 106 is formed using a silicon oxide film or a silicon oxynitride film, a deposition gas containing silicon and an oxidizing gas are preferably used as a source gas. Typical examples of the deposition gas containing silicon include silane, disilane, trisilane, and silane fluoride. As the oxidizing gas, oxygen, ozone, dinitrogen monoxide, and nitrogen dioxide can be given as examples.

For example, a silicon oxide film or a silicon oxynitride film is formed under the conditions as follows: the substrate placed in a treatment chamber of a plasma CVD apparatus, which is vacuum-evacuated, is held at a temperature higher than or equal to 180° C. and lower than or equal to 260° C., preferably higher than or equal to 200° C. and lower than or equal to 240° C., the pressure is greater than or equal to 100 Pa and less than or equal to 250 Pa, preferably greater than or equal to 100 Pa and less than or equal to 200 Pa with introduction of a source gas into the treatment chamber, and high-frequency power higher than or equal to 0.17 W/cm² and lower than or equal to 0.5 W/cm², preferably higher than or equal to 0.25 W/cm² and lower than or equal to 0.35 W/cm² is supplied to an electrode provided in the treatment chamber.

As the film formation conditions, the high-frequency power having the above power density is supplied to the treatment chamber having the above pressure, whereby the decomposition efficiency of the source gas in plasma is increased, oxygen radicals are increased, and oxidation of the source gas is promoted; therefore, oxygen is contained in the oxide insulating film at a higher proportion than oxygen in the stoichiometric composition. However, in the case where the substrate temperature is within the above temperature range, the bond between silicon and oxygen is weak, and accordingly, part of oxygen is released by heating. Thus, it is possible to form an oxide insulating film which contains oxygen at a higher proportion than oxygen in the stoichiometric composition and from which part of oxygen is released by heating.

Further, in the case of providing an oxide insulating film between the oxide semiconductor layer 104 and the insulating layer 106, the oxide insulating film serves as a protective film for the oxide semiconductor layer 104 in the steps of forming the insulating layer 106. Thus, the insulating layer 106 can be formed using the high-frequency power having a high power density while damage to the oxide semiconductor layer 104 is reduced.

For example, a silicon oxide film or a silicon oxynitride film is formed as the oxide insulating film under the conditions as follows: the substrate placed in a treatment chamber of a PECVD apparatus, which is vacuum-evacuated, is held at a temperature higher than or equal to 180° C. and lower than or equal to 400° C., preferably higher than or equal to 200° C. and lower than or equal to 370° C., the pressure is greater than or equal to 20 Pa and less than or equal to 250 Pa, preferably greater than or equal to 100 Pa and less than or equal to 250 Pa with introduction of a source gas into the treatment chamber, and high-frequency power is supplied to an electrode provided in the treatment chamber. Further, when the pressure in the treatment chamber is greater than or equal to 100 Pa and less than or equal to 250 Pa, damage to the oxide semiconductor layer 104 can be reduced.

A deposition gas containing silicon and an oxidizing gas are preferably used as a source gas of the oxide insulating film. Typical examples of the deposition gas containing silicon include silane, disilane, trisilane, and silane fluoride. As the oxidizing gas, oxygen, ozone, dinitrogen monoxide, and nitrogen dioxide can be given as examples.

The insulating layer 107 can be formed by a sputtering method, a PECVD method, or the like.

In the case where the insulating layer 107 is formed using a silicon nitride film or a silicon nitride oxide film, a deposition gas containing silicon, an oxidizing gas, and a gas containing nitrogen are preferably used as a source gas. Typical examples of the deposition gas containing silicon include silane, disilane, trisilane, and silane fluoride. As the oxidizing gas, oxygen, ozone, dinitrogen monoxide, and nitrogen dioxide can be given as examples. As the gas containing nitrogen, nitrogen and ammonia can be given as examples.

Through the above process, the transistor 100 can be formed.

### <Modification Example of Transistor>

A structural example of a transistor, which is partly different from the transistor 100, is described below.

### Modification Example 1

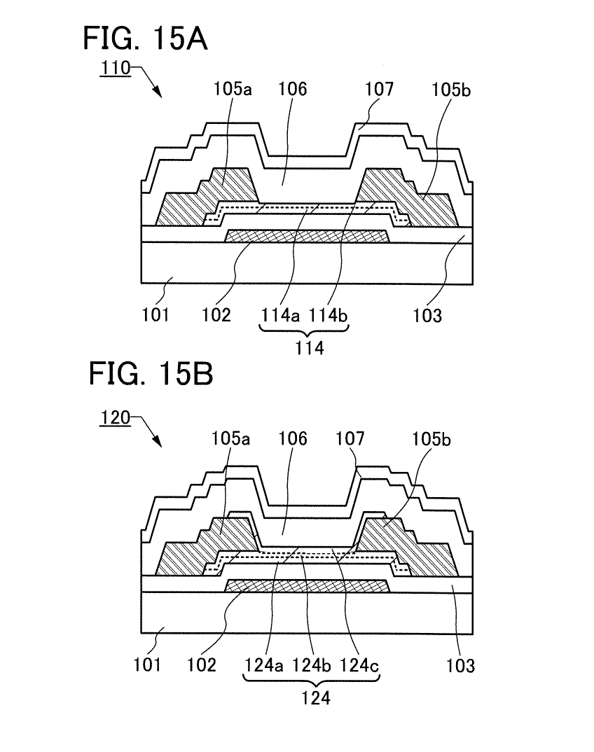

FIG. 15A is a schematic cross-sectional view of a transistor 110 described as an example below. The transistor 110 is different from the transistor 100 in the structure of an oxide semiconductor layer.

In an oxide semiconductor layer 114 included in the transistor 110, an oxide semiconductor layer 114a and an oxide semiconductor layer 114b are stacked.

Since a boundary between the oxide semiconductor layer 114a and the oxide semiconductor layer 114b is unclear in some cases, the boundary is shown by a dashed line in FIG. 15A and the like.

Typical examples of a material that can be used for the oxide semiconductor layer 114a are an In—Ga oxide, an In—Zn oxide, and an In-M-Zn oxide (M is Al, Ti, Ga, Y, Zr, La, Ce, Nd, or Hf). When an In-M-Zn oxide is used for the oxide semiconductor layer 114a, the atomic ratio of In and M, not taking Zn and O into consideration, is preferably as follows: the atomic percentage of In is less than 50 at. % and the atomic percentage of M is greater than or equal to 50 at. %; further preferably, the atomic percentage of In is less than 25 at. % and the atomic percentage of M is greater than or equal to 75 at. %. Further, a material having an energy gap of 2 eV or more, preferably 2.5 eV or more, further preferably 3 eV or more is used for the oxide semiconductor layer 114a, for example.

The oxide semiconductor layer 114b contains In or Ga; the oxide semiconductor layer 114b contains, for example, a material typified by an In—Ga oxide, an In—Zn oxide, or an In-M-Zn oxide (M is Al, Ti, Ga, Y, Zr, La, Ce, Nd, or Hf). In addition, the energy of the conduction band minimum of the oxide semiconductor layer 114b is closer to the vacuum level than that of the oxide semiconductor layer 114a is. The difference between the energy of the conduction band minimum of the oxide semiconductor layer 114b and the energy of the conduction band minimum of the oxide semiconductor layer 114a is preferably 0.05 eV or more, 0.07 eV or more, 0.1 eV or more, or 0.15 eV or more and 2 eV or less, 1 eV or less, 0.5 eV or less, or 0.4 eV or less.

When an In-M-Zn oxide is used for the oxide semiconductor layer 114b, for example, the atomic ratio of In and M, not taking Zn and O into consideration, is preferably as follows: the atomic percentage of In is greater than or equal to 25 at. % and the atomic percentage of M is less than 75 at. %; further preferably, the atomic percentage of In is greater than or equal to 34 at. % and the atomic percentage of M is less than 66 at. %.

For the oxide semiconductor layer 114a, an In—Ga—Zn oxide containing In, Ga, and Zn at an atomic ratio of 1:1:1, 1:1:1.2, or 3:1:2 can be used, for example. Further, for the oxide semiconductor layer 114b, an In—Ga—Zn oxide containing In, Ga, and Zn at an atomic ratio of 1:3:2, 1:6:4, or 1:9:6 can be used. Note that the atomic ratio of each of the oxide semiconductor layers 114a and 114b varies within a range of ±20% of the above atomic ratio as an error.

When an oxide containing a large amount of Ga that serves as a stabilizer is used for the oxide semiconductor layer 114b provided over the oxide semiconductor layer 114a, oxygen can be prevented from being released from the oxide semiconductor layers 114a and 114b.

Note that, without limitation to those described above, a material with an appropriate composition may be used depending on required semiconductor characteristics and electrical characteristics (e.g., field-effect mobility and threshold voltage) of a transistor. Further, in order to obtain required semiconductor characteristics of a transistor, it is preferable that the carrier density, the impurity concentration, the defect density, the atomic ratio of a metal element to oxygen, the interatomic distance, the density, and the like of the oxide semiconductor layers 114a and 114b be set to be appropriate.

Although a structure in which two oxide semiconductor layers are stacked is described above as an example of the oxide semiconductor layer 114, a structure in which three or more oxide semiconductor layers are stacked can also be employed.

### Modification Example 2

FIG. 15B is a schematic cross-sectional view of a transistor 120 described as an example below. The transistor 120 is different from the transistor 100 and the transistor 110 in the structure of an oxide semiconductor layer.

In an oxide semiconductor layer 124 included in the transistor 120, an oxide semiconductor layer 124a, an oxide semiconductor layer 124b, and an oxide semiconductor layer 124c are stacked in this order.

The oxide semiconductor layers 124a and 124b are stacked over the insulating layer 103. The oxide semiconductor layer 124c is provided in contact with the top surface of the oxide semiconductor layer 124b and the top surfaces and side surfaces of the pair of electrodes 105a and 105b.

The oxide semiconductor layer 124b can have a structure which is similar to that of the oxide semiconductor layer 114a described as an example in Modification example 1, for example. Further, the oxide semiconductor layers 124a and 124c can each have a structure which is similar to that of the oxide semiconductor layer 114b described as an example in Modification example 1, for example.

When an oxide containing a large amount of Ga that serves as a stabilizer is used for the oxide semiconductor layer 124a, which is provided under the oxide semiconductor layer 124b, and the oxide semiconductor layer 124c, which is provided over the oxide semiconductor layer 124b, for example, oxygen can be prevented from being released from the oxide semiconductor layer 124a, the oxide semiconductor layer 124b, and the oxide semiconductor layer 124c.

In the case where a channel is mainly formed in the oxide semiconductor layer 124b, for example, an oxide containing a large amount of In can be used for the oxide semiconductor layer 124b and the pair of electrodes 105a and 105b is provided in contact with the oxide semiconductor layer 124b; thus, the on-state current of the transistor 120 can be increased.

### <Another Structural Example of Transistor>

A structural example of a top-gate transistor to which the oxide semiconductor film of one embodiment of the present invention can be applied is described below.

Note that descriptions of components having structures or functions similar to those of the above, which are denoted by the same reference numerals, are omitted below.

### Structural Example

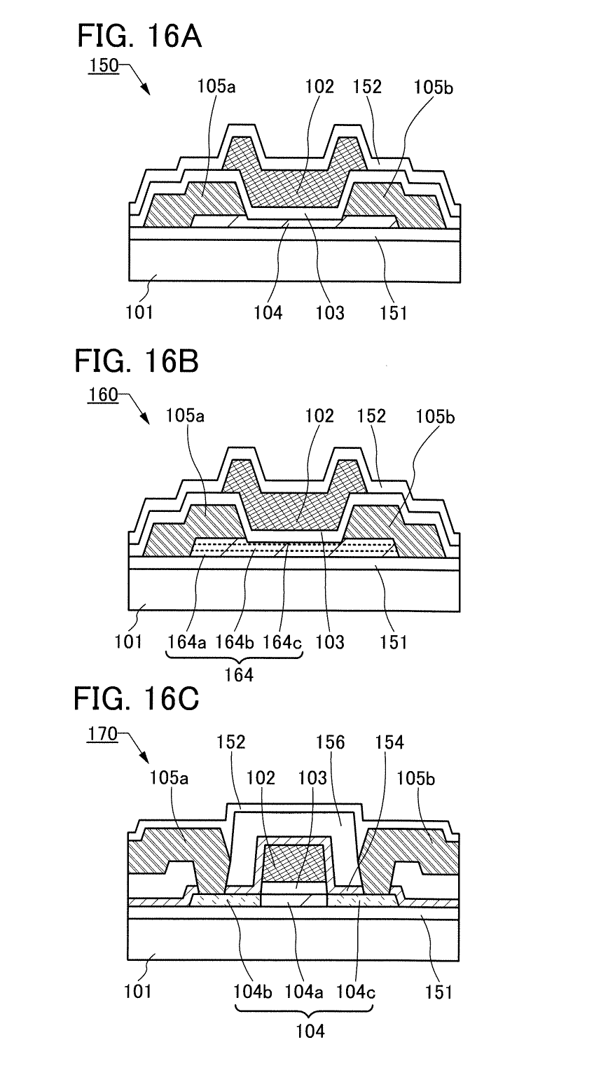

FIG. 16A is a schematic cross-sectional view of a top-gate transistor 150 which is described below as an example.

The transistor 150 includes the oxide semiconductor layer 104 over the substrate 101 on which an insulating layer 151 is provided, the pair of electrodes 105a and 105b in contact with the top surface of the oxide semiconductor layer 104, the insulating layer 103 over the oxide semiconductor layer 104 and the pair of electrodes 105a and 105b, and the gate electrode 102 provided over the insulating layer 103 so as to overlap with the oxide semiconductor layer 104. Further, an insulating layer 152 is provided to cover the insulating layer 103 and the gate electrode 102.

The insulating layer 151 has a function of suppressing diffusion of impurities from the substrate 101 into the oxide semiconductor layer 104. For example, a structure similar to that of the insulating layer 107 can be employed. Note that the insulating layer 151 is not necessarily provided.

The insulating layer 152 can be formed using an insulating film having a blocking effect against oxygen, hydrogen, water, and the like in a manner similar to that of the insulating layer 107. Note that the insulating layer 107 is not necessarily provided.

### Modification Example 1

A structural example of a transistor, which is partly different from the transistor 150, is described below.

FIG. 16B is a schematic cross-sectional view of a transistor 160 described as an example below. The structure of an oxide semiconductor layer in the transistor 160 is different from that in the transistor 150.

In an oxide semiconductor layer 164 included in the transistor 160, an oxide semiconductor layer 164a, an oxide semiconductor layer 164b, and an oxide semiconductor layer 164c are stacked in this order.

The above-described oxide semiconductor film can be applied to one or more of the oxide semiconductor layer 164a, the oxide semiconductor layer 164b, and the oxide semiconductor layer 164c.

The oxide semiconductor layer 164b can have a structure which is similar to that of the oxide semiconductor layer 114a described as an example in Modification example 1, for example. Further, the oxide semiconductor layers 164a and 164c can each have a structure which is similar to that of the oxide semiconductor layer 114b described as an example in Modification example 1, for example.

An oxide containing a large amount of Ga that serves as a stabilizer is used for the oxide semiconductor layer 164a, which is provided under the oxide semiconductor layer 164b, and the oxide semiconductor layer 164c, which is provided over the oxide semiconductor layer 164b; thus, oxygen can be prevented from being released from the oxide semiconductor layer 164a, the oxide semiconductor layer 164b, and the oxide semiconductor layer 164c.

### Modification Example 2

A structural example of a transistor, which is partly different from the transistor 150, is described below.

FIG. 16C is a schematic cross-sectional view of a transistor 170 described below as an example. The transistor 170 is different from the transistor 150 in the shapes of the pair of electrodes 105a and 105b in contact with the oxide semiconductor layer 104, the shape of the gate electrode 102, and the like.

The transistor 170 includes the oxide semiconductor layer 104 provided over the substrate 101 provided with the insulating layer 151, the insulating layer 103 over the oxide semiconductor layer 104, the gate electrode 102 over the insulating layer 103, an insulating layer 154 over the insulating layer 151 and the oxide semiconductor layer 104, an insulating layer 156 over the insulating layer 154, the pair of electrodes 105a and 105b electrically connected to the oxide semiconductor layer 104 through openings provided in the insulating layers 154 and 156, and the insulating layer 152 over the insulating layer 156 and the pair of electrodes 105a and 105b.

The insulating layer 154 is formed with, for example, an insulating film including hydrogen. An example of the insulating film including hydrogen is a silicon nitride film. Hydrogen included in the insulating layer 154 becomes a carrier in the oxide semiconductor layer 104 when bonded to an oxygen vacancy in the oxide semiconductor layer 104. Thus, in the structure illustrated in FIG. 16C, regions of the oxide semiconductor layer 104 in contact with the insulating layer 154 are expressed as an n-type region 104b and an n-type region 104c. Note that a region sandwiched between the n-type region 104b and the n-type region 104c is a channel region 104a.

By forming the n-type regions 104b and 104c in the oxide semiconductor layer 104, the contact resistance with the pair of electrodes 105a and 105b can be reduced. Note that the n-type regions 104b and 104c can be formed in a self-aligned manner during the formation of the gate electrode 102, using the insulating layer 154 that covers the gate electrode 102. The transistor 170 illustrated in FIG. 16C is what is called a self-aligned top gate transistor. In the self-aligned top gate transistor, the gate electrode 102 and the pair of electrodes 105a and 105b which function as a source electrode and a drain electrode do not overlap, which can reduce the parasitic capacitance generated between the electrodes.

The insulating layer 156 included in the transistor 170 can be formed with, for example, a silicon oxynitride film.

Note that this embodiment can be combined with any of the other embodiments in this specification as appropriate.

### Embodiment 7

In this embodiment, a structure of an oxide semiconductor film that can be used in a display device of one embodiment of the present invention is described below in detail.

An oxide semiconductor has a wide energy gap of 3.0 eV or more. A transistor including an oxide semiconductor film obtained by processing of the oxide semiconductor in an appropriate condition and a sufficient reduction in carrier density of the oxide semiconductor can have much lower leakage current between a source and a drain in an off state (off-state current) than a conventional transistor including silicon.

In the case where an oxide semiconductor film is used for a transistor, the thickness of the oxide semiconductor film is preferably greater than or equal to 2 nm and less than or equal to 40 nm.

An oxide semiconductor containing at least indium (In) or zinc (Zn) is preferably used. In particular, In and Zn are preferably contained. In addition, as a stabilizer for reducing variation in electrical characteristics of a transistor using the oxide semiconductor, one or more elements selected from gallium (Ga), tin (Sn), hafnium (Hf), zirconium (Zr), titanium (Ti), scandium (Sc), yttrium (Y), and a lanthanoid (such as cerium (Ce), neodymium (Nd), or gadolinium (Gd)) is preferably contained.

As the oxide semiconductor, for example, an indium oxide, a tin oxide, a zinc oxide, an In—Zn-based oxide, a Sn—Zn-based oxide, an Al—Zn-based oxide, a Zn—Mg-based oxide, a Sn—Mg-based oxide, an In—Mg-based oxide, an In—Ga-based oxide, an In—Ga—Zn-based oxide (also referred to as IGZO), an In—Al—Zn-based oxide, an In—Sn—Zn-based oxide, a Sn—Ga—Zn-based oxide, an Al—Ga—Zn-based oxide, a Sn—Al—Zn-based oxide, an In—Hf—Zn-based oxide, an In—Zr—Zn-based oxide, an In—Ti—Zn-based oxide, an In—Sc—Zn-based oxide, an In—Y—Zn-based oxide, an In—La—Zn-based oxide, an In—Ce—Zn-based oxide, an In—Pr—Zn-based oxide, an In—Nd—Zn-based oxide, an In—Sm—Zn-based oxide, an In—Eu—Zn-based oxide, an In—Gd—Zn-based oxide, an In—Tb—Zn-based oxide, an In—Dy—Zn-based oxide, an In—Ho—Zn-based oxide, an In—Er—Zn-based oxide, an In—Tm—Zn-based oxide, an In—Yb—Zn-based oxide, an In—Lu—Zn-based oxide, an In—Sn—Ga—Zn-based oxide, an In—Hf—Ga—Zn-based oxide, an In—Al—Ga—Zn-based oxide, an In—Sn—Al—Zn-based oxide, an In—Sn—Hf—Zn-based oxide, or an In—Hf—Al—Zn-based oxide can be used.

Here, an “In—Ga—Zn-based oxide” means an oxide containing In, Ga, and Zn as main components and there is no limitation on the ratio of In:Ga:Zn. Further, a metal element in addition to In, Ga, and Zn may be contained.

Alternatively, a material represented by InMO₃(ZnO)ₘ (m >0, where m is not an integer) may be used as the oxide semiconductor. Note that M represents one or more metal elements selected from Ga, Fe, Mn, and Co, or the above-described element as a stabilizer. Alternatively, a material represented by In₂SnO₅(ZnO)ₙ (n>0, where n is an integer) may be used as the oxide semiconductor.

For example, an In—Ga—Zn-based oxide with an atomic ratio of In:Ga:Zn=1:1:1, In:Ga:Zn=1:3:2, In:Ga:Zn=3:1:2, or In:Ga:Zn=2:1:3, or an oxide with an atomic ratio close to the above atomic ratios can be used.

When the oxide semiconductor film contains a large amount of hydrogen, the hydrogen and an oxide semiconductor are bonded to each other, so that part of the hydrogen serves as a donor and causes generation of an electron which is a carrier. As a result, the threshold voltage of the transistor shifts in the negative direction. Therefore, after formation of the oxide semiconductor film, it is preferable that dehydration treatment (dehydrogenation treatment) be performed to remove hydrogen or moisture from the oxide semiconductor film so that the oxide semiconductor film is highly purified to contain impurities as little as possible.

Note that oxygen in the oxide semiconductor film is also reduced by the dehydration treatment (dehydrogenation treatment) in some cases. Therefore, it is preferable that oxygen be added to the oxide semiconductor film to fill oxygen vacancies increased by the dehydration treatment (dehydrogenation treatment). In this specification and the like, supplying oxygen to an oxide semiconductor film may be expressed as oxygen adding treatment, or treatment for making the oxygen content of an oxide semiconductor film be in excess of that of the stoichiometric composition may be expressed as treatment for making an oxygen-excess state.

In this manner, hydrogen or moisture is removed from the oxide semiconductor film by the dehydration treatment (dehydrogenation treatment) and oxygen vacancies therein are filled by the oxygen adding treatment, whereby the oxide semiconductor film can be turned into an i-type (intrinsic) oxide semiconductor film or a substantially i-type (intrinsic) oxide semiconductor film which is extremely close to an i-type oxide semiconductor film. Note that “substantially intrinsic” means that the oxide semiconductor film contains extremely few (close to zero) carriers derived from a donor at higher than or equal to 1×10⁻⁹/cm³ and lower than 8×10¹¹/cm³, preferably lower than 1×10¹¹/cm³, more preferably lower than 1×10¹⁰/cm³.

Thus, the transistor including an i-type or substantially i-type oxide semiconductor film can have extremely favorable off-state current characteristics. For example, the drain current at the time when the transistor including an oxide semiconductor film is in an off state can be less than or equal to 1×10⁻¹⁸ A, preferably less than or equal to 1×10⁻²¹ A, further preferably less than or equal to 1×10⁻²⁴ A at room temperature (about 25° C.); or less than or equal to 1×10⁻¹⁵ A, preferably less than or equal to 1×10⁻¹⁸ A, further preferably less than or equal to 1×10⁻²¹ A at 85° C. An off state of a transistor refers to a state where gate voltage is sufficiently lower than the threshold voltage in an n-channel transistor. Specifically, the transistor is in an off state when the gate voltage is lower than the threshold voltage by 1 V or more, 2 V or more, or 3 V or more.

Next, a structure that can be included in an oxide semiconductor film is described.

An oxide semiconductor is classified into a single crystal oxide semiconductor and a non-single-crystal oxide semiconductor.

Examples of a non-single-crystal oxide semiconductor include a CAAC-OS (c-axis aligned crystalline oxide semiconductor), a polycrystalline oxide semiconductor, a microcrystalline oxide semiconductor, and an amorphous oxide semiconductor. In addition, examples of a crystalline oxide semiconductor include a single crystal oxide semiconductor, a CAAC-OS, a polycrystalline oxide semiconductor, and a microcrystalline oxide semiconductor.

From another perspective, an oxide semiconductor is classified into an amorphous oxide semiconductor and a crystalline oxide semiconductor. Examples of a crystalline oxide semiconductor include a single crystal oxide semiconductor, a CAAC-OS, a polycrystalline oxide semiconductor, and a microcrystalline oxide semiconductor.

### <CAAC-OS>

First, a CAAC-OS is described. Note that a CAAC-OS can be referred to as an oxide semiconductor including CANC (c-axis aligned nanocrystals).

A CAAC-OS is one of oxide semiconductors having a plurality of c-axis aligned crystal parts (also referred to as pellets).

In a combined analysis image (also referred to as a high-resolution TEM image) of a bright-field image and a diffraction pattern of a CAAC-OS, which is obtained using a transmission electron microscope (TEM), a plurality of pellets can be observed. However, in the high-resolution TEM image, a boundary between pellets, that is, a grain boundary is not clearly observed. Thus, in the CAAC-OS, a reduction in electron mobility due to the grain boundary is less likely to occur.

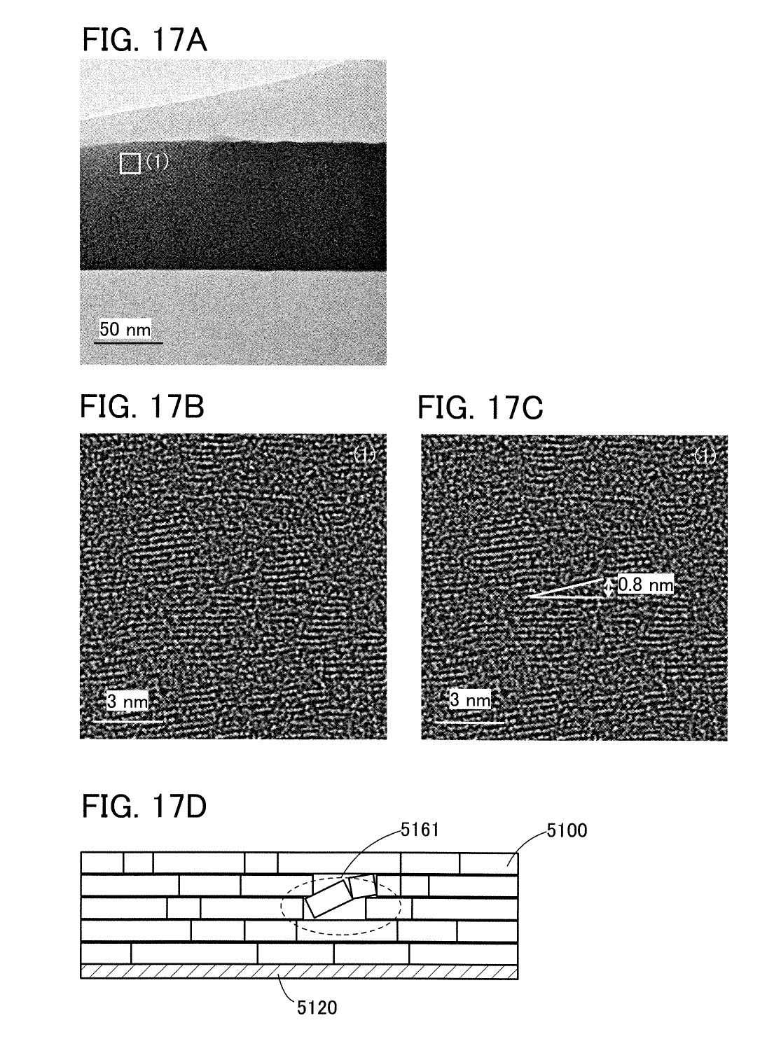

FIG. 17A shows an example of a high-resolution TEM image of a cross section of the CAAC-OS which is obtained from a direction substantially parallel to the sample surface. Here, the TEM image is obtained with a spherical aberration corrector function. The high-resolution TEM image obtained with a spherical aberration corrector function is particularly referred to as a Cs-corrected high-resolution TEM image in the following description. Note that the Cs-corrected high-resolution TEM image can be obtained with, for example, an atomic resolution analytical electron microscope JEM-ARM200F manufactured by JEOL Ltd.

A CAAC-OS observed with TEM is described below. FIG. 17A shows a high-resolution TEM image of a cross section of the CAAC-OS which is observed from a direction substantially parallel to the sample surface. The high-resolution TEM image is obtained with a spherical aberration corrector function. The high-resolution TEM image obtained with a spherical aberration corrector function is particularly referred to as a Cs-corrected high-resolution TEM image. The Cs-corrected high-resolution TEM image can be obtained with, for example, an atomic resolution analytical electron microscope JEM-ARM200F manufactured by JEOL Ltd.

FIG. 17B is an enlarged Cs-corrected high-resolution TEM image of a region (1) in FIG. 17A. FIG. 17B shows that metal atoms are arranged in a layered manner in a pellet. Each metal atom layer has a configuration reflecting unevenness of a surface over which the CAAC-OS is formed (hereinafter, the surface is referred to as a formation surface) or a top surface of the CAAC-OS, and is arranged parallel to the formation surface or the top surface of the CAAC-OS.

As shown in FIG. 17B, the CAAC-OS has a characteristic atomic arrangement. The characteristic atomic arrangement is denoted by an auxiliary line in FIG. 17C. FIGS. 17B and 17C prove that the size of a pellet is approximately 1 nm to 3 nm, and the size of a space caused by tilt of the pellets is approximately 0.8 nm. Therefore, the pellet can also be referred to as a nanocrystal (nc).

Here, according to the Cs-corrected high-resolution TEM images, the schematic arrangement of pellets 5100 of a CAAC-OS over a substrate 5120 is illustrated by such a structure in which bricks or blocks are stacked (see FIG. 17D). The part in which the pellets are tilted as observed in FIG. 17C corresponds to a region 5161 shown in FIG. 17D.

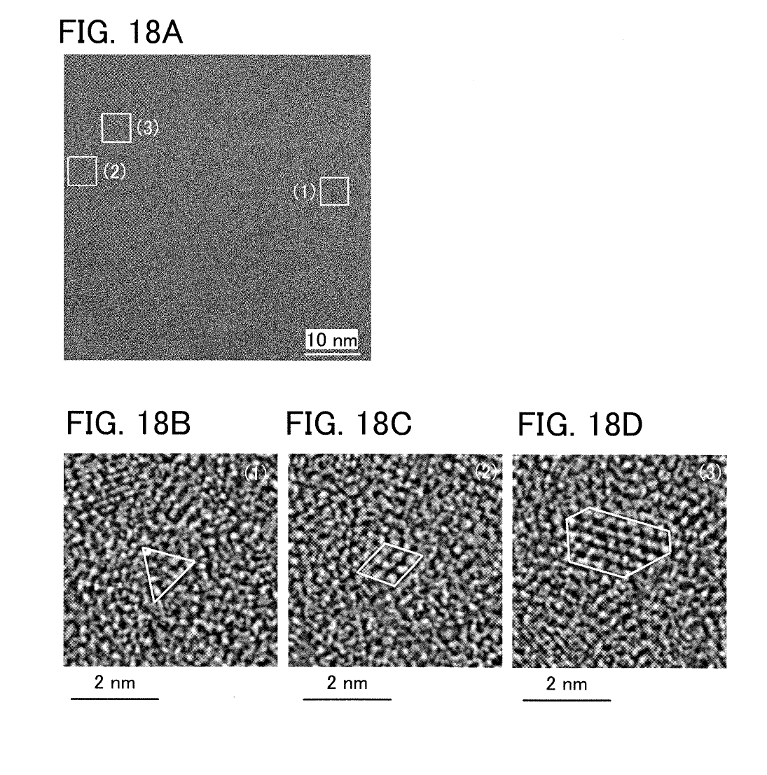

FIG. 18A shows a Cs-corrected high-resolution TEM image of a plane of the CAAC-OS observed from a direction substantially perpendicular to the sample surface.

FIGS. 18B, 18C, and 18D are enlarged Cs-corrected high-resolution TEM images of regions (1), (2), and (3) in FIG. 18A, respectively. FIGS. 18B, 18C, and 18D indicate that metal atoms are arranged in a triangular, quadrangular, or hexagonal configuration in a pellet. However, there is no regularity of arrangement of metal atoms between different pellets.

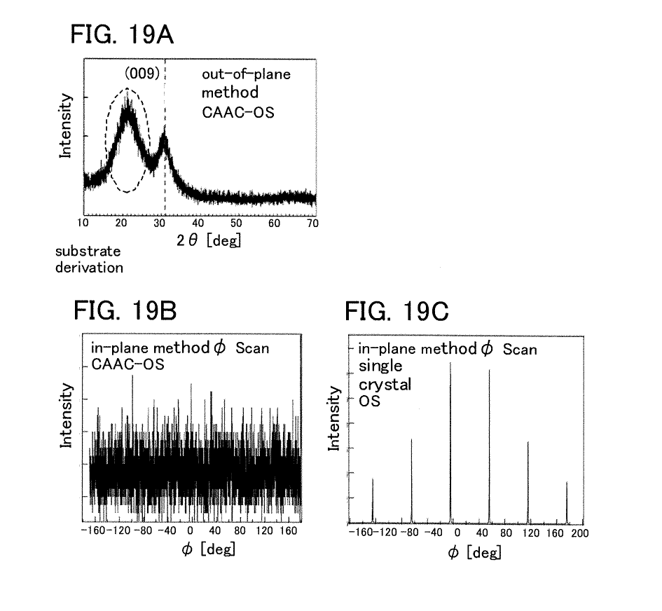

Next, a CAAC-OS analyzed by X-ray diffraction (XRD) is described. For example, when the structure of a CAAC-OS including an InGaZnO₄ crystal is analyzed by an out-of-plane method, a peak appears at a diffraction angle (2θ) of around 31° as shown in FIG. 19A. This peak is derived from the (009) plane of the InGaZnO₄ crystal, which indicates that crystals in the CAAC-OS have c-axis alignment, and that the c-axes are aligned in a direction substantially perpendicular to the formation surface or the top surface of the CAAC-OS.

Note that in structural analysis of the CAAC-OS by an out-of-plane method, another peak may appear when 2θ is around 36°, in addition to the peak at 2θ of around 31°. The peak at 2θ of around 36° indicates that a crystal having no c-axis alignment is included in part of the CAAC-OS. It is preferable that in the CAAC-OS analyzed by an out-of-plane method, a peak appear when 2θ is around 31° and that a peak not appear when 2θ is around 36°.

On the other hand, in structural analysis of the CAAC-OS by an in-plane method in which an X-ray is incident on a sample in a direction substantially perpendicular to the c-axis, a peak appears when 20 is around 56°. This peak is attributed to the (110) plane of the InGaZnO₄ crystal. In the case of the CAAC-OS, when analysis (φ scan) is performed with 20 fixed at around 56° and with the sample rotated using a normal vector of the sample surface as an axis (φ axis), as shown in FIG. 19B, a peak is not clearly observed. In contrast, in the case of a single crystal oxide semiconductor of InGaZnO₄, when 0 scan is performed with 20 fixed at around 56°, as shown in FIG. 19C, six peaks which are derived from crystal planes equivalent to the (110) plane are observed. Accordingly, the structural analysis using XRD shows that the directions of a-axes and b-axes are irregularly oriented in the CAAC-OS.

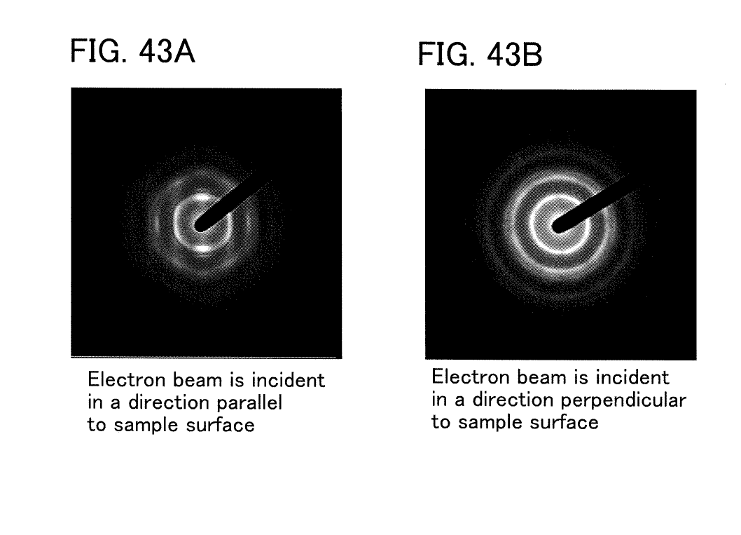

Next, a CAAC-OS analyzed by electron diffraction is described. For example, when an electron beam with a probe diameter of 300 nm is incident on a CAAC-OS including an InGaZnO₄ crystal in a direction parallel to the sample surface, a diffraction pattern (also referred to as a selected-area transmission electron diffraction pattern) shown in FIG. 43A can be obtained. In this diffraction pattern, spots derived from the (009) plane of an InGaZnO₄ crystal are included. Thus, the electron diffraction also indicates that pellets included in the CAAC-OS have c-axis alignment and that the c-axes are aligned in a direction substantially perpendicular to the formation surface or the top surface of the CAAC-OS. Meanwhile, FIG. 43B shows a diffraction pattern obtained in such a manner that an electron beam with a probe diameter of 300 nm is incident on the same sample in a direction perpendicular to the sample surface. As shown in FIG. 43B, a ring-like diffraction pattern is observed. Thus, the electron diffraction also indicates that the a-axes and b-axes of the pellets included in the CAAC-OS do not have regular alignment. The first ring in FIG. 43B is considered to be derived from the (010) plane, the (100) plane, and the like of the InGaZnO₄ crystal. The second ring in FIG. 43B is considered to be derived from the (110) plane and the like.

Moreover, the CAAC-OS is an oxide semiconductor having a low density of defect states. Defects in the oxide semiconductor are, for example, a defect due to impurity and oxygen vacancies. Therefore, the CAAC-OS can be regarded as an oxide semiconductor with a low impurity concentration, or an oxide semiconductor having a small number of oxygen vacancies.

The impurity contained in the oxide semiconductor might serve as a carrier trap or serve as a carrier generation source. Furthermore, oxygen vacancies in the oxide semiconductor serve as carrier traps or serve as carrier generation sources when hydrogen is captured therein.

Note that the impurity means an element other than the main components of the oxide semiconductor, such as hydrogen, carbon, silicon, or a transition metal element. For example, an element (specifically, silicon or the like) having higher strength of bonding to oxygen than a metal element included in an oxide semiconductor extracts oxygen from the oxide semiconductor, which results in disorder of the atomic arrangement and reduced crystallinity of the oxide semiconductor. A heavy metal such as iron or nickel, argon, carbon dioxide, or the like has a large atomic radius (or molecular radius), and thus disturbs the atomic arrangement of the oxide semiconductor and decreases crystallinity.

An oxide semiconductor having a low density of defect states (a small number of oxygen vacancies) can have a low carrier density. Such an oxide semiconductor is referred to as a highly purified intrinsic or substantially highly purified intrinsic oxide semiconductor. A CAAC-OS has a low impurity concentration and a low density of defect states. That is, a CAAC-OS is likely to be highly purified intrinsic or substantially highly purified intrinsic oxide semiconductor. Thus, a transistor including a CAAC-OS rarely has negative threshold voltage (is rarely normally on). The highly purified intrinsic or substantially highly purified intrinsic oxide semiconductor has few carrier traps. An electric charge trapped by the carrier traps in the oxide semiconductor takes a long time to be released. The trapped electric charge may behave like a fixed electric charge. Thus, the transistor which includes the oxide semiconductor having a high impurity concentration and a high density of defect states might have unstable electrical characteristics. However, a transistor including a CAAC-OS has small variation in electrical characteristics and high reliability.

Since the CAAC-OS has a low density of defect states, carriers are less likely to be trapped in defect states with light irradiation. Therefore, in a transistor using the CAAC-OS, change in electrical characteristics due to irradiation with visible light or ultraviolet light is small.

### <Microcrystalline Oxide Semiconductor>

Next, a microcrystalline oxide semiconductor is described.

A microcrystalline oxide semiconductor has a region in which a crystal part is observed and a region in which a crystal part is not clearly observed in a high-resolution TEM image. In most cases, the size of a crystal part included in the microcrystalline oxide semiconductor is greater than or equal to 1 nm and less than or equal to 100 nm, or greater than or equal to 1 nm and less than or equal to 10 nm. An oxide semiconductor including a nanocrystal (nc) that is a microcrystal with a size greater than or equal to 1 nm and less than or equal to 10 nm, or a size greater than or equal to 1 nm and less than or equal to 3 nm is specifically referred to as a nanocrystalline oxide semiconductor (nc-OS). In a high-resolution TEM image of the nc-OS, for example, a grain boundary is not clearly observed in some cases. Note that there is a possibility that the origin of the nanocrystal is the same as that of a pellet in a CAAC-OS. Therefore, a crystal part of the nc-OS may be referred to as a pellet in the following description.

In the nc-OS, a microscopic region (for example, a region with a size greater than or equal to 1 nm and less than or equal to 10 nm, in particular, a region with a size greater than or equal to 1 nm and less than or equal to 3 nm) has a periodic atomic arrangement. There is no regularity of crystal orientation between different pellets in the nc-OS. Thus, the orientation of the whole film is not ordered. Accordingly, the nc-OS cannot be distinguished from an amorphous oxide semiconductor, depending on an analysis method. For example, when the nc-OS is subjected to structural analysis by an out-of-plane method with an XRD apparatus using an X-ray having a diameter larger than the size of a pellet, a peak which shows a crystal plane does not appear. Furthermore, a diffraction pattern like a halo pattern is observed when the nc-OS is subjected to electron diffraction using an electron beam with a probe diameter (e.g., 50 nm or larger) that is larger than the size of a pellet (the electron diffraction is also referred to as selected-area electron diffraction). Meanwhile, spots appear in a nanobeam electron diffraction pattern of the nc-OS when an electron beam having a probe diameter close to or smaller than the size of a pellet is applied. Moreover, in a nanobeam electron diffraction pattern of the nc-OS, regions with high luminance in a circular (ring) pattern are shown in some cases. Also in a nanobeam electron diffraction pattern of the nc-OS, a plurality of spots is shown in a ring-like region in some cases.

Since there is no regularity of crystal orientation between the pellets (nanocrystals) as mentioned above, the nc-OS can also be referred to as an oxide semiconductor including random aligned nanocrystals (RANC) or an oxide semiconductor including non-aligned nanocrystals (NANC).

The nc-OS is an oxide semiconductor that has high regularity as compared with an amorphous oxide semiconductor. Therefore, the nc-OS is likely to have a lower density of defect states than an amorphous oxide semiconductor. Note that there is no regularity of crystal orientation between different pellets in the nc-OS. Therefore, the nc-OS has a higher density of defect states than the CAAC-OS.

### <Amorphous Oxide Semiconductor>

Next, an amorphous oxide semiconductor is described.

The amorphous oxide semiconductor is an oxide semiconductor having disordered atomic arrangement and no crystal part and exemplified by an oxide semiconductor which exists in an amorphous state as quartz.

In a high-resolution TEM image of the amorphous oxide semiconductor, crystal parts cannot be found.

When the amorphous oxide semiconductor is subjected to structural analysis by an out-of-plane method with an XRD apparatus, a peak which shows a crystal plane does not appear. A halo pattern is observed when the amorphous oxide semiconductor is subjected to electron diffraction. Furthermore, a spot is not observed and only a halo pattern appears when the amorphous oxide semiconductor is subjected to nanobeam electron diffraction.

There are various understandings of an amorphous structure. For example, a structure whose atomic arrangement does not have ordering at all is called a completely amorphous structure. Meanwhile, a structure which has ordering until the nearest neighbor atomic distance or the second-nearest neighbor atomic distance but does not have long-range ordering is also called an amorphous structure. Therefore, the strictest definition does not permit an oxide semiconductor to be called an amorphous oxide semiconductor as long as even a negligible degree of ordering is present in an atomic arrangement. At least an oxide semiconductor having long-term ordering cannot be called an amorphous oxide semiconductor. Accordingly, because of the presence of crystal part, for example, a CAAC-OS and an nc-OS cannot be called an amorphous oxide semiconductor or a completely amorphous oxide semiconductor.

### <Amorphous-Like Oxide Semiconductor>

Note that an oxide semiconductor may have a structure having physical properties intermediate between the nc-OS and the amorphous oxide semiconductor. The oxide semiconductor having such a structure is specifically referred to as an amorphous-like oxide semiconductor (a-like OS).

In a high-resolution TEM image of the a-like OS, a void may be observed. Furthermore, in the high-resolution TEM image, there are a region where a crystal part is clearly observed and a region where a crystal part is not observed.

The a-like OS has an unstable structure because it contains a void. To verify that an a-like OS has an unstable structure as compared with a CAAC-OS and an nc-OS, a change in structure caused by electron irradiation is described below.

An a-like OS (referred to as Sample A), an nc-OS (referred to as Sample B), and a CAAC-OS (referred to as Sample C) are prepared as samples subjected to electron irradiation. Each of the samples is an In—Ga—Zn oxide.

First, a high-resolution cross-sectional TEM image of each sample is obtained. The high-resolution cross-sectional TEM images show that all the samples have crystal parts.

Note that a crystal part is determined as follows. It is known that a unit cell of an InGaZnO₄ crystal has a structure in which nine layers including three In-0 layers and six Ga—Zn—O layers are stacked in the c-axis direction. The distance between the adjacent layers is equivalent to the lattice spacing on the (009) plane (also referred to as d value). The value is calculated to be 0.29 nm from crystal structural analysis. Accordingly, a portion where the lattice spacing between lattice fringes is greater than or equal to 0.28 nm and less than or equal to 0.30 nm is regarded as a crystal part of InGaZnO₄. Each of lattice fringes corresponds to the a-b plane of the InGaZnO₄ crystal.

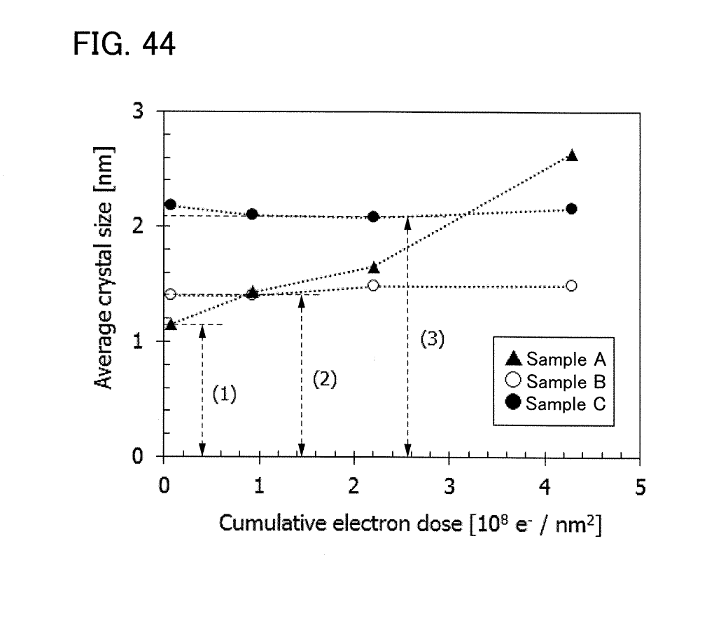

FIG. 44 shows change in the average size of crystal parts (at 22 points to 45 points) in each sample. Note that the crystal part size corresponds to the length of a lattice fringe. FIG. 44 indicates that the crystal part size in the a-like OS increases with an increase in the cumulative electron dose. Specifically, as shown by (1) in FIG. 44, a crystal part of approximately 1.2 nm at the start of TEM observation grows to a size of approximately 2.6 nm at a cumulative electron dose of 4.2×10⁸ e⁻/nm². In contrast, the crystal part size in the nc-OS and the CAAC-OS shows little change from the start of electron irradiation to a cumulative electron dose of 4.2×10⁸ e⁻/nm². Specifically, as shown by (2) and (3) in FIG. 44, the average crystal sizes in an nc-OS and a CAAC-OS are approximately 1.4 nm and approximately 2.1 nm, respectively, regardless of the cumulative electron dose.

In this manner, growth of the crystal part in the a-like OS is induced by electron irradiation. In contrast, in the nc-OS and the CAAC-OS, growth of the crystal part is hardly induced by electron irradiation. Therefore, the a-like OS has an unstable structure as compared with the nc-OS and the CAAC-OS.

The a-like OS has a lower density than the nc-OS and the CAAC-OS because it contains a void. Specifically, the density of the a-like OS is higher than or equal to 78.6% and lower than 92.3% of the density of the single crystal oxide semiconductor having the same composition. The density of each of the nc-OS and the CAAC-OS is higher than or equal to 92.3% and lower than 100% of the density of the single crystal oxide semiconductor having the same composition. Note that it is difficult to deposit an oxide semiconductor having a density of lower than 78% of the density of the single crystal oxide semiconductor.

For example, in the case of an oxide semiconductor having an atomic ratio of In:Ga:Zn=1:1:1, the density of single crystal InGaZnO₄ with a rhombohedral crystal structure is 6.357 g/cm³. Accordingly, in the case of the oxide semiconductor having an atomic ratio of In:Ga:Zn=1:1:1, the density of the a-like OS is higher than or equal to 5.0 g/cm³ and lower than 5.9 g/cm³. For example, in the case of the oxide semiconductor having an atomic ratio of In:Ga:Zn=1:1:1, the density of each of the nc-OS and the CAAC-OS is higher than or equal to 5.9 g/cm³ and lower than 6.3 g/cm³.

Note that there is a possibility that an oxide semiconductor having a desired composition cannot exist in a single crystal structure. In that case, single crystal oxide semiconductors with different compositions are combined at an adequate ratio, which makes it possible to calculate density equivalent to that of a single crystal oxide semiconductor with the desired composition. The density of a single crystal oxide semiconductor having the desired composition can be calculated using a weighted average according to the combination ratio of the single crystal oxide semiconductors with different compositions. Note that it is preferable to use as few kinds of single crystal oxide semiconductors as possible to calculate the density.

As described above, oxide semiconductors have various structures and various properties. Note that an oxide semiconductor may be a stacked layer including two or more films of an amorphous oxide semiconductor, an a-like OS, a microcrystalline oxide semiconductor, and a CAAC-OS, for example.

The semiconductor device of one embodiment of the present invention can be formed using an oxide semiconductor film having any of the above structures.

The structure and method described in this embodiment can be implemented by being combined as appropriate with any of the other structures and methods described in the other embodiments.

### Embodiment 8

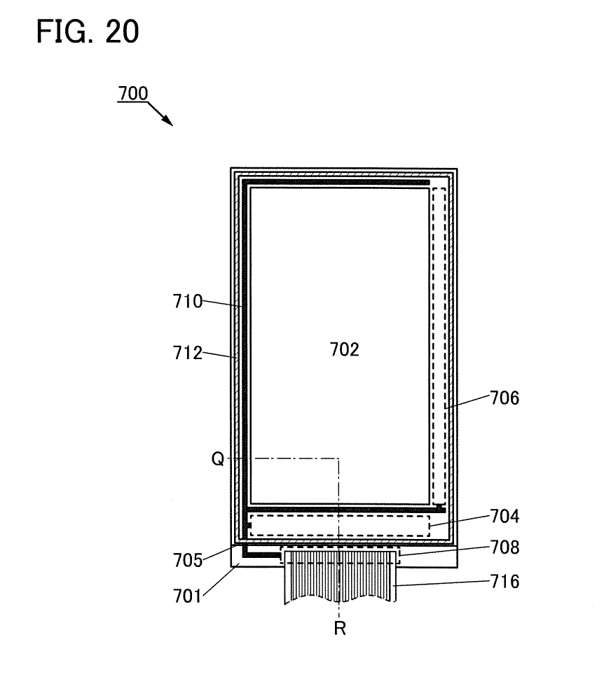

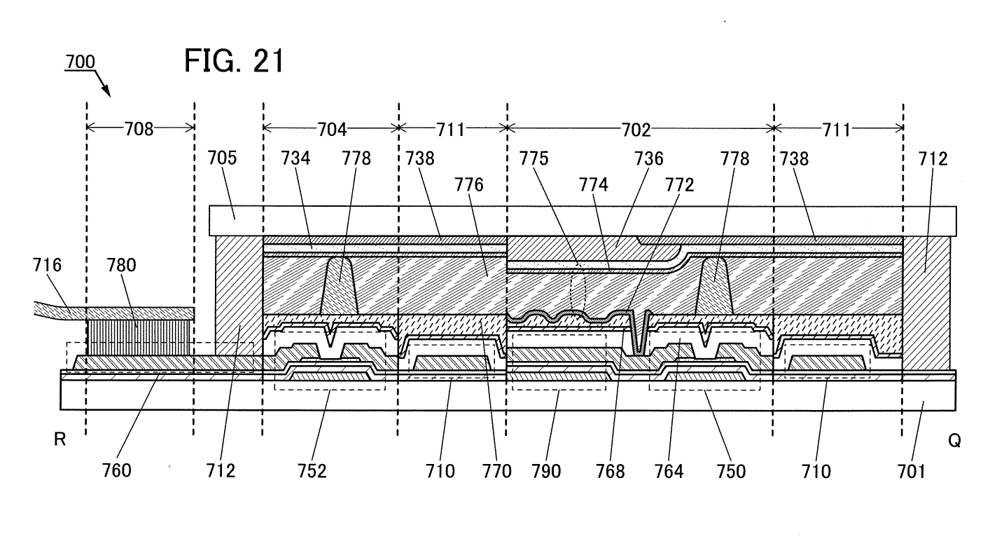

In this embodiment, an example of a display module is described below with reference to FIG. 20 and FIG. 21.

FIG. 20 is a top view of an example of a display module. A display module 700 illustrated in FIG. 20 includes a pixel portion 702 provided over a first substrate 701; a source driver circuit portion 704 and a gate driver circuit portion 706 provided over the first substrate 701; a sealant 712 provided to surround the pixel portion 702, the source driver circuit portion 704, and the gate driver circuit portion 706; and a second substrate 705 provided to face the first substrate 701. The first substrate 701 and the second substrate 705 are sealed with the sealant 712. That is, the pixel portion 702, the source driver circuit portion 704, and the gate driver circuit portion 706 are sealed with the first substrate 701, the sealant 712, and the second substrate 705. Although not illustrated in FIG. 20, a display element is provided between the first substrate 701 and the second substrate 705.

In the display module 700, a flexible printed circuit (FPC) terminal portion 708 electrically connected to the pixel portion 702, the source driver circuit portion 704, the gate driver circuit portion 706, and the gate driver circuit portion 706 is provided in a region different from the region which is surrounded by the sealant 712 and positioned over the first substrate 701. Furthermore, an FPC 716 is connected to the FPC terminal portion 708, and a variety of signals and the like are supplied to the pixel portion 702, the source driver circuit portion 704, and the gate driver circuit portion 706 through the FPC 716. Furthermore, a signal line 710 is connected to the pixel portion 702, the source driver circuit portion 704, the gate driver circuit portion 706, and the FPC terminal portion 708. The variety of signals and the like are applied to the pixel portion 702, the source driver circuit portion 704, the gate driver circuit portion 706, and the FPC terminal portion 708 via the signal line 710 from the FPC 716.

A plurality of gate driver circuit portions 706 may be provided in the display module 700. An example of the display module 700 in which the source driver circuit portion 704 and the gate driver circuit portion 706 are formed over the first substrate 701 where the pixel portion 702 is also formed is described; however, the structure is not limited thereto. For example, only the gate driver circuit portion 706 may be formed over the first substrate 701 or only the source driver circuit portion 704 may be formed over the first substrate 701. In this case, a substrate where a source driver circuit, a gate driver circuit, or the like is formed (e.g., a driver-circuit substrate formed using a single-crystal semiconductor film or a polycrystalline semiconductor film) may be mounted on the first substrate 701. Note that there is no particular limitation on the method of connecting a separately prepared driver circuit substrate, and a chip on glass (COG) method, a wire bonding method, or the like can be used.

The pixel portion 702, the source driver circuit portion 704, and the gate driver circuit portion 706 included in the display module 700 include a plurality of transistors. As the plurality of transistors, any of the transistors that are described in the above embodiments can be used.

The display module 700 can include a liquid crystal element. Examples of display devices including the liquid crystal element include a liquid crystal display (e.g., a transmissive liquid crystal display, a transflective liquid crystal display, a reflective liquid crystal display, a direct-view liquid crystal display, or a projection liquid crystal display). In the case of a transflective liquid crystal display or a reflective liquid crystal display, some of or all of pixel electrodes function as reflective electrodes. For example, some or all of pixel electrodes are formed to include aluminum, silver, or the like. In such a case, a memory circuit such as an SRAM can be provided under the reflective electrodes, leading to lower power consumption.

As a display method in the display module 700, a progressive method, an interlace method, or the like can be employed. Furthermore, color elements controlled in a pixel at the time of color display are not limited to three colors: R, G, and B (R, G, and B correspond to red, green, and blue, respectively). For example, four pixels of the R pixel, the G pixel, the B pixel, and a W (white) pixel may be included. Alternatively, a color element may be composed of two colors among R, G, and B as in PenTile layout. The two colors may differ among color elements. Alternatively, one or more colors of yellow, cyan, magenta, and the like may be added to RGB. Furthermore, the size of a display region may be different depending on respective dots of the color components. Embodiments of the disclosed invention are not limited to a display device for color display; the disclosed invention can also be applied to a display device for monochrome display.

A coloring layer (also referred to as a color filter) may be used in order to obtain a full-color display device in which white light (W) for a backlight (e.g., an organic EL element, an inorganic EL element, an LED, or a fluorescent lamp) is used. As the coloring layer, red (R), green (G), blue (B), yellow (Y), or the like may be combined as appropriate, for example. With the use of the coloring layer, higher color reproducibility can be obtained than in the case without the coloring layer. In this case, by providing a region with the coloring layer and a region without the coloring layer, white light in the region without the coloring layer may be directly utilized for display. By partly providing the region without the coloring layer, a decrease in luminance due to the coloring layer can be suppressed, and 20% to 30% of power consumption can be reduced in some cases when an image is displayed brightly. Note that in the case where full-color display is performed using a self-luminous element such as an organic EL element or an inorganic EL element, elements may emit light of their respective colors R, G, B, Y, and W. By using a self-luminous element, power consumption can be further reduced as compared to the case of using the coloring layer in some cases. Note that in this embodiment, a structure in which a backlight and the like are not provided, that is, a so-called reflective liquid crystal display module is described below.

FIG. 21 is a cross-sectional view taken along dashed-dotted line Q-R in FIG. 20. The display module illustrated in FIG. 21 is described in detail below.

### <Display Module>

The display module 700 illustrated in FIG. 21 includes a lead wiring portion 711, the pixel portion 702, the source driver circuit portion 704, and the FPC terminal portion 708. Note that the lead wiring portion 711 includes the signal line 710. The pixel portion 702 includes a transistor 750 and a capacitor 790. The source driver circuit portion 704 includes a transistor 752.

Any of the transistors described above can be used as the transistors 750 and 752.

The transistors used in this embodiment each include an oxide semiconductor film which is highly purified and in which formation of oxygen vacancies is suppressed. In the transistor, the current in an off state (off-state current) can be made small. Accordingly, an electrical signal such as an image signal can be held for a longer period, and a writing interval can be set longer in an on state. Accordingly, frequency of refresh operation can be reduced, which leads to an effect of suppressing power consumption.

In addition, the transistor used in this embodiment can have relatively high field-effect mobility and thus is capable of high speed operation. For example, with such a transistor which can operate at high speed used for a liquid crystal display device, a switching transistor in a pixel portion and a driver transistor in a driver circuit portion can be formed over one substrate. That is, a semiconductor device formed using a silicon wafer or the like is not additionally needed as a driver circuit, by which the number of components of the semiconductor device can be reduced. In addition, the transistor which can operate at high speed can be used also in the pixel portion, whereby a high-quality image can be provided.

The capacitor 790 includes a dielectric between a pair of electrodes.

Specifically, a conductive film which is formed using the same step as a conductive film functioning as a gate electrode of the transistor 750 is used as one electrode of the capacitor 790, and a conductive film functioning as a source electrode or a drain electrode of the transistor 750 is used as the other electrode of the capacitor 790. Furthermore, an insulating film functioning as a gate insulating film of the transistor 750 is used as the dielectric between the pair of electrodes.

In FIG. 21, insulating films 764, 766, and 768 and a planarization insulating film 770 are formed over the transistor 750, the transistor 752, and the capacitor 790.

As the insulating film 764, a silicon oxide film, a silicon oxynitride film, or the like may be formed by a PECVD device, for example. As the insulating film 768, a silicon nitride film or the like may be formed by a PECVD device, for example. The planarization insulating film 770 can be formed using a heat-resistant organic material, such as a polyimide resin, an acrylic resin, a polyimide amide resin, a benzocyclobutene resin, a polyamide resin, or an epoxy resin. Note that the planarization insulating film 770 may be formed by stacking a plurality of insulating films formed from these materials. Alternatively, a structure without the planarization insulating film 770 may be employed.

The signal line 710 is formed in the same process as conductive films functioning as a source electrode and a drain electrode of the transistor 750 or 752. Note that the signal line 710 may be formed using a conductive film which is formed in a different process as a source electrode and a drain electrode of the transistor 750 or 752, e.g., a conductive film functioning as a gate electrode may be used. In the case where the signal line 710 is formed using a material including a copper element, signal delay or the like due to wiring resistance is reduced, which enables display on a large screen.

The FPC terminal portion 708 includes a connection electrode 760, an anisotropic conductive film 780, and the FPC 716. Note that the connection electrode 760 is formed in the same process as conductive films functioning as a source electrode and a drain electrode of the transistor 750 or 752. The connection electrode 760 is electrically connected to a terminal included in the FPC 716 through the anisotropic conductive film 780.

For example, a glass substrate can be used as the first substrate 701 and the second substrate 705. A flexible substrate may be used as the first substrate 701 and the second substrate 705. Examples of the flexible substrate include a plastic substrate.

A structure body 778 is provided between the first substrate 701 and the second substrate 705. The structure body 778 is a columnar spacer obtained by selective etching of an insulating film and provided to control the distance (cell gap) between the first substrate 701 and the second substrate 705. Note that a spherical spacer may be used as the structure body 778. Although the structure in which the structure body 778 is provided on the first substrate 701 side is described as an example in this embodiment, one embodiment of the present invention is not limited thereto. For example, a structure in which the structure body 778 is provided on the second substrate 705 side, or a structure in which both of the first substrate 701 and the second substrate 705 are provided with the structure body 778 may be employed.

Furthermore, a light-blocking film 738 functioning as a black matrix, a coloring film 736 functioning as a color filter, and an insulating film 734 in contact with the light-blocking film 738 and the coloring film 736 are provided on the second substrate 705 side.

### <Structural Example of Liquid Crystal Element as Display Element>

The display module 700 illustrated in FIG. 21 includes a liquid crystal element 775. The liquid crystal element 775 includes a conductive film 772, a conductive film 774, and a liquid crystal layer 776. The liquid crystal layer 776 is formed using a liquid crystal material having a dielectric constant anisotropy of greater than or equal to 2 and less than or equal to 3.8. The conductive film 774 is provided on the second substrate 705 side and functions as a counter electrode. The display module 700 in FIG. 21 is capable of displaying an image in such a manner that transmission or non-transmission of light is controlled by change in the alignment state of the liquid crystal layer 776 depending on a voltage applied to the conductive film 772 and the conductive film 774.

The conductive film 772 is connected to the conductive films functioning as a source electrode and a drain electrode included in the transistor 750. The conductive film 772 is formed over the planarization insulating film 770 to function as a pixel electrode, i.e., one electrode of the display element. The conductive film 772 has a function of a reflective electrode. The display module 700 in FIG. 21 is what is called a reflective color liquid crystal display device in which external light is reflected by the conductive film 772 to display an image through the coloring film 736.

A conductive film that transmits visible light or a conductive film that reflects visible light can be used for the conductive film 772. For example, a material including one kind selected from indium (In), zinc (Zn), and tin (Sn) is preferably used for the conductive film that transmits visible light. For example, a material including aluminum or silver may be used for the conductive film that reflects visible light. In this embodiment, the conductive film that reflects visible light is used for the conductive film 772.

In the case where a conductive film which reflects visible light is used as the conductive film 772, the conductive film may have a stacked-layer structure. For example, a 100-nm-thick aluminum film is formed as the bottom layer, and a 30-nm-thick silver alloy film (e.g., an alloy film including silver, palladium, and copper) is formed as the top layer. Such a structure makes it possible to obtain the following effects.

(1) Adhesion between the base film and the conductive film 772 can be improved.

(2) The aluminum film and the silver alloy film can be collectively etched depending on a chemical solution.

(3) The conductive film 772 can have a favorable cross-sectional shape (e.g., a tapered shape).

The reason for (3) is as follows: the etching rate of the aluminum film with the chemical solution is lower than that of the silver alloy film, or etching of the aluminum film that is the bottom layer is developed faster than that of the silver alloy film because when the aluminum film that is the bottom layer is exposed after the etching of the silver alloy film that is the top layer, electrons are extracted from metal that is less noble than the silver alloy film, i.e., aluminum that is metal having a high ionization tendency, and thus etching of the silver alloy film is suppressed.

Note that projections and depressions are provided in part of the planarization insulating film 770 of the pixel portion 702 in the display module 700 in FIG. 21. The projections and depressions can be formed in such a manner that the planarization insulating film 770 is formed using an organic resin film or the like, and projections and depressions are formed on the surface of the organic resin film. The conductive film 772 functioning as a reflective electrode is formed along the projections and depressions. Therefore, when external light is incident on the conductive film 772, the light is reflected diffusely at the surface of the conductive film 772, whereby visibility can be improved. As illustrated in FIG. 21, a reflective color liquid crystal display device can display an image without a backlight, which enables a reduction in power consumption.

Note that the display module 700 illustrated in FIG. 21 is a reflective color liquid crystal display module given as an example, but a display type is not limited thereto. For example, a transmissive color liquid crystal display module in which the conductive film 772 is a conductive film that transmits visible light may be used. In the case of a transmissive color liquid crystal display module, projections and depressions are not necessarily provided on the planarization insulating film 770.

Although not illustrated in FIG. 21, an alignment film may be provided on a side of the conductive film 772 in contact with the liquid crystal layer 776 and on a side of the conductive film 774 in contact with the liquid crystal layer 776. Although not illustrated in FIG. 21, an optical member (an optical substrate) and the like such as a polarizing member, a retardation member, or an anti-reflection member may be provided as appropriate. For example, circular polarization may be employed by using a polarizing substrate and a retardation substrate. In the case of the transmissive display module or the semi-transmissive display module, a backlight, a sidelight, or the like may be used as a light source.

As the liquid crystal element, a thermotropic liquid crystal, a low-molecular liquid crystal, a high-molecular liquid crystal, a polymer dispersed liquid crystal, a ferroelectric liquid crystal, an anti-ferroelectric liquid crystal, or the like can be used. Such a liquid crystal material exhibits a cholesteric phase, a smectic phase, a cubic phase, a chiral nematic phase, an isotropic phase, or the like depending on conditions.

Alternatively, in the case of employing a horizontal electric field mode, a liquid crystal exhibiting a blue phase for which an alignment film is unnecessary may be used. A blue phase is one of liquid crystal phases, which is generated just before a cholesteric phase changes into an isotropic phase while temperature of cholesteric liquid crystal is increased. Since the blue phase appears only in a narrow temperature range, a liquid crystal composition in which several weight percent or more of a chiral material is mixed is used for the liquid crystal layer in order to improve the temperature range. The liquid crystal composition which includes liquid crystal exhibiting a blue phase and a chiral material has a short response time, and has optical isotropy, which makes the alignment process unneeded. Furthermore, the liquid crystal material that exhibits a blue phase has a small viewing angle dependence. An alignment film does not need to be provided and rubbing treatment is thus not necessary; accordingly, electrostatic discharge damage caused by the rubbing treatment can be prevented and defects and damage of the liquid crystal display device in the manufacturing process can be reduced.

In the case where a liquid crystal element is used as the display element, a twisted nematic (TN) mode, an in-plane-switching (IPS) mode, a fringe field switching (FFS) mode, an axially symmetric aligned micro-cell (ASM) mode, an optical compensated birefringence (OCB) mode, a ferroelectric liquid crystal (FLC) mode, an antiferroelectric liquid crystal (AFLC) mode, or the like can be used.

Furthermore, a normally black liquid crystal display device such as a transmissive liquid crystal display device utilizing a vertical alignment (VA) mode may also be used. There are some examples of a vertical alignment mode; for example, a multi-domain vertical alignment (MVA) mode, a patterned vertical alignment (PVA) mode, an ASV mode, or the like can be employed.

The structure described in this embodiment can be used in appropriate combination with any of the structures described in the other embodiments.

### Embodiment 9

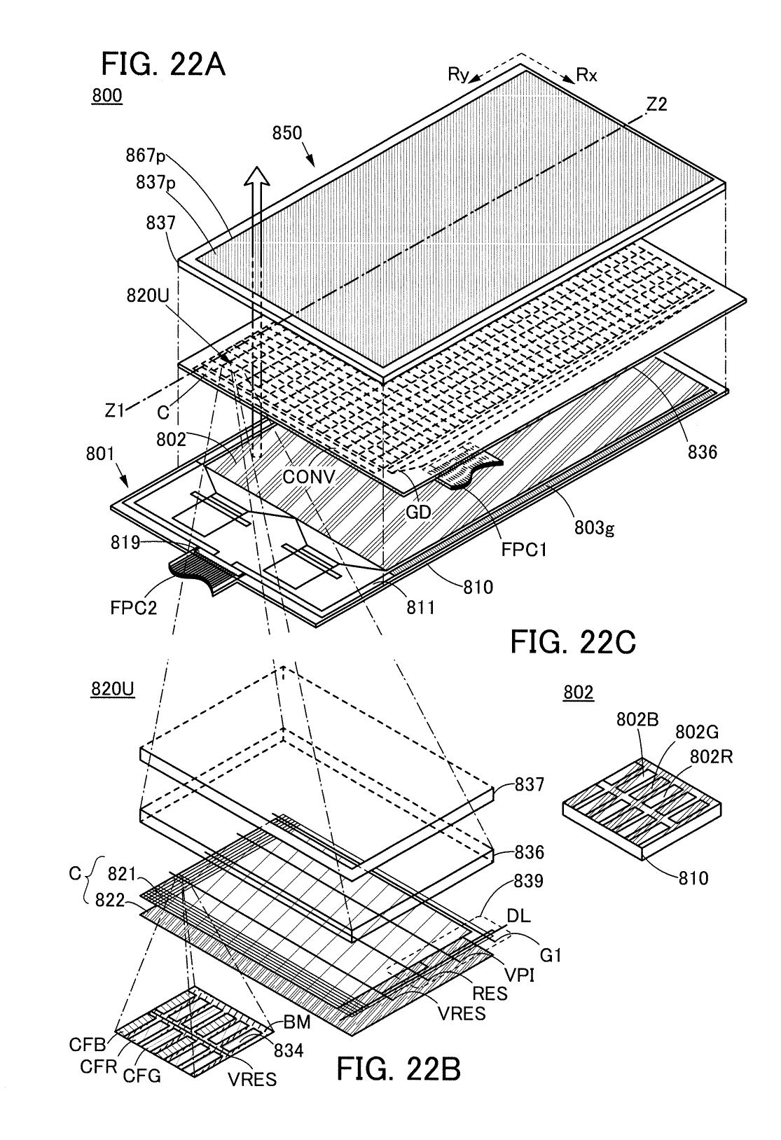

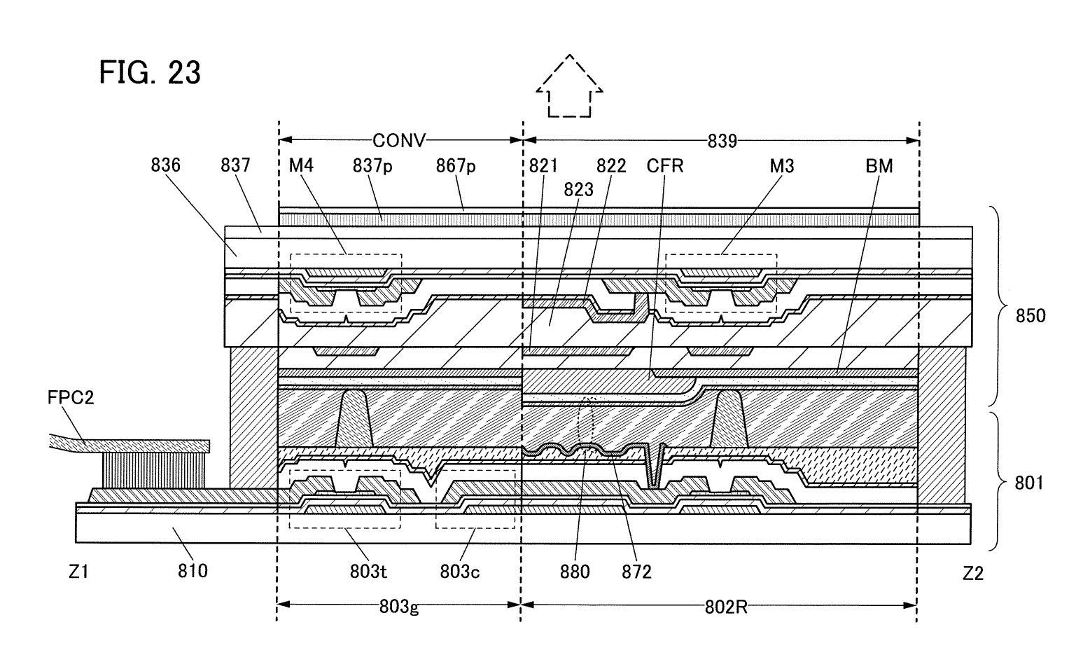

In this embodiment, an input/output device (also referred to as a touch panel) obtained by providing a touch sensor (a contact sensor device) for the display module described in the above embodiment is described with reference to FIG. 22 and FIG. 23. Hereinafter, the description of the same portions as the above embodiments is omitted in some cases.

FIG. 22 are projection drawings illustrating a structure of the input/output device.

FIG. 22A is a projection drawing of an input/output device 800, and FIG. 22B is a projection drawing illustrating a structure of a sensor unit 820U included in the input/output device 800.

FIG. 23 is a cross-sectional view taken along line Z1-Z2 of the input/output device 800 in FIG. 22A.

### <Structural Example 1 of Input/Output Device>

The input/output device 800 described in this embodiment includes an input device 850 and a display module 801. The input device 850 includes a plurality of sensor units 820U arranged in matrix and each provided with window portions 834 transmitting visible light, a scan line G1 electrically connected to a plurality of sensor units 820U placed in the row direction (indicated by arrow Rx in the drawing), a signal line DL electrically connected to a plurality of sensor units 820U placed in the column direction (indicated by arrow Ry in the drawing), and a first base material 836 supporting the sensor unit 820U, the scan line G1, and the signal line DL. The display module 801 includes a plurality of pixels 802 overlapping with the window portions 834 and arranged in matrix and a second base material 810 supporting the pixels 802 (see FIGS. 22A to 22C).

The sensor unit 820U includes a sensor element C overlapping with the window portion 834 and a sensor circuit 839 electrically connected to the sensor element C (see FIG. 22B).

The sensor element C includes an insulating layer 823 (not illustrated in FIG. 22B), and a first electrode 821 and a second electrode 822 between which the insulating layer 823 is sandwiched (see FIG. 22B).

A selection signal is supplied to the sensor circuit 839, and the sensor circuit 839 supplies a sensor signal DATA based on the change in capacitance of the sensor element C.

The scan line G1 can supply the selection signal, the signal line DL can supply the sensor signal DATA, and the sensor circuit 839 is placed to overlap with gaps between the plurality of window portions 834.

In addition, the input/output device 800 described in this embodiment includes a coloring layer between the sensor unit 820U and the pixel 802 overlapping with the window portion 834 of the sensor unit 820U.

The input/output device 800 described in this embodiment includes the input device 850 including the plurality of sensor units 820U, each of which is provided with the window portions 834 transmitting visible light, and the display module 801 including the plurality of pixels 802 overlapping with the window portions 834. The coloring layer is included between the window portion 834 and the pixel 802.

With such a structure, the input/output device can supply a sensor signal based on the change in the capacitance and positional information of the sensor unit supplying the sensor signal and can display image data relating to the positional information of the sensor unit. As a result, a novel input/output device with high convenience or high reliability can be provided.

The input/output device 800 may include a flexible substrate FPC 1 to which a signal from the input device 850 is supplied and/or a flexible substrate FPC 2 supplying a signal including image data to the display module 801.

In addition, a protective base material 837 or a protective layer 837p that protects the input/output device 800 by preventing damage and/or an anti-reflective layer 867p that weakens the intensity of external light reflected by the input/output device 800 may be included.

Moreover, the input/output device 800 includes a scan line driver circuit 803g that supplies the selection signal to an operation line of the display module 801, a wiring 811 supplying a signal, and a terminal 819 electrically connected to the flexible substrate FPC 2.

Components of the input/output device 800 are described below. Note that these components cannot be clearly distinguished and one component also serves as another component or includes part of another component in some cases. For example, the input device 850 including the coloring layer overlapping with the plurality of window portions 834 also serves as a color filter.

### <<Whole Structure of Input/Output Device>>

The input/output device 800 includes the input device 850 and the display module 801 (see FIG. 22A).

### <<Input Device>>

The input device 850 includes the plurality of sensor units 820U and the first base material 836 supporting the sensor units 820U. For example, the plurality of sensor units 820U are arranged in matrix with 40 rows and 15 columns on the first base material 836.

### <<Window Portion, Coloring Layer, and Light-Blocking Layer>>

The window portion 834 transmits visible light.

A coloring layer transmitting light of a predetermined color is provided to overlap with the window portion 834. For example, a coloring layer CFB transmitting blue light, a coloring layer CFG, or a coloring layer CFR is included (see FIG. 22B).

Note that, in addition to the coloring layers transmitting blue light, green light, and/or red light, coloring layers transmitting light of various colors such as a coloring layer transmitting white light and a coloring layer transmitting yellow light can be included.

For a coloring layer, a metal material, a pigment, dye, or the like can be used.

A light-blocking layer BM is provided to surround the window portions 834. The light-blocking layer BM does not easily transmit light as compared to the window portion 834.

For the light-blocking layer BM, carbon black, a metal oxide, a composite oxide containing a solid solution of a plurality of metal oxides, or the like can be used.

The scan line G1, the signal line DL, a wiring VPI, a wiring RES, a wiring VRES, and the sensor circuit 839 are provided to overlap with the light-blocking layer BM.

Note that a light-transmitting overcoat layer covering the coloring layer and the light-blocking layer BM can be provided.

### <<Sensor Element>>

The sensor element Ca includes the first electrode 821, the second electrode 822, and the insulating layer 823 between the first electrode 821 and the second electrode 822 (see FIG. 23A).

The first electrode 821 is formed in, for example, an island shape so as to be apart from other regions. A layer that can be formed in the same process as that of the first electrode 821 is preferably placed close to the first electrode 821 so that the user of the input/output device 800 does not recognize the first electrode 821. Further preferably, the number of the window portions 834 placed in the gap between the first electrode 821 and the layer placed close to the first electrode 821 is reduced as much as possible. In particular, the window portion 834 is preferably not placed in the gap.

When an object whose dielectric constant is different from that of the air gets closer to the first electrode 821 or the second electrode 822 of the sensor element C that is put in the air, the capacitance of the sensor element C is changed. Specifically, when a finger or the like gets closer to the sensor element C, the capacitance of the sensor element C is changed. Thus, the sensor element C can be used in a proximity sensor.

The first electrode 821 and the second electrode 822 include a conductive material.

For example, an inorganic conductive material, an organic conductive material, a metal material, a conductive ceramic material, or the like can be used for the first electrode 821 and the second electrode 822.

Specifically, a metal element selected from aluminum, chromium, copper, tantalum, titanium, molybdenum, tungsten, nickel, silver, and manganese; an alloy including any of the above-described metal elements; an alloy including any of the above-described metal elements in combination; or the like can be used for the first electrode 821 and the second electrode 822.

Alternatively, a conductive oxide such as indium oxide, indium tin oxide, indium zinc oxide, zinc oxide, or zinc oxide to which gallium is added can be used for the first electrode 821 and the second electrode 822.

Alternatively, graphene or graphite can be used for the first electrode 821 and the second electrode 822. The film including graphene can be formed, for example, by reducing a film containing graphene oxide. As a reducing method, a method with application of heat, a method using a reducing agent, or the like can be employed.

Alternatively, a conductive polymer can be used for the first electrode 821 and the second electrode 822.

### <<Sensor Circuit>>

The sensor circuit 839 includes transistors M1 to M3, for example. In addition, the sensor circuit 839 includes wirings supplying a power supply potential and a signal. For example, the signal line DL, the wiring VPI, a wiring CS, the scan line G1, the wiring RES, the wiring VRES, and the signal line DL are included.

Note that the sensor circuit 839 may be placed not to overlap with the window portion 834.

A conductive material can be used for the wirings (e.g., the signal line DL, the wiring VPI, the wiring CS, the scan line G1, the wiring RES, the wiring VRES, and the signal line DL). For example, an inorganic conductive material, an organic conductive material, a metal material, a conductive ceramic material, or the like can be used for the wirings. Alternatively, a material which is the same as those of the first electrode 821 and the second electrode 822 may be used.

For the scan line G1, the signal line DL, the wiring VPI, the wiring RES, and the wiring VRES, a metal material such as aluminum, gold, platinum, silver, nickel, titanium, tungsten, chromium, molybdenum, iron, cobalt, copper, or palladium, or an alloy material containing any of these metal materials can be used.

The sensor circuit 839 may be formed on the first base material 836. Alternatively, the sensor circuit 839 formed on another base material may be transferred to the first base material 836.

### <<First Base Material and Second Base Material>>

Examples of the materials of the first base material 836 and the second base material 810 are glass substrates or flexible materials (e.g., a resin, a resin film, and a plastic film).

More specifically, non-alkali glass, soda-lime glass, potash glass, crystal glass, or the like can be used for the first base material 836 and the second base material 810. Alternatively, a resin film or resin plate of polyester, polyolefin, polyamide, polyimide, polycarbonate, an acrylic resin, or the like can be used for the first base material 836.

### <<Protective Base Material, Protective Layer>>

For example, as the protective base material 837 and/or the protective layer 837p, a glass substrate, a resin film or resin plate of polyester, polyolefin, polyamide, polyimide, polycarbonate, an acrylic resin, or the like, a stack thereof, or the like can be used for the protective base material 817.

For example, a hard coat layer or a ceramic coat layer can be used as the protective layer 837p. Specifically, a layer containing a UV curable resin or aluminum oxide may be formed to overlap with the second electrode 822.

### <<Display Module>>

The display module 801 includes the plurality of pixels 802 arranged in matrix (see FIG. 22C).

For example, the pixel 802 includes a sub-pixel 802B, a sub-pixel 802G, and a sub-pixel 802R, and each sub-pixel includes a display element and a pixel circuit for driving the display element.

In the pixel 802, the sub-pixel 802B is placed to overlap with the coloring layer CFB, the sub-pixel 802G is placed to overlap with the coloring layer CFG, and the sub-pixel 802R is placed to overlap with the coloring layer CFR.

### <<Pixel Structure>>

The coloring layer CFR is positioned in a region overlapping with the liquid crystal element 880. Note that the liquid crystal element 880 includes a reflective electrode 872 as one electrode (see FIG. 23). Thus, part of external light reflected by the reflective electrode 872 passes through the coloring layer CFR and is emitted in a direction indicated by an arrow in the drawing. The reflective electrode 872 can have a structure similar to that of the conductive film 772 serving as the reflective electrode in the above embodiment. The liquid crystal element 880 includes a liquid crystal layer having a dielectric constant anisotropy of greater than or equal to 2 and less than or equal to 3.8.

The light-blocking layer BM is provided to surround the coloring layer (e.g., the coloring layer CFR).

### <<Configuration of Scan Line Driver Circuit>>

The scan line driver circuit 803g includes a transistor 803t and a capacitor 803c (see FIG. 23).

### <<Converter>>

Various circuits that can convert the sensor signal DATA supplied from the sensor unit 820U and supply the converted signal to the FPC 1 can be used as a converter CONV (see FIG. 22A).

For example, a transistor M4 illustrated in FIG. 23 can be used in the converter CONV.

### <<Other Structure>>

The display module 801 includes the anti-reflective layer 867p positioned in a region overlapping with pixels. As the anti-reflective layer 867p, a circular polarizing plate can be used, for example.

As illustrated in FIG. 22A, the display module 801 includes the wirings 811 through which signals can be supplied. The wirings 811 are provided with the terminal 819. Note that the flexible substrate FPC 2 through which a signal such as an image signal or a synchronization signal is supplied is electrically connected to the terminal 819.

Note that a printed wiring board (PWB) may be attached to the flexible substrate FPC 2.

The display module 801 includes wirings such as scan lines, signal lines, and power supply lines. Any of various conductive films can be used as the wirings.

For the wirings included in the display module 801, for example, a metal element selected from aluminum, chromium, copper, tantalum, titanium, molybdenum, tungsten, nickel, yttrium, zirconium, silver, and manganese; an alloy including any of the above-described metal elements; or an alloy including any of the above-described metal elements in combination can be used. In particular, one or more elements selected from aluminum, chromium, copper, tantalum, titanium, molybdenum, and tungsten are preferably included. In particular, an alloy of copper and manganese is suitably used in microfabrication with the use of a wet etching method.

As specific structures of the wirings included in the display module 801, a two-layer structure in which a titanium film is stacked over an aluminum film, a two-layer structure in which a titanium film is stacked over a titanium nitride film, a two-layer structure in which a tungsten film is stacked over a titanium nitride film, a two-layer structure in which a tungsten film is stacked over a tantalum nitride film or a tungsten nitride film, a three-layer structure in which a titanium film, an aluminum film, and a titanium film are stacked in this order, and the like can be given. Alternatively, a structure in which an alloy film or a nitride film which contains one or more elements selected from titanium, tantalum, tungsten, molybdenum, chromium, neodymium, and scandium is stacked over an aluminum film can be used. Alternatively, a light-transmitting conductive material including indium oxide, tin oxide, or zinc oxide may be used.

Note that this embodiment can be combined with any of the other embodiments in this specification as appropriate.

### Embodiment 10

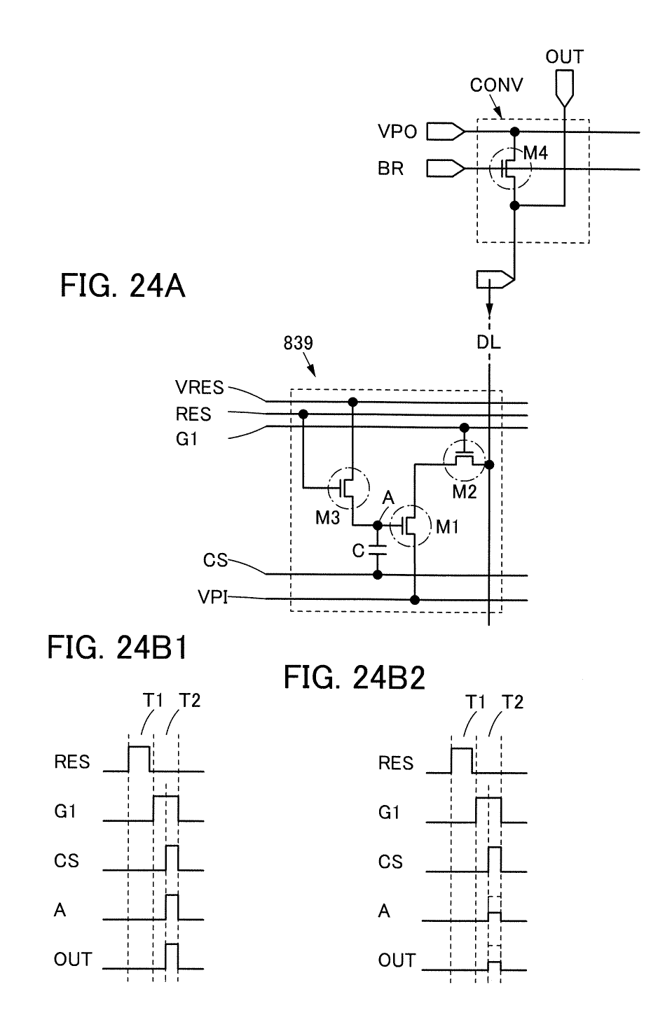

In this embodiment, a configuration and a driving method of the sensor circuit 839 that can be used in the sensor unit 820U of the input/output device 800 described in the above embodiment is described with reference to FIG. 24.

FIG. 24 illustrate a configuration and a driving method of the sensor circuit 839 and the converter CONV of one embodiment of the present invention.

FIG. 24A is a circuit diagram illustrating configurations of the sensor circuit 839 and the converter CONV of one embodiment of the present invention, and FIGS. 24B1 and 24B2 are timing charts illustrating driving methods.

The sensor circuit 839 includes the first transistor M1 whose gate is electrically connected to the first electrode 821 of the sensor element C and whose first electrode is electrically connected to the wiring VPI that can supply, for example, a ground potential (see FIG. 24A).

Furthermore, the second transistor M2 whose gate is electrically connected to the scan line G1 that can supply a selection signal, whose first electrode is electrically connected to a second electrode of the first transistor M1, and whose second electrode is electrically connected to the signal line DL that can supply, for example, the sensor signal DATA may be included.

Furthermore, the third transistor M3 whose gate is electrically connected to the wiring RES that can supply a reset signal, whose first electrode is electrically connected to the first electrode 821 of the sensor element C, and whose second electrode is electrically connected to the wiring VRES that can supply, for example, a ground potential may be included.

The capacitance of the sensor element C is changed when an object gets closer to the first electrode 821 or the second electrode 822 or when a gap between the first electrode 821 and the second electrode 822 is changed, for example. Thus, the sensor circuit 839 can supply the sensor signal DATA based on the change in the capacitance of the sensor element C.

Furthermore, the sensor circuit 839 includes the wiring CS that can supply a control signal for controlling the potential of the second electrode 822 of the sensor element C.

Note that a node at which the first electrode 821 of the sensor element C, the gate of the first transistor M1, and the first electrode of the third transistor are electrically connected to each other is referred to as a node A.

The wiring VRES and the wiring VPI each can supply a ground potential, for example, and the wiring VPO and the wiring BR each can supply a high power supply potential, for example.

Furthermore, the wiring RES can supply a reset signal, the scan line G1 can supply a selection signal, and the wiring CS can supply a control signal for controlling the potential of the second electrode 822 of the sensor element C.

Furthermore, the signal line DL can supply the sensor signal DATA, and a terminal OUT can supply a signal converted based on the sensor signal DATA.

Any of various circuits that can convert the sensor signal DATA and supply the converted signal to the terminal OUT can be used as the converter CONV. For example, a source follower circuit, a current mirror circuit, or the like may be formed by the electrical connection between the converter CONV and the sensor circuit 839.

Specifically, by using the converter CONV including the transistor M4, a source follower circuit can be formed (see FIG. 24A). Note that a transistor that can be formed in the same process as those of the first transistor M1 to the third transistor M3 may be used as the transistor M4.

The transistors M1 to M3 each include a semiconductor layer. For example, for the semiconductor layer, an element belonging to group 4, a compound semiconductor, or an oxide semiconductor can be used. Specifically, a semiconductor containing silicon, a semiconductor containing gallium arsenide, an oxide semiconductor containing indium, or the like can be used. Note that the above embodiments can be referred to for the transistor including an oxide semiconductor.

### <Driving Method of Sensor Circuit>

A driving method of the sensor circuit 839 is described.

### <<First Step>>

In a first step, a reset signal that turns on and then turns off the third transistor M3 is supplied to the gate, and the potential of the first electrode 821 of the sensor element C is set to a predetermined potential (see a period T1 in FIG. 24B1).

Specifically, the reset signal is supplied from the wiring RES. The third transistor M3 to which the reset signal is supplied sets the potential of the node A to a ground potential, for example (see FIG. 24A).

### <<Second Step>>

In a second step, a selection signal that turns on the second transistor M2 is supplied to the gate of the second transistor M2, and the second electrode of the first transistor M1 is electrically connected to the signal line DL.

Specifically, the selection signal is supplied from the scan line G1. Through the second transistor M2 to which the selection signal is supplied, the second electrode of the first transistor M1 is electrically connected to the signal line DL (see a period T2 in FIG. 24B1).

### <<Third Step>>

In a third step, a control signal is supplied to the second electrode 822 of the sensor element C, and a potential changed based on the control signal and the capacitance of the sensor element C is supplied to the gate of the first transistor M1.

Specifically, a rectangular wave control signal is supplied from the wiring CS. By supplying the rectangular wave control signal to the second electrode 822 of the sensor element C, the potential of the node A is increased based on the capacitance of the sensor element C (see the latter half in the period T2 in FIG. 24B1).

For example, in the case where the sensor element is put in the air, when an object whose dielectric constant is higher than that of the air is placed closer to the second electrode 822 of the sensor element C, the capacitance of the sensor element C is apparently increased.

Thus, the change in the potential of the node A due to the rectangular wave control signal becomes smaller than that in the case where an object whose dielectric constant is higher than that of the air is placed is not placed closer (see a solid line in FIG. 24B2).

### <<Fourth Step>>

In a fourth step, a signal obtained by the change in the potential of the gate of the first transistor M1 is supplied to the signal line DL.

For example, a change in current due to the change in the potential of the gate of the first transistor M1 is supplied to the signal line DL.

The converter CONV converts the change in the current flowing through the signal line DL into a change in voltage and outputs the voltage.

### <<Fifth Step>>

In a fifth step, a selection signal for turning off the second transistor M2 is supplied to the gate of the second transistor M2.

Note that this embodiment can be combined with any of the other embodiments in this specification as appropriate.

### Embodiment 11

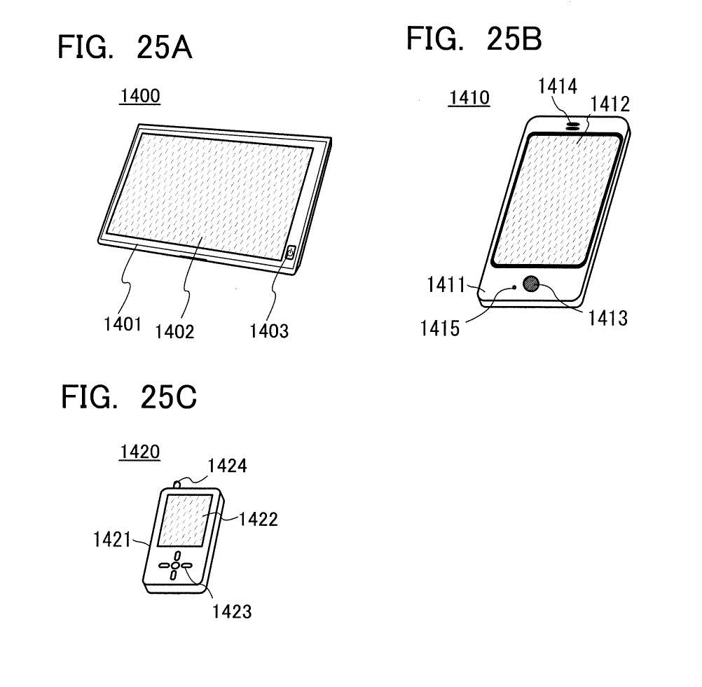

In this embodiment, specific examples of electronic devices each of which is fabricated using the liquid crystal display device described in the above embodiment are described with reference to FIG. 25.

Examples of electronic devices to which one embodiment of the present invention can be applied include a television set (also referred to as a television or a television receiver), a monitor of a computer or the like, a camera such as a digital camera or a digital video camera, a digital photo frame, a mobile phone, a portable game machine, a portable information terminal, a music reproducing device, a game machine (e.g., a pachinko machine or a slot machine), and a game console. FIG. 25 illustrate specific examples of these electronic devices.

FIG. 25A illustrates a portable information terminal 1400 including a display portion. The portable information terminal 1400 includes a display portion 1402 and an operation button 1403 which are incorporated in a housing 1401. The liquid crystal display device of one embodiment of the present invention can be used for the display portion 1402.

FIG. 25B illustrates a cellular phone 1410. The cellular phone 1410 includes a display portion 1412, an operation button 1413, a speaker 1414, and a microphone 1415 which are incorporated in a housing 1411. The liquid crystal display device of one embodiment of the present invention can be used for the display portion 1412.

FIG. 25C illustrates a music reproducing device 1420. The music reproducing device 1420 includes a display portion 1422, an operation button 1423, and an antenna 1424 which are incorporated in a housing 1421. In addition, the antenna 1424 transmits and receives data via a wireless signal. The liquid crystal display device of one embodiment of the present invention can be used for the display portion 1422.

The display portions 1402, 1412, and 1422 each have a touch-input function. When a user touches a displayed button (not illustrated) which is displayed on the display portion 1402, 1412, or 1422 with his/her fingers or the like, the user can carry out operation on the screen and input of information.

When the liquid crystal display device described in the above embodiment is used for the display portions 1402, 1412, and 1422, the display quality of the display portions 1402, 1412, and 1422 can be improved.

This embodiment can be implemented in an appropriate combination with any of the structures described in the other embodiments.

### Embodiment 12

In this embodiment, the significance of a reduction in refresh rate described in the above embodiments is explained.

The eyestrain is divided into two categories: nerve strain and muscle strain. The nerve strain is caused by prolonged looking at light emitted from a liquid crystal display device or blinking images. This is because the brightness stimulates and fatigues a retina, optic nerves, and a brain. The muscle strain is caused by overuse of a ciliary muscle which works for adjusting the focus.

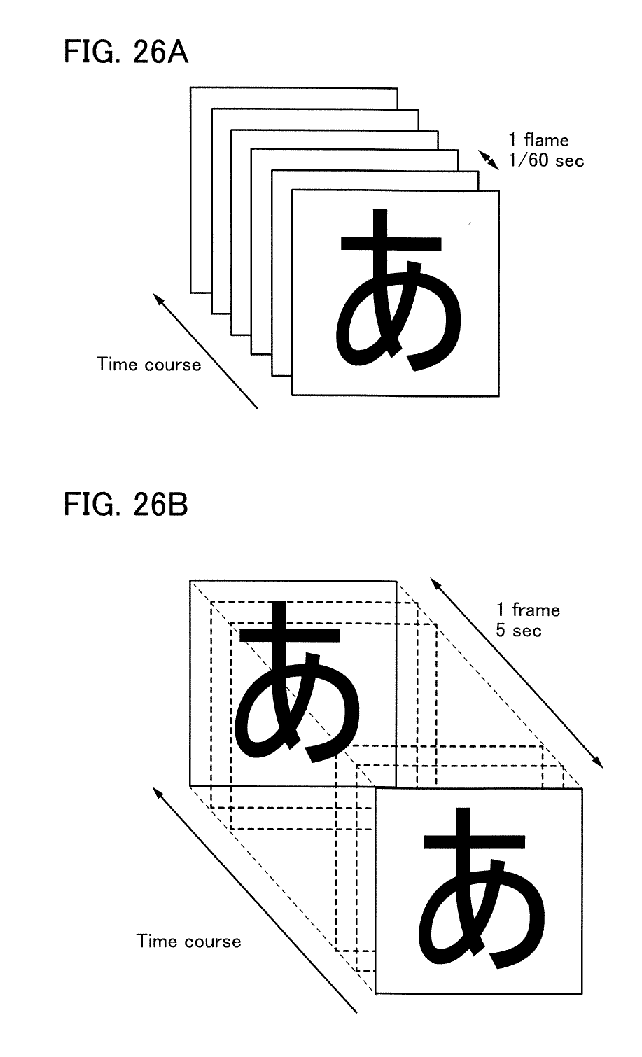

FIG. 26A is a schematic diagram illustrating display of a conventional liquid crystal display device. As illustrated in FIG. 26A, for the display of the conventional liquid crystal display device, image rewriting is performed 60 times per second. A prolonged looking at such a screen might stimulate a retina, optic nerves, and a brain of a user and lead to eyestrain.

In one embodiment of the present invention, a transistor including an oxide semiconductor (e.g., a transistor including a CAAC-OS) is used in a pixel portion of a liquid crystal display device. Since the transistor has an extremely small off-state current, the luminance of the liquid crystal display device can be kept even when the frame frequency is decreased.

Thus, for example, the number of times of image writing can be reduced to 5 times per second as shown in FIG. 26B. The same image can be displayed for a long time as much as possible and flickering on a screen perceived by a user can be suppressed. Therefore, stimuli to a retina, optic nerves, and a brain of a user are reduced, so that the strain is reduced.

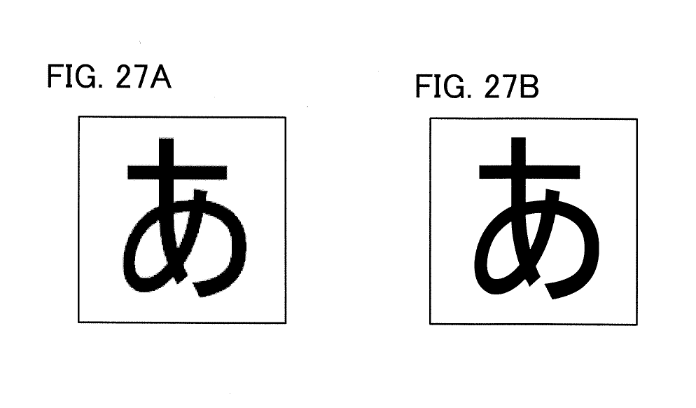

In the case where the size of one pixel is large (e.g., the resolution is less than 150 ppi), a blurred character is displayed by a liquid crystal display device as shown in FIG. 27A. When users look at the blurred character displayed on the liquid crystal display device for a long time, their ciliary muscles keep working to adjust the focus in a state where adjusting the focus is difficult, which might lead to eyestrain.

In contrast, in the liquid crystal display device of one embodiment of the present invention, the size of one pixel is small and thus high resolution display is performed as shown in FIG. 27B, so that precise and smooth display can be achieved. The precise and smooth display enables ciliary muscles to adjust the focus more easily, and reduces muscle strain of users.

Quantitative measurement of eyestrain has been studied. For example, the critical flicker (fusion) frequency (CFF) is known as an index of measuring nerve strain; and the accommodation time and the accommodation near point are known as indexes of measuring muscle strain.

Examples of other methods for measuring eyestrain include electroencephalography, thermography, measurement of the number of blinkings, measurement of tear volume, measurement of a pupil contractile response speed, and a questionnaire for surveying subjective symptoms.

One embodiment of the present invention can provide an eye-friendly liquid crystal display device.

This embodiment can be implemented in an appropriate combination with any of the structures described in the other embodiments.

### Example 1

In this example, a time-dependent change in voltage holding ratio of a material that is different from the liquid crystal layer described in Embodiment 1, and the residual DC voltage of the liquid crystal layer were measured.

In this example, two samples with different liquid crystal materials were fabricated. For a first sample, a liquid crystal material with a dielectric constant anisotropy of 3.85 (conventional material) was used in a liquid crystal layer. For a second sample, a liquid crystal material with a dielectric constant anisotropy of 2.2 (improved material 2) was used in a liquid crystal layer. Note that the sample including the liquid crystal material with a dielectric constant anisotropy of 2.2 (improved material 2) is one embodiment of the present invention. The liquid crystal material with a dielectric constant anisotropy of 3.85 (conventional material) is for a comparative sample, and is the same material as the conventional material described in Embodiment 1.

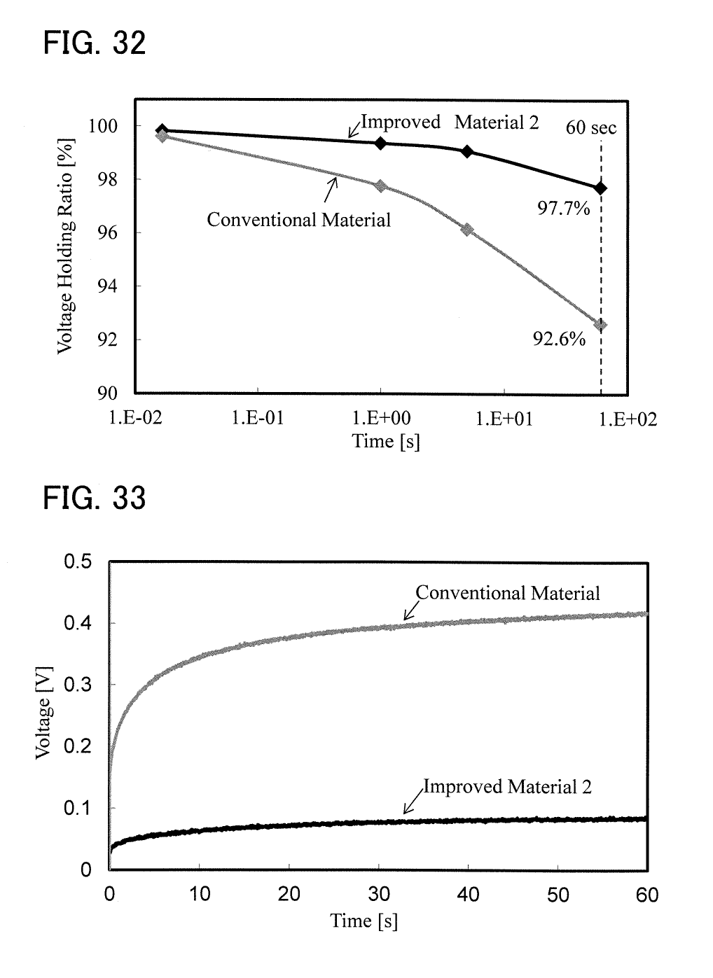

FIG. 32 shows the results by measuring dielectric constant anisotropies of the liquid crystal layers used in this example. The voltage holding ratio shown in FIG. 32 was calculated as an area ratio with a voltage held after a voltage of 5 V is applied to electrodes with the liquid crystal layer interposed therebetween and the electrodes are open-circuited. In FIG. 32, the vertical axis represents a voltage holding ratio (VHR) and the horizontal axis represents time.

FIG. 33 shows the results by measuring residual DC voltage of a liquid crystal layer used in this example. The residual DC voltage shown in FIG. 33 was obtained by measuring a time-dependent change in voltage in a state where a voltage of 5 V is applied between electrodes between which a liquid crystal layer is sandwiched for one minute, and the electrodes are short-circuited for one second, and then the electrodes are open-circuited. In FIG. 33, the vertical axis represents voltage and the horizontal axis represents time.

According to the results shown in FIG. 32, the liquid crystal material with a dielectric constant anisotropy of 2.2 (improved material 2), which is one embodiment of the present invention, had a voltage holding ratio of 97.7% after 60 s, whereas the liquid crystal material for comparison with a dielectric constant anisotropy of 3.85 (conventional material) had a voltage holding ratio of 92.6% after 60 s. Thus, it was able to be demonstrated that the liquid crystal layer with a dielectric constant anisotropy of 2.2 has a high voltage holding ratio.

Furthermore, according to the results shown in FIG. 33, the liquid crystal material with a dielectric constant anisotropy of 2.2 (improved material 2), which is one embodiment of the present invention, had a lower residual DC voltage than the liquid crystal material for comparison with a dielectric constant anisotropy of 3.85 (conventional material).

The structure described in this example can be used as appropriate in combination with any of the structures described in the other embodiments and the other examples.

### Example 2

In this example, a display device of one embodiment of the present invention was fabricated and evaluated.

The display devices of this example were active matrix reflective monochrome displays. For backplane-side FETs in the display devices fabricated in this example, CAAC-IGZO was used.

In this example, two display devices with different liquid crystal materials were fabricated. For a first display device, a liquid crystal material with a dielectric constant anisotropy of 3.85 (conventional material) was used in a liquid crystal layer. For a second display device, a liquid crystal material with a dielectric constant anisotropy of 2.3 (an improved material) was used in a liquid crystal layer. Note that the display device including the liquid crystal material with a dielectric constant anisotropy of 2.3 (improved material) is one embodiment of the present invention.

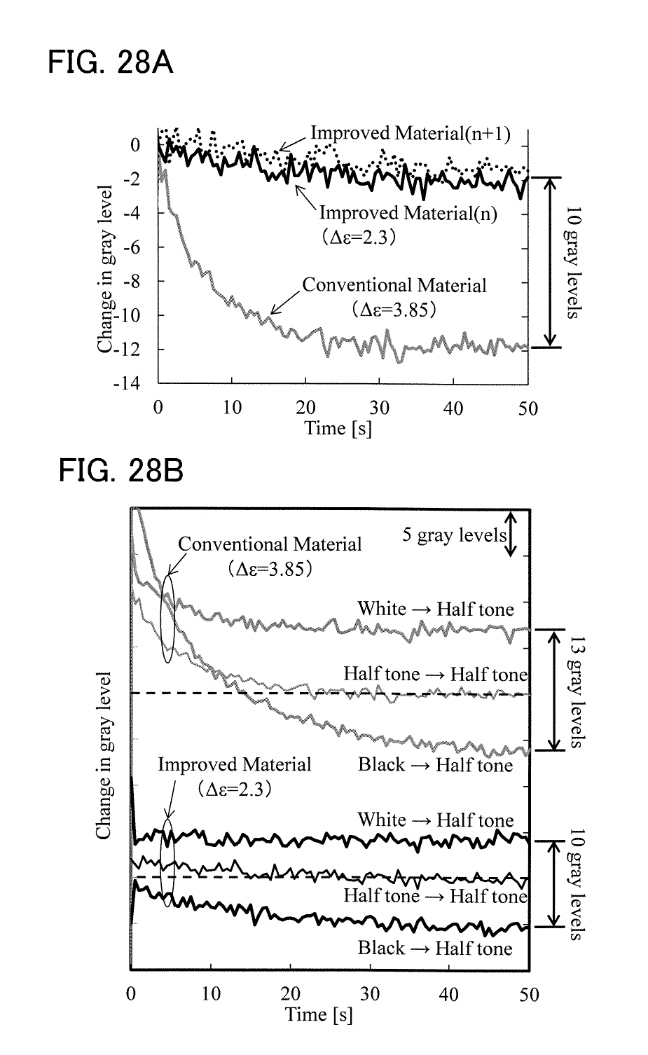

FIG. 28A shows changes in grayscale during intermediate grayscale display of the above-described two kinds of display devices using the liquid crystal materials. Note that in FIG. 28A, the vertical axis represents a change in intermediate grayscale (gray level) and the horizontal axis represents time. The change in grayscale of the liquid crystal material with a dielectric constant anisotropy of 2.3 (improved material) was measured at the n-th writing and at the (n+1)-th writing.

Note that the display device of this example was driven at a frame frequency of 0.017 Hz.

The results shown in FIG. 28A indicate that a change in grayscale of the liquid crystal material with a dielectric constant anisotropy of 3.85 (conventional material) for a frame (here, for 50 s) is 12 levels, whereas a change in grayscale of the improved material for a frame is 2 levels. That is, as compared to the liquid crystal material with a dielectric constant anisotropy of 3.85 (conventional material), the change in grayscale of the liquid crystal material with a dielectric constant anisotropy of 2.3 (improved material) was reduced by 10 levels. Therefore, it was demonstrated that the use of the liquid crystal material with a dielectric constant anisotropy of 2.3 (improved material) can suppress flickering on intermediate grayscale display. This is reproducible regardless of whether the number of writings is an even number or an odd number because the results in FIG. 28A show that the change in grayscale of the improved material is approximately 2 levels at either of the n-th and (n+1)-th writings.

Next, burn-in on the two kinds of display devices fabricated was examined.

In the examination method, deviation in gray level in halftone display after white display (white→half tone) from the gray level in continuous halftone display (half tone→half tone) and deviation in gray level in halftone display after black display (black→half tone) from the gray level in continuous halftone display were measured.

FIG. 28B shows the change in gray level after white display or black display. Note that in FIG. 28B, the vertical axis represents a change in intermediate grayscale (gray level) and the horizontal axis represents time elapsed since writing for halftone display.

According to the results shown in FIG. 28B, the liquid crystal material with a dielectric constant anisotropy of 3.85 (conventional material) had 13-gray-level deviation between white→half tone display and black→half tone display. The liquid crystal material with a dielectric constant anisotropy of 2.3 (improved material) had 10-gray-level deviation between white→half tone display and black→half tone display. Therefore, it was able to be demonstrated that the use of the liquid crystal material with a dielectric constant anisotropy of 2.3 (improved material) can suppress deviation in gray level.

The structure described in this example can be used as appropriate in combination with any of the structures described in the other embodiments and the other examples.

### Example 3

In this example, active matrix reflective color display devices were fabricated, and burn-in on the display devices was examined. For backplane-side FETs in the display devices fabricated in this example, CAAC-IGZO was used.

In this example, two display devices with different liquid crystal materials were fabricated. For a first display device, a liquid crystal material with a dielectric constant anisotropy of 3.85 (conventional material) was used in a liquid crystal layer. For a second display device, a liquid crystal material with a dielectric constant anisotropy of 2.2 (improved material 2) was used in a liquid crystal layer. Note that the display device including the liquid crystal material with a dielectric constant anisotropy of 2.2 (improved material 2) is one embodiment of the present invention.

In the examination method of burn-in on the display devices, deviation in gray level in halftone display after white display (white→half tone) from the gray level in continuous halftone display (half tone→half tone) and deviation in gray level in halftone display after black display (black→half tone) from the gray level in continuous halftone display were measured.

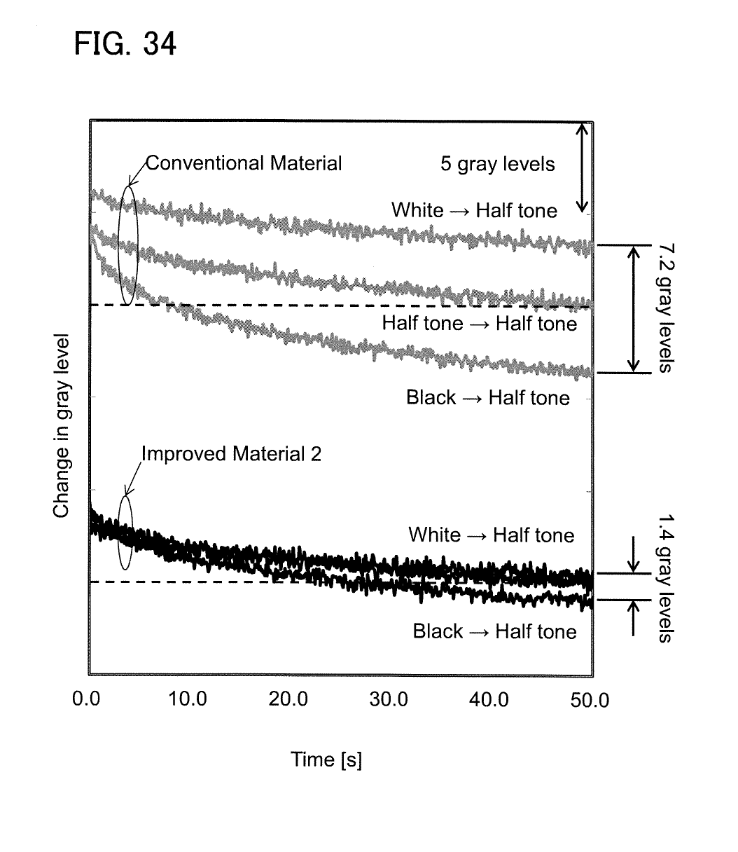

FIG. 34 shows the results of change in gray level after white display or black display. Note that in FIG. 34, the vertical axis represents a change in intermediate grayscale (gray level) and the horizontal axis represents time elapsed since writing for halftone display.

According to the results shown in FIG. 34, the liquid crystal material with a dielectric constant anisotropy of 3.85 (conventional material) had 7.2-gray-level deviation between white→half tone display and black→half tone display. The liquid crystal material with a dielectric constant anisotropy of 2.2 (improved material 2) had 1.4-gray-level deviation between white→half tone display and black→half tone display. Therefore, it was able to be demonstrated that the use of the liquid crystal material with a dielectric constant anisotropy of 2.2 (improved material 2) can suppress deviation in gray level. Note that in FIG. 34, data of continuous halftone display (half tone→half tone) using the improved material 2 and data of halftone display after white display (white→half tone) substantially overlap.

Although the conventional material of Example 1 and that of this example have the same dielectric constant anisotropy, the change in gray level after white display or black display is different between FIG. 28 and FIG. 34 depending on the backplane-side FETs, a color filter, or the like.

The structure described in this example can be used as appropriate in combination with any of the structures described in the other embodiments and the other examples.

### Example 4

In this example, eyestrain caused by page turning was measured.

First, a comparative display device used in this example is described. In the comparative display device, an electrophoretic display was used for a display element. For the electrophoretic display, a driving method in which black and white conversion is performed at an interval of 5 s was employed.

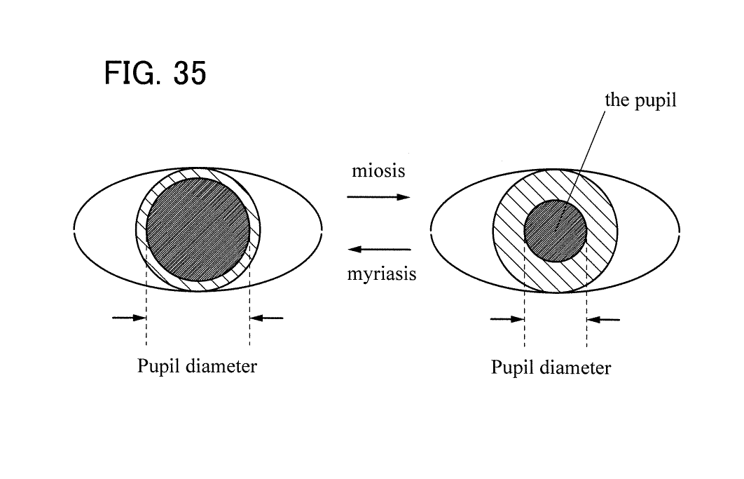

First, a change in pupil diameter is described with reference to FIG. 35. Note that FIG. 35 schematically illustrates a change in pupil diameter.

In FIG. 35, “the pupil” indicates a pupil, “miosis” indicates miosis, “myriasis” indicates myriasis, the left indicates a mydriatic pupil diameter, and the right indicates a miotic pupil diameter. The pupil diameter changes depending on brightness: the pupil diameter constricts (miosis) when sensing bright and dilates (mydriasis) when sensing dark.

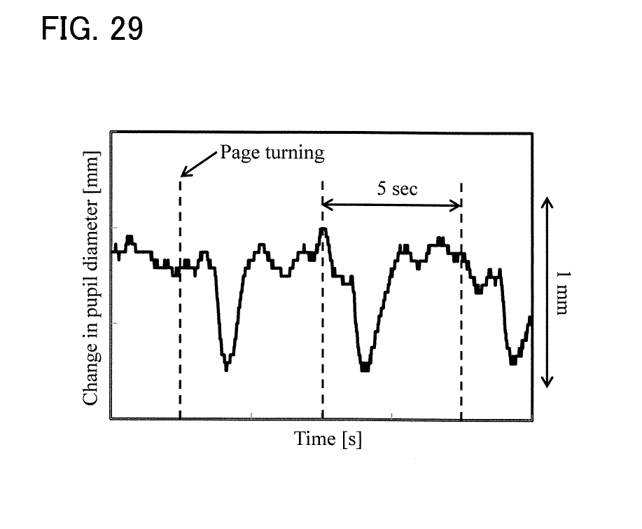

Next, FIG. 29 shows a change in pupil diameter during viewing of display on the comparative display device used in this example.

In FIG. 29, the vertical axis represents a change in pupil diameter and the horizontal axis represents display viewing time.

As shown in FIG. 29, a change in pupil diameter, in other words, contraction of pupil diameter (miosis) was observed immediately after page turning on the comparative display device. This change in pupil diameter suggests that page turning is perceived as dazzling light and is suspected to hurt eyes.

Next, a display device of one embodiment of the present invention used in this example is described.

In the display device of one embodiment of the present invention, a liquid crystal element was used as a display element. The liquid crystal material with a dielectric constant anisotropy of 2.3 (improved material) was used for the liquid crystal element. Note that the liquid crystal material of this example is the same as that of Example 2.

The display device of one embodiment of the present invention was driven by four driving methods below, and the pupil diameter during viewing of the screen was measured. The black text was displayed on white background and the text was changed at an interval of 5 s.

a) Fade-out to black/fade-in from black
b) Fade-out to white/fade-in from white
c) Page sliding to the right
d) No change when changing the text

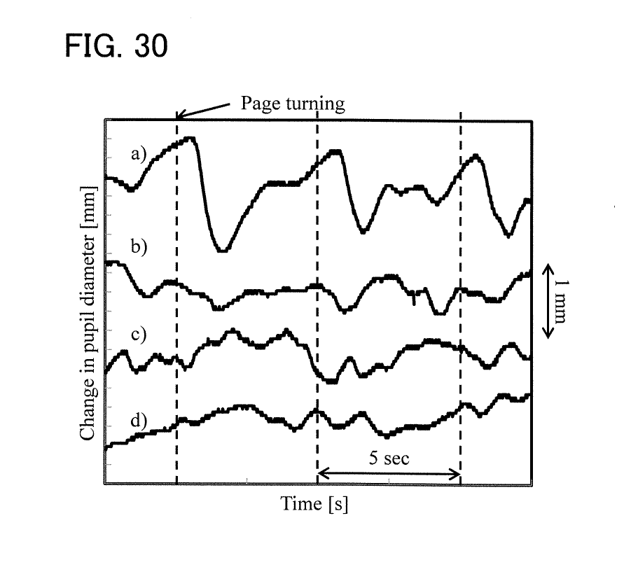

FIG. 30 shows changes in pupil diameter during viewing of display on the display device of one embodiment of the present invention.

In FIG. 30, the vertical axis represents a change in pupil diameter and the horizontal axis represents display viewing time.

As shown in FIG. 30, miosis was observed immediately after the page turning by the driving method a. In general, the pupil diameter constricts in bright light and dilates in the dark. Even though the darkness increases in the driving method a (fade-out to black/fade-in from black), miosis occurs. This is probably caused by the change in brightness due to the page turning, i.e., a rapid change in brightness from black to white background. In addition, changes in pupil diameter immediately after the page turning by the driving methods b, c, and d, which are shown in FIG. 30, are smaller than a change in pupil diameter with the comparative display device, which is shown in FIG. 29. Therefore, by the driving methods b, c, and d, the display device can provide less eyestrain.

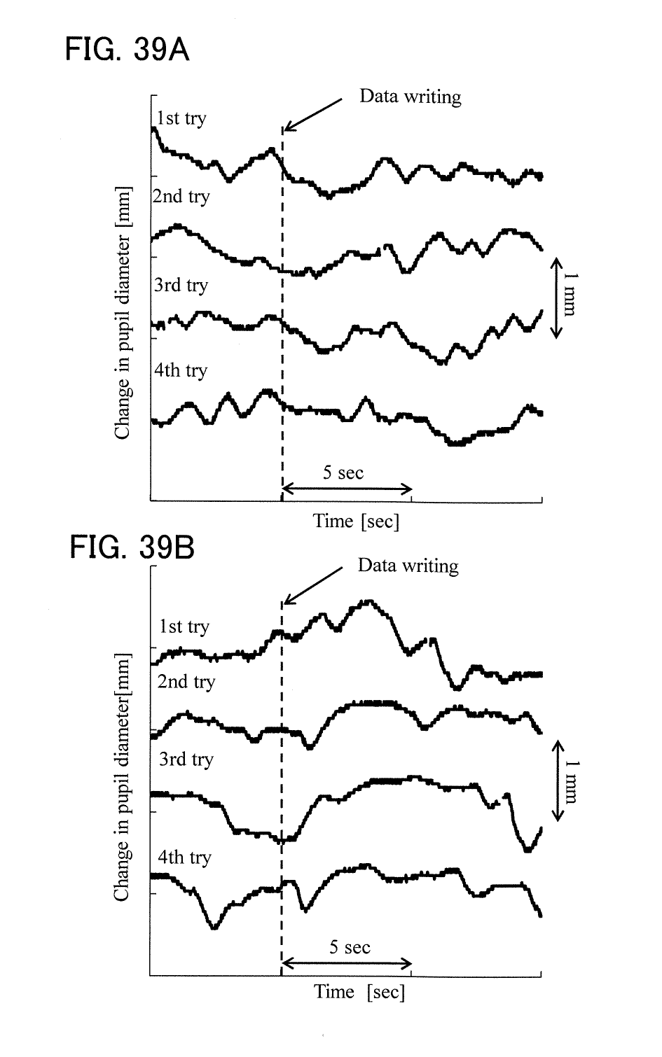

Next, flickering during data writing on the display device of one embodiment of the present invention driven at a low frequency was measured in terms of a change in pupil diameter during viewing of the display. FIGS. 39A and 39B show changes in pupil diameter during viewing of a panel in which the same images were written after a voltage of one polarity holding for 60 s by 1/60 fps driving. Note that measurement results of text display (two gray levels of white and black) are shown in FIG. 39A, whereas measurement results of halftone display on the entire surface are shown in FIG. 39B.

The results in FIGS. 39A and 39B show that a change in pupil diameter caused by the data writing is small in the both cases of the text display and the halftone display. Thus, on the display device of one embodiment of the present invention driven at low frequency driving of 1/60 fps or lower, flickering during data writing is suppressed. Therefore, the display device provides less eyestrain.

Next, the degree of eyestrain was measured using the display device of one embodiment of the present invention. For the measurement, critical fusion frequency (CFF), which is an objective index of eyestrain, was used. When the frequency of flashing of light is increased, the light appears continuous. This phenomenon is called fusion, and the frequency at which light begins to appear continuous without flickering being recognized is referred to as CFF. CFF is lowered as eyestrain is increased.

Letters were displayed on the display device of one embodiment of the present invention, and page turning by the method a and page turning by the method b were compared. For measuring eyestrain, three subjects (a male aged 24, a male aged 28, and a male aged 38) read text (MS P Gothic, font size: 10 p) displayed on the display device of one embodiment of the present invention for three hours. Each subject was subjected to the CFF measurement hourly. Note that a digital flicker value tester (product name: RDF-1) was used as a device for the CFF measurement.

Table 1 shows the results of the CFF measurement.

TABLE 1

Task Time

| | | 0 h | 1 h | 2 h | 3 h |
|---|---|---|---|---|---|
| male | a) | 39.8 | 35.2 | 35.3 | 34.8 |
| age 24 | b) | 37.0 | 36.3 | 36.1 | 36.3 |
| male | a) | 46.4 | 46.0 | 46.2 | 44.6 |
| age 28 | b) | 45.6 | 45.1 | 45.2 | 45.6 |
| male | a) | 39.1 | 39.8 | 40.5 | 40.4 |
| age 38 | b) | 39.5 | 39.5 | 40.5 | 39.5 |

As shown in Table 1, the CFF of some subjects changed, that is, the CFF decreased in the driving method a and did not change in the driving method b. From these results, it was demonstrated that the driving method b can reduce eyestrain than the driving method a.

The structure described in this example can be used as appropriate in combination with any of the structures described in the other embodiments and the other examples.

### Example 5

In this example, a display device of one embodiment of the present invention was fabricated and evaluated. One embodiment of the display device fabricated in this example is described below.

First, specifications of the display device fabricated in this example are shown in Table 2.

TABLE 2

| | |
|---|---|
| Display type | Reflective |
| Screen diagonal | 6.05 inch |
| Resolution | 768 (H) × 1024 (V) |
| Pixel pitch | 120 μm (H) × 120 μm (V) |
| Pixel density | 212 ppi |
| Source driver | Analog switch integrated |
| Scan driver | Integrated |
| Liquid crystal Mode | TN mode |
| Frame frequency | Still Image: 1/60 Hz |
| | Moving Image: 60 Hz |

The display device fabricated in this example was an active matrix reflective monochrome LCD. For backplane-side FETs in the display device fabricated in this example, CAAC-IGZO was used. The liquid crystal material with a dielectric constant anisotropy of 2.3 (improved material) was used as the liquid crystal material.

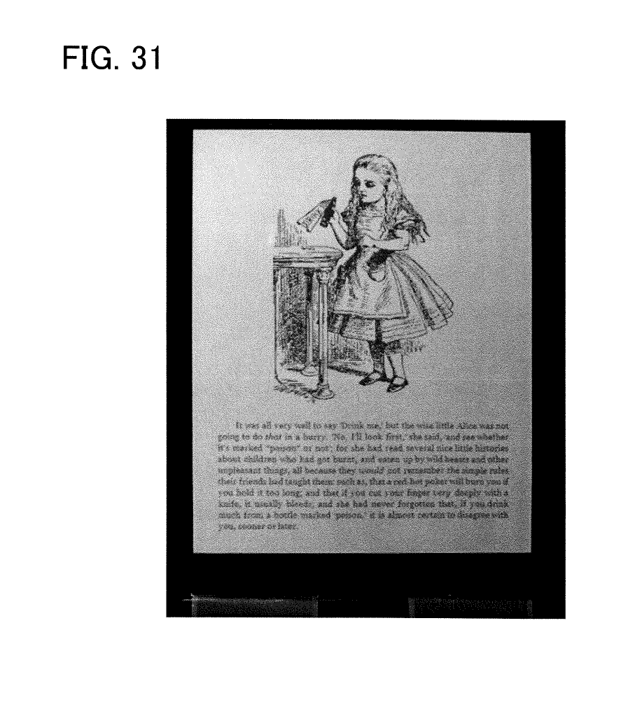

FIG. 31 shows a display example on the display device fabricated in this example. As shown in FIG. 31, excellent display can be obtained without practical problems.

The structure described in this example can be used as appropriate in combination with any of the structures described in the other embodiments and the other examples.

### Example 6

In this example, three kinds of display devices (a display device A, a display device B, and a display device C) were fabricated, and subjected to display evaluation, reflectance evaluation, and NTSC ratio evaluation. One embodiment of the display device fabricated in this example is described below.

First, specifications of the display device A fabricated in this example are shown in Table 3.

TABLE 3

| Display type | Reflective |
|---|---|
| Screen diagonal | 6.05 inch |
| Resolution | 768 (H) × 1024 × RGB (V) |
| Pixel pitch | 120 μm (H) × 40 μm (V) |
| Pixel density | 212 ppi |
| Scan driver | Integrated |
| Liquid crystal Mode | Twisted ECB mode |
| Frame frequency | Still Image: 1/60 Hz to 2 Hz |
| | Moving Image: 60 Hz |
| Reflectance | 29.5% |
| NTSC ratio | 39.3% |

Next, Table 4 shows the specifications of the display device B and the display device C fabricated in this example.

TABLE 4

| Display type | Reflective | |
|---|---|---|
| Backplane | CAAC-OS | |
| Screen diagonal | 6.05 inch | |
| Resolution | 768 (H) × 1024 × RGB (V) | |
| Pixel pitch | 120 μm (H) × 40 μm (V) | |
| Pixel density | 212 ppi | |
| Aperture ratio | 83.4% | |
| Scan driver | Integrated | |
| Liquid crystal mode | Twisted ECB mode | |
| Frame | Still image: 1/60 Hz to 2 Hz | |
| frequency | Moving image: 60 Hz | |
| | High color gamut | High reflective |
| Reflectance | 32.6% | 53.2% |
| NTSC ratio | 40.1% | 7.5% |
| Contrast | 20.4 | 26.7 |

Note that in Table 4, the display device B is a high-color-gamut type (High color gamut) and the display device C is a high-reflective type (High reflective).

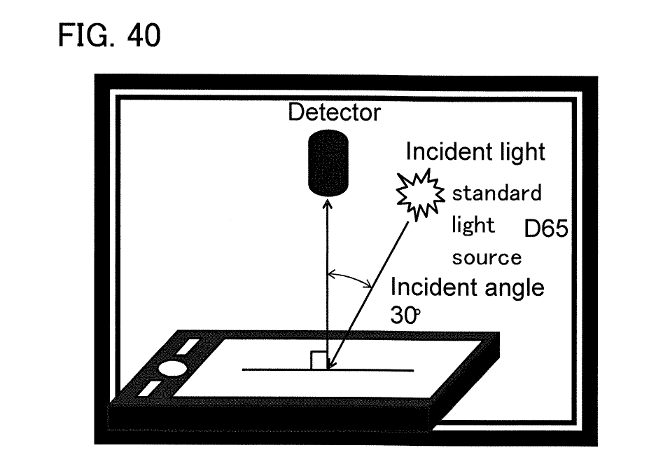

As shown in Table 4, the display device B had a reflectance of 32.6% and the display device C had a reflectance of 53.2%. Note that FIG. 40 schematically illustrates conditions for measuring the reflectances of the display device B and the display device C. As in FIG. 40, a light source (a standard light source D65) was incident at an angle of 30° and the reflectance in the vertical direction was measured. The reflectance of a standard white plate was regarded as 100%.

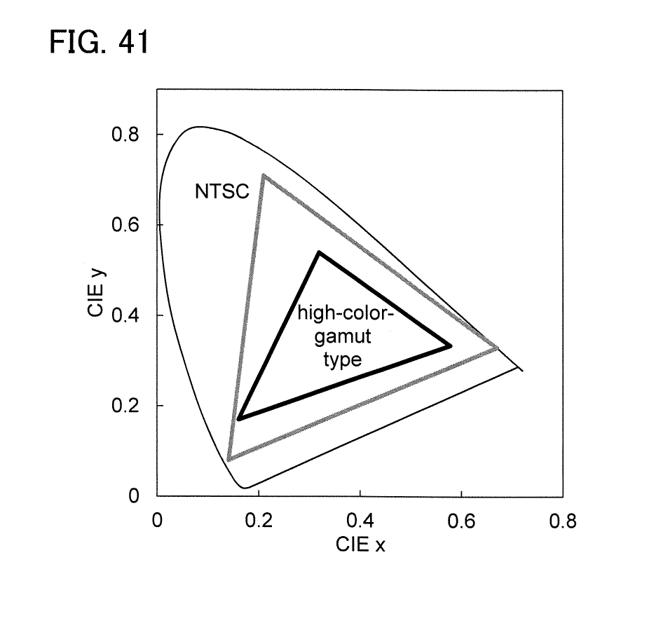

FIG. 41 shows the NTSC (national television system committee) ratio of the display device B. As seen in FIG. 41, the display device B had an NTSC ratio of 41.9%.

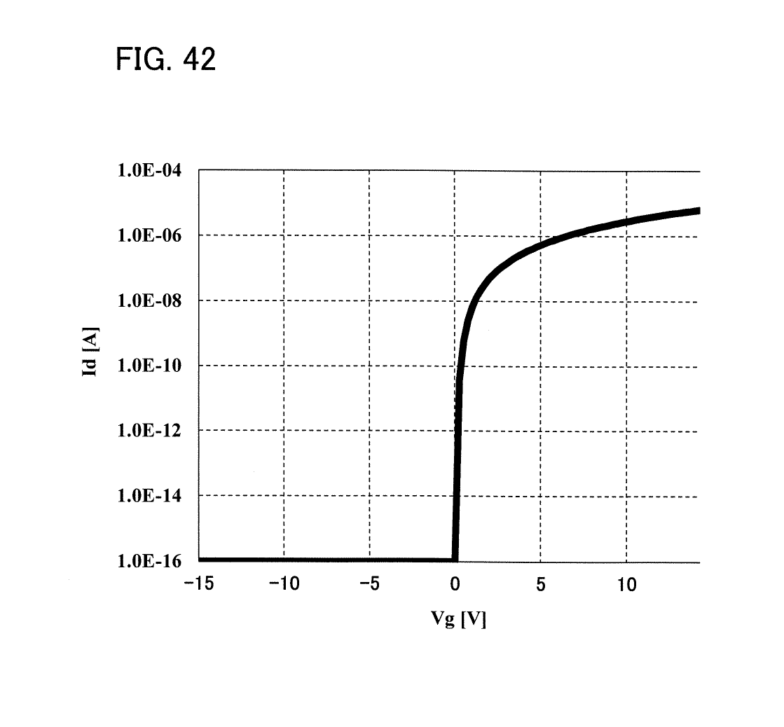

The display devices A, B, and C fabricated in this example were active matrix reflective color LCDs. For backplane-side FETs in the display devices A, B, and C fabricated in this example, CAAC-IGZO was used. FIG. 42 shows the characteristics of the backplane-side FET. The transistor shown in FIG. 42 was used as a pixel FET in the display devices A, B, and C, and had a size of W (channel width)/L (channel length)=3 μm/3 μm. The result in FIG. 42 indicates that the transistor has an extremely low off-state current (Ioff). This low Ioff enables IDS driving (idlling stop driving: driving in which data writing is performed, and then data rewriting is stopped) for still image display.

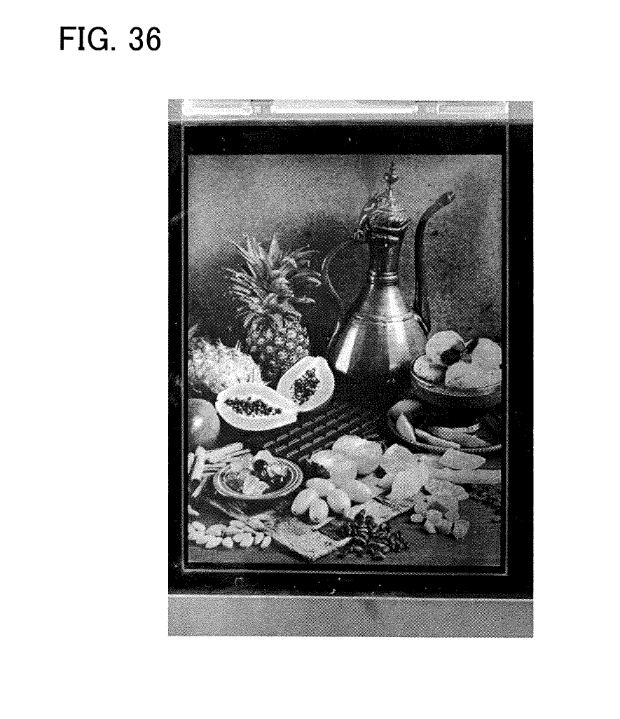

FIG. 36 shows a display example on the display device A fabricated in this example. Note that a liquid crystal material with a dielectric constant anisotropy of 3.6 (an improved material 3) was used for the display device A. As shown in FIG. 36, the display device A fabricated in this example has no problem in practical use and can provide preferable display.

The structure described in this example can be used as appropriate in combination with any of the structures described in the other embodiments and the other examples.

### Example 7

In this example, the display devices fabricated in Example 6, which were active matrix reflective color LCDs, were subjected to flickering evaluation. A flickering analytical model, flickering analysis, and subjective flickering examination, which were employed in this example, are described in detail below.

### <Flickering Analytical Model>

The human visual system has a bandpass characteristic, and CSF (contrast sensitivity function) is dependence of contrast sensitivity on frequency. Furthermore, an IRF (impulse response function), which is a transfer function of human visual system to light, is obtained by inverse Fourier transform of CSF.

The visual stimulation transition with time is obtained by convolution of IRF and luminance transition. When the visual stimulation transition with time is represented by s(t); the luminance transition with time is represented by l(t); and frequency characteristics of s(t) and l(t), which are obtained by Fourier transform, are represented by S(w) and L(w), respectively, S(w) is the product of L(w) and CSF. Since the contrast sensitivity is a reciprocal of the minimum value of Michelson contrast that is perceivable by human, S(w) is expressed by Formula 3.

$$\begin{matrix}[ Formula 3 ] & \\ S ( w ) = L ( w ) \cdot CSF ( w ) = L ( w ) \cdot \frac{{L}_{max} + {L}_{min}}{{L}_{max} - {L}_{min}} = L ( w ) \cdot \frac{2 {L}_{ave}}{Δ {L}_{min} ( w )} & ( 3 )\end{matrix}$$

In Formula 3, Lₘₐₓ−Lₘᵢₙ is a minimum perceivable luminance difference (ΔLₘᵢₙ(w)), and Lₘₐₓ+Lₘᵢₙ is the average luminance (L_{ave.}) of an object. It is possible to calculate whether a difference between l(t) and measured luminance is larger than ΔLₘᵢₙ(w) (when the absolute value thereof exceeds 1) to perceive a difference of flickering.

A formula S_{d}(w) to perceive the difference of flickering was devised. The formula S_{d}(w) is expressed by Formula 4.

$$\begin{matrix} [ Formula 4 ] & \\ {S}_{d} ( w ) = \frac{L ( w ) - {L}_{ave .} \cdot δ ( w )}{Δ {L}_{min} ( w )} = \frac{L ( w ) - {L}_{ave .} \cdot δ ( w )}{2 {L}_{ave .}} \cdot \frac{2 {L}_{ave .}}{Δ {L}_{min} ( w )} = {L}_{d} ( w ) \cdot CSF ( w ) & ( 4 )\end{matrix}$$

The formula S_{d}(w) in Formula 4 is expressed by the product of CSF(w) and L_{d}(w) that is converted from L(w) in Formula 3.

Furthermore, l_{d}(t) is obtained by the convolution of IRF and l_{d}(t) that is converted from l(t) and expressed by Formula 5.

$$\begin{matrix}[ Formula 5 ] & \\ {l}_{d} ( t ) = \frac{l ( t ) - {L}_{ave .}}{2 {L}_{ave .}} & ( 5 )\end{matrix}$$

### <Flickering Analysis>

The brightness of a reflective LCD is influenced by its surrounding environment; therefore, the temporal CSF of Barten's equation for analysis was employed because it can consider parameters of the surrounding environment. Table 5 lists the parameters used in the analysis, and Table 6 lists the conditions for the analysis.

TABLE 5

| Binocular | | τ₁₀τ₂₀ | 0.046, 0.018 | k | 3.2 | u₀ | 7 |
|---|---|---|---|---|---|---|---|
| L | 20 | η | 0.03 | Xₘₐₓ | 12 | Φ₀ | 3.00E−08 |
| X₀ | 18.92 | p | 1.18E+06 | Nₘₐₓ | 15 | | |
| n₁, n₂ | 7, 4 | C_{ab} | 0.08 | T | 0.1 | | |

TABLE 6

| | |
|---|---|
| Display | 6.05 inch TN-mode reflective LCD 768(H) × |
| | 1024(V) 212 ppi |
| Measurement | LCD-7200 (produced by Otsuka Electronics Co., |
| system | Ltd.) |
| Optical system | Detector: polar angle 0° Light source: polar |
| | angle 30° |
| | Reflectance of BaSO₄ is used as reference |
| Measurement time | For 60 consecutive seconds at an interval of 0.001 |
| | seconds |
| Frame frequency | 1 Hz (1 sec), 0.5 Hz (2 sec), 0.2 Hz (5 sec), |
| (Rewrite interval) | 0.1 Hz (10 sec), 0.067 Hz (15 sec) |

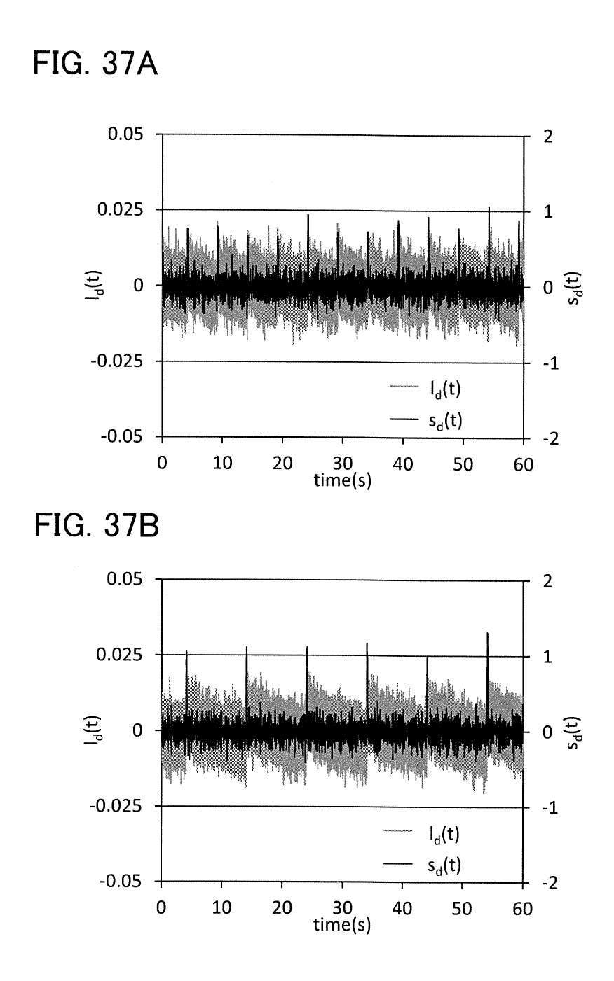

FIGS. 37A and 37B show l_{d}(t) obtained by converting a change in luminance l(t) at 0.2 Hz (5 s) and 0.1 Hz (10 s), which were measured under the conditions in Table 6, and visual stimulation (s_{d}(t)) obtained by convolution of l_{d}(t) and IRF. Note that FIG. 37A shows the result at 0.2 Hz (5 s) and FIG. 37B shows the result at 0.1 Hz (10 s). In FIGS. 37A and 37B, the first vertical axis represents l_{d}(t), the second vertical axis represents s_{d}(t), and the horizontal axis represents time.

In the case of 0.2 Hz shown in FIG. 37A, the relation s_{d}(t)<1 is approximately satisfied including spikes which indicate visual stimulation at the timing of refresh; thus, flickering is not perceivable. In contrast, in the case of 0.1 Hz shown in FIG. 37B, spikes of visual stimulation indicating the timing of refresh exceed 1, which means that flickering is perceivable.

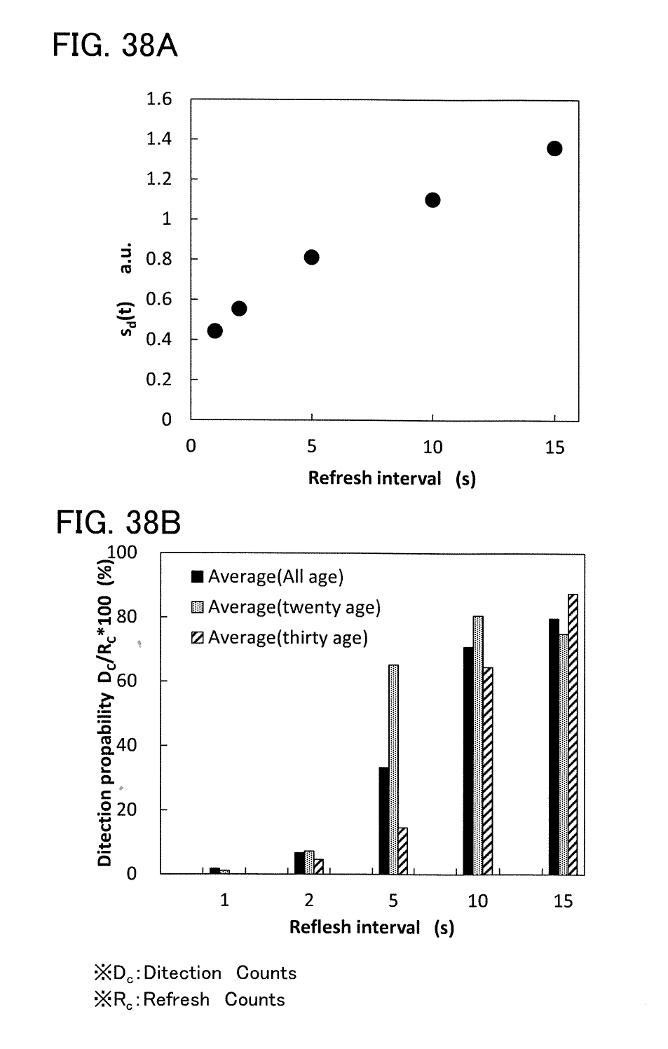

The above-described analysis was performed at each of frame frequencies listed in Table 6. FIG. 38A shows the average peak values (spikes) of visual stimulation, that is, results of dependence of visual stimulation on rewrite time. In FIG. 38A, the vertical axis represents s_{d}(t) and the horizontal axis represents refresh interval (rewriting time).

According to the result in FIG. 38A, at 0.1 Hz or lower, that is, at a refresh interval of 10 s or greater, s_{d}(t) exceeds 1; therefore, flickering is possibly perceivable.

### <Subjective Flickering Examination>

A subjective examination by questionnaire was performed to demonstrate the validity of the analytical model, using the active matrix reflective LCD fabricated in Example 6. Table 7 shows the conditions for the analysis.

TABLE 7

| | |
|---|---|
| Luminance | 20 cd/m² |
| Frame frequency | 1 Hz (1 sec), 0.5 Hz (2 sec), 0.2 Hz (5 sec), 0.1 Hz |
| (Rewrite interval) | (10 sec), 0.067 Hz (15 sec) |
| Observation | All gray display |
| | Observed for 2 minutes at each driving frequency |
| | Order of observation is random |
| Viewing distance | 30 cm |
| Subjects | Three persons in their 20s and four persons in their |
| | 30s with normal vision |
| Environment | Dark room |
| | Light up from above the panel tilted to 30° |
| | Take the view of the panel from the front |

FIG. 38B shows the results of the subjective flickering evaluation (the questionnaire survey). Note that in FIG. 38B, the vertical axis represents a flickering detection probability (detection probabilly) and the horizontal axis represents a refresh interval (rewrite time). Note that the flickering detection probability is normalized as follows: the timing when a subject perceives flickering is recorded, and the number of times the subject perceive flickering accurately is divided by the actual number of data rewrite operations during the examination.

According to FIG. 38B, although there are variations due to age, the overall results are consistent with the analysis results.

The structure described in this example can be used as appropriate in combination with any of the structures described in the other embodiments and the other examples.

### REFERENCE NUMERALS

11 electrode
12 electrode
13 alignment film
14 alignment film
15 liquid crystal molecule
19 sensor circuit
21 polarizing plate
22 polarizing plate
23 light detector
24 arrow
25 arrow
100 transistor
101 substrate
102 gate electrode
103 insulating layer
104 oxide semiconductor layer
104a channel region
104b n-type region
104c n-type region
105a electrode
105b electrode
106 insulating layer
107 insulating layer
110 transistor
114 oxide semiconductor layer
114a oxide semiconductor layer
114b oxide semiconductor layer
120 transistor
124 oxide semiconductor layer
124a oxide semiconductor layer
124b oxide semiconductor layer
124c oxide semiconductor layer
150 transistor
151 insulating layer
152 insulating layer
154 insulating layer
156 insulating layer
160 transistor
164 oxide semiconductor layer
164a oxide semiconductor layer
164b oxide semiconductor layer
164c oxide semiconductor layer
170 transistor
500 input unit
500_C signal
600 liquid crystal display device
610 control unit
615_C second-order control signal
615_V second-order image signal
620 arithmetic unit
625_C first-order control signal
625_V first-order image signal
630 display portion
631 pixel portion
631a region
631b region
631c region
631p pixel
632 G driver circuit
632_G G signal
633 S driver circuit
633_S S signal
634 pixel circuit
634c capacitor
634t transistor
635 display element
635_1 pixel electrode
635LC liquid crystal element
650 light supply portion
671 arithmetic unit
672 memory unit
673 graphic unit
674 display means
700 display module
701 substrate
702 pixel portion
704 source driver circuit portion
705 substrate
706 gate driver circuit portion
708 FPC terminal portion
710 signal line
711 wiring portion
712 sealing material
716 FPC
734 insulating film
736 coloring film
738 light-blocking film
750 transistor
752 transistor
760 connection electrode
764 insulating film
766 insulating film
768 insulating film
770 planarization insulating film
772 conductive film
774 conductive film
775 liquid crystal element
776 liquid crystal layer
778 structure body
780 anisotropic conductive film
790 capacitor
800 input/output device
801 display module
802 pixel
802B sub-pixel
802G sub-pixel
802R sub-pixel
803c capacitance
803g scan line driver circuit
803t transistor
810 base material
811 wiring
817 protective base material
819 terminal
820U sensor unit
821 electrode
822 electrode
823 insulating layer
834 window portion
836 base material
837 protective base material
837p protective layer
839 sensor circuit
850 input device
867p anti-reflective layer
872 reflective electrode
880 liquid crystal element
1400 portable information terminal
1401 housing
1402 display portion
1403 operation button
1410 mobile phone device
1411 housing
1412 display portion
1413 operation button
1414 speaker
1415 microphone
1420 music reproducing device
1421 housing
1422 display portion
1423 operation button
1424 antenna
5100 pellet
5120 substrate
5161 region

This application is based on Japanese Patent Application serial no. 2014-044502 filed with Japan Patent Office on Mar. 7, 2014, Japanese Patent Application serial no. 2014-104894 filed with Japan Patent Office on May 21, 2014, Japanese Patent Application serial no. 2014-130113 filed with Japan Patent Office on Jun. 25, 2014, and Japanese Patent Application serial no. 2014-196183 filed with Japan Patent Office on Sep. 26, 2014, the entire contents of which are hereby incorporated by reference.

1. A display device comprising:
a pixel for displaying a still image at a frame frequency of less than or equal to 1 Hz, the pixel comprising a liquid crystal layer,
wherein the liquid crystal layer has a dielectric constant anisotropy of higher than or equal to 2 and lower than or equal to 3.8.

2. A display device comprising:
a pixel for displaying a still image at a frame frequency of less than or equal to 1 Hz, the pixel comprising a transistor and a liquid crystal layer,
wherein the liquid crystal layer has a dielectric constant anisotropy of higher than or equal to 2 and lower than or equal to 3.8.

3. A display device comprising:
a pixel for displaying a still image at a frame frequency of less than or equal to 1 Hz, the pixel comprising a transistor, a liquid crystal layer, and a reflective electrode,
wherein the liquid crystal layer has a dielectric constant anisotropy of higher than or equal to 2 and lower than or equal to 3.8.

4. The display device according to claim 2 or 3,
wherein the transistor comprises a semiconductor layer, and
wherein the semiconductor layer comprises an oxide semiconductor.

5. The display device according to any one of claims 1 to 3, wherein the liquid crystal layer has a dielectric constant anisotropy of higher than or equal to 2.1 and lower than or equal to 3.6.

6. The display device according to any one of claims 1 to 3, wherein the frame frequency is less than or equal to 0.2 Hz.

7. The display device according to claim 3, wherein the reflective electrode has unevenness.

8. A display module comprising:
the display device according to any one of claims 1 to 3; and
a touch sensor.

9. An electronic device comprising:
the display device according to any one of claims 1 to 3; and
an operation key or a battery.

10. An electronic device comprising:
the display module according to claim 8; and
an operation key or a battery.
